(19) United States
(12) Patent Application Publication
(10) Pub. No.: US 2025/0139477 A1
(43) Pub. Date: May 1, 2025

(54) Integrated computing architecture for distributing layered data sets to processing units based on computation tasks including ones based on quantum models

(71) Applicants: Stephen J. Brown, Malibu, CA (US); Marek Alboszta, Palo Alto, CA (US)

(72) Inventors: Stephen J. Brown, Malibu, CA (US); Marek Alboszta, Palo Alto, CA (US)

(21) Appl. No.: 18/806,371

(22) Filed: Aug. 15, 2024

(51) Int. Cl. G06N 10/20; G06F 9/50; G06F 9/52

(52) U.S. Cl. CPC G06N 10/20; G06F 9/5027; G06F 9/52

(57) ABSTRACT

The present invention is directed to an integrated computing architecture designed for distributing a layered data set according to different computation tasks and to different processing units based on the layer type descriptors to carry out different computation tasks. Computation tasks involving matrix operations are distributed to Graphic Processing Units and others involving computation tasks requiring application of specialized computation models and distributed to one or more specialized processing units. The specialized processing units can include data layers that cannot be efficiently handled by GPUs and/or data layers that require models that include non-classical models such as quantum models. The integrated computing architecture is particularly useful when at least one of the data layers requires processing by a quantum cognition model and it may be extended by models with synthetic agents such as Artificial Intelligence Agents (AI Agents).

### FIELD OF THE INVENTION

The present invention is related to an integrated computing architecture that distributes layered data sets to different processing units including to a Graphics Processing Unit (GPU) and to specialized processing units, where the distribution is dictated by the type of computation task and computational model deployed, and where the models specifically include learning models and various non-classical models with a focus on quantum models such as quantum cognition models with agents.

### BACKGROUND OF THE INVENTION

Artificial Intelligence (AI) is in a period of rapid growth and adoption across many fields. In particular, Machine Learning (ML) and its many paradigms and processing techniques that most AI systems deploy are enjoying widespread interest.

The computing architectures that support today's ML and its diverse categories are heavily reliant on Graphics Processing Units (GPUs). GPUs are well-suited for most of the operations that ML entails and they also support massive parallel processing and distribution of computation tasks across many units.

Currently, some of the most promising ML approaches in AI are based on structures that use multi-layered networks of “perceptrons” (neuron-inspired entities) in networks called neural networks or deep neural nets. The depth of a neural network depends on the number of “hidden layers” of neurons sandwiched between the input layer and the output layer of a modern neural network. The input layer typically corresponds to the dimensionality of input data (e.g., for an input image there is an input for each pixel) and the output layer typically has a number of outputs that accounts for all possible results (e.g., number of possible image classifications). Meanwhile, the intermediate hidden layers between the input and output layers typically range from as few as one to dozens of layers with varying numbers of neurons, often referred to as nodes in the context of networks. In most cases, each neuron in a hidden layer receives weighted inputs from all neurons in the previous layer and it responds with its own output signal as dictated by the weights and its own activation function (e.g., reLU, sigmoid, etc.).

The performance of a neural network is tuned during a period called training. Training or teaching involves adjustments of weights and sometimes also of activation functions in the nodes located in the hidden layers of the network. These adjustments are initially derived from the errors that the neural network makes in outputs from its output layer (e.g., mistakes in image classification). The training phase uses an algorithmic approach (typically backpropagation and gradient descent) to adjust the weights and activation functions such that output errors are minimized. The training takes many iterations commonly referred to as epochs by those skilled in the art. In a final step the performance of the neural network is benchmarked using test data (data that was not used during the training phase).

Mathematically the construction and training of a neural network rely heavily on standard linear algebra and differential operations (e.g., application of the chain rule). Thus, unsurprisingly, processors that excel at these types of operations are deployed in construction, training and subsequent operation of neural networks. At present, the most successful processors belonging to this group are GPUs.

While GPUs have revolutionized the field of machine learning and deployment of deep neural networks in particular by enabling large-scale matrix operations and unprecedented speeds, they are not inherently optimized for many other important computation tasks. For example, GPUs are not typically optimized for computation tasks that involve differential equations or for computation tasks that apply non-classical models or for computation tasks that involve non-sequential and/or non-parallelizable operations.

Before the advent of specialized coprocessors integrated within a unified architecture, the most common approach to neural network computation was to use GPUs as the primary workhorses for both training and inference tasks. This approach was largely GPU-centric, routing all kinds of layers and operations through the GPU regardless of layer type or specialized computation requirements. That strategy was largely based on the many strengths of the GPU.

Among the strengths of GPUs is their massive parallelism. Indeed, it is one of the primary advantages of GPUs that they have the ability to perform a large number of calculations concurrently. This ability makes them extremely effective for matrix multiplications and other linear algebra operations that are ubiquitous in neural network training and inference. GPUs also have the advantage of high bandwidth. Specifically, modern GPUs come with high-memory bandwidth, which is crucial for dealing with large datasets and high-dimensional vectors and matrices, commonly found in machine learning tasks. In addition to the above core advantages, GPUs are also relatively flexible. GPUs are capable of handling a wide variety of layer types and operations. While they might not be as optimized for specific tasks as specialized hardware, their broad utility has been invaluable.

A further strength of the GPU comes from its broad ecosystem support. There is a well-developed software ecosystem around GPUs, including libraries and frameworks like TensorFlow and PyTorch, that makes it relatively easy to design and deploy neural network models. Additionally, GPU architectures are highly scalable. In particular, GPUs can be easily scaled horizontally (i.e., by adding more GPU units) to accommodate larger neural network models or datasets.

Meanwhile, the explosion of AI approaches and their deployment on GPUs have exposed a number of issues and limitations in both. While machine learning on GPUs has been and continues to be successful in dealing with image data, other types of input data and expected outputs are not faring as well. The challenges and limitations in learning from such data are sometimes due to the learning methodology and not the physical processors used. In some other cases, the issues of learning models and physical implementation are intertwined. The most serious limitation can be traced back to the basic assumptions of machine learning approaches and the fundamentally sequential processing nature of the GPU.

The mathematical framework of machine learning is deeply rooted in classical models of the environment and logical positivism found in Boolean logic and Bayesian statistics/reasoning. In these models, uncertainty arises from a state of ignorance which is due to lack of information and not due to the environment itself. Such assumptions lead to a limited model of the environment that does not span the space of possibilities encountered in real-life situations. For example, models based on logical positivism and a classical world view fail to account for rudimentary effects due to the environment's underlying quantum nature. Among many others, these effects include the color of light emissions from a glowing filament, the behavior of field-effect elements in electronic circuits, superconductivity, the nature of bonding and anti-bonding orbitals in molecules, light and particle lasing/clumping mechanisms and a vast array of wave-particle dualities as well as interference effects.

It is at least unclear how machine learning based on logically naive and classical models of the environment can lead to independent learning of environmental effects that are due to the many complex natural processes including quantum phenomena. Similarly, solutions of problems that involve differential equations or are probabilistic in nature, including problems with non-linear complexities that do not lend themselves to parallel processing are not well-suited to the mathematical framework of machine learning. In fact, even some large-scale phenomena are known to exhibit correlations that are suitable for treatment with non-classical algorithms. These phenomena include not only those found in data sets from physics, chemistry and biology, but also in real-world graphs including graphs of social networks that track relationships between human beings.

There are many references that suggest the use of quantum models for handling human subjects. Among the more notable early attempts at applying quantum techniques to characterize human states are those of C. G. Jung and Wolfgang Pauli. Although they did not meet with success, their bold move to export quantum formalisms to large scale realms without too much concern for justifying such procedures paved the way for others. More recently, the textbook by physicist David Bohm, “Quantum Theory”, Prentice Hall, 1979 ISBN 0-486-65969-0, pp. 169-172 also indicates a motivation for exporting quantum mechanical concepts to applications with human subjects. More specifically, Bohm speculates about employing aspects of the quantum description to characterize human thoughts and feelings.

In a review article published online by J. Summers, “Thought and the Uncertainty Principle”, http://www.jasonsummers.org/thought-and-the-uncertainty-principle/, 2013 the author suggests that a number of close analogies that exist between quantum processes and human inner experience and thought processes could be more than mere coincidence. The author shows that this suggestion is in line with certain thoughts on the subject expressed by Niels Bohr, one of the fathers of quantum mechanics.

Early attempts at lifting quantum mechanics from the micro-scale realm to describe human states cast new light on the already known problem with standard classical logic, typically expressed by Bayesian models. In particular, it had long been known that Bayesian models are not sufficient and are even incompatible with properties observed in human decision-making. The mathematical nature of these properties, which are quite different from Bayesian probabilities, were later investigated in quantum information science by Vedral, V., “Introduction to quantum information science”, New York: Oxford University Press 2006.

Taking the early attempts and more recent related motivations into account, it is perhaps not surprising that an increasing number of authors argue that the basic framework of quantum theory can be exported from the micro-domain to find useful applications in the cognitive domain. Some of the most notable contributions are found in: Aerts, D., Czachor, M., & D'Hooghe, B. (2005), “Do we think and communicate in quantum ways? On the presence of quantum structures in language”, In N. Gontier, J. P. V. Bendegem, & D. Aerts (Eds.), Evolutionary epistemology, language and culture. Studies in language, companion series. Amsterdam: John Benjamins Publishing Company; Atmanspacher, H., Roemer, H., & Walach, H. (2002), “Weak quantum theory: Complementarity and entanglement in physics and beyond”, Foundations of Physics, 32, pp. 379-406.; Blutner, R. (2009), “Concepts and bounded rationality: An application of Niestegge's approach to conditional quantum probabilities”, In Accardi, L. et al. (Eds.), Foundations of probability and physics-5, American institute of physics conference proceedings, New York (pp. 302-310); Busemeyer, J. R., Wang, Z., & Townsend, J. T. (2006), “Quantum dynamics of human decision-making”, Journal of Mathematical Psychology, 50, pp. 220-241; Franco, R. (2007), “Quantum mechanics and rational ignorance”, Arxiv preprint physics/0702163; Khrennikov, A. Y., “Quantum-like formalism for cognitive measurements”, BioSystems, 2003, Vol. 70, pp. 211-233; Pothos, E. M., & Busemeyer, J. R. (2009), “A quantum probability explanation for violations of ‘rational’ decision theory”, Proceedings of the Royal Society B: Biological Sciences, 276. Recently, Gabora, L., Rosch, E., & Aerts, D. (2008), “Toward an ecological theory of concepts”, Ecological Psychology, 20, pp. 84-116 have even demonstrated how this framework can account for the creative, context-sensitive manner in which concepts are used, and they have discussed empirical data supporting their view. Still another application of quantum theory to the modeling of inner states of human subjects was provided by the paper of R. Blutner and E. Hochnadel, “Two qubits for C. G. Jung's theory of personality”, Cognitive Systems Research, Elsevier, Vol. 11, 2010, pp. 243-259. The authors propose a formalization of C. G. Jung's theory of personality using a four-dimensional Hilbert space for representation of two qubits.

A practical application of quantum mechanical models that align with the quantum cognition approach introduced in several of the above references has been proposed more recently still in U.S. Published Patent Applications 2014/0164313; 2014/0207723; 2015/0026112; 2015/0154147; 2016/0004972; 2016/0180238; 2016/0189053; 2016/0210560 to Alboszta et al., as well as in U.S. Pat. Nos. 9,741,081; 10,007,884 also to Alboszta et al. The quantum cognition models presented in these references are adapted to handling social networks. Such networks can represent quantum states of human subjects and their interdependence, e.g., due to entanglement, in data sets presented in graph form.

In addition to data sets that can be processed with quantum models including quantum cognition models, still other non-classical and specialized data sets should be handled by resources other than GPUs due to the limitations discussed above. In other words, computing tasks should be taken into account when designing integrated computing architectures that handle diverse data sets. It would thus be an advance in the art to provide an integrated computing architecture that would handle the various computing tasks ranging from those well-suited for GPUs to those that require specialized processors and/or coprocessors including ones for handling non-classical and quantum models.

### Objects and Advantages

In view of the shortcomings of the prior art, it is an object of the present invention to provide for an integrated computing architecture that handles computation tasks ranging from those well-suited for GPUs to those that require specialized processors and/or coprocessors. The computation tasks can include ones based on specialized computation models that are non-classical such as quantum models.

Furthermore, the objectives of the present invention are to improve five key criteria. Efficiency: To reduce computational load on the GPU, allowing for faster data processing and lower energy consumption. Flexibility: To handle a wide array of computational tasks, from classical deep learning to emerging fields like quantum cognition. Optimized Learning: To allow deployment of specialized coprocessors can enable deep learning models to achieve high performance with fewer layers and parameters. Real-time Analytics: To provide an architecture that supports real-time data analytics and decision-making in complex scenarios involving human behavior and quantum effects. Future-Proof: To provide an integrated architecture that is designed to be modular, allowing for the easy addition of other specialized coprocessors as new computational paradigms emerge.

By combining the best of both classical and emerging computational approaches, this integrated computing architecture paves the way for a new class of powerful, efficient, and flexible AI models.

Still other objects and advantages of the invention will become apparent upon reading the detailed specification and reviewing the accompanying drawing figures.

### SUMMARY OF THE INVENTION

The present invention relates to an integrated computing architecture designed for distributing a layered data set according to different computation tasks. The layered data set has data layers that are tagged with layer type descriptors that are preferably included in the metadata accompanying the data layers. Alternatively, layer type descriptors can be included in the data layers themselves. The integrated computing architecture is designed for distributing the layered data set to different processing units based on the layer type descriptors. More specifically, the data layers are distributed according to at least two different computation tasks, such as a first computation task and a second computation task.

The integrated computing architecture has a Central Processing Unit (CPU) for receiving the layered data set that is tagged with the layer type descriptors. The CPU identifies and separates the layered data set based on the layer type descriptors into data types. Specifically, the CPU separates the layered data set into at least two subsets, namely a first type data subset and a second type data subset. The CPU assigns the first type data subset to the first computation task and the second data subset to the second computation task.

The integrated computing architecture also has a high-speed bus that is connected to the CPU for routing the first and second type data subsets. Furthermore, the integrated computing architecture provides at least one Graphics Processing Unit (GPU) that is connected to the high-speed bus and is set up for performing the first computation task on the first type data subset that is routed to it via the high-speed bus. At least one specialized processing unit is also connected to the high-speed bus and is set up for performing the second computation task on at least one segment and up to the entirety of the second data type subset that is routed to it via the high-speed bus.

In accordance with the invention the first and second computation tasks differ. The first computation task involves matrix operations that are well-suited for the one or more GPUs. Meanwhile, the second computation task involves application of a specialized computation model and is hence performed by the at least one specialized processing unit.

The layer type descriptors are important for identifying, separating and routing the first type data subset and the second type data subset. In some embodiments, the layer type descriptors include a specialized metadata indicator that points to the at least one segment of the second data type subset. When the layer type descriptors are in the metadata the type of information can include parameters such as dimensions, activation functions, attention mechanisms, hyperparameters, positional encodings, feed-forward networks, non-classical data indicators and entanglement suspects. In one case, the layer type descriptors include at least one suspected non-classical metadata indicator for the at least one segment of the second data type subset. In that case the CPU can perform a non-classicality test on the at least one segment thus identified in the metadata. A useful non-classicality test can include a factorizability test, which is a way of determining whether the states described by the data are separable (where non-separability of states is an indicator of possible quantum entanglement and hence non-classicality).

In cases where the at least one segment is a quantum data segment the specialized processing unit should be chosen correspondingly. Specifically, the at least one specialized processing unit should be selected from among Quantum Coprocessors, Quantum Computers and Quantum Simulators in accordance with the specialized computation model that is to be deployed.

There exist a variety of specialized computation models that are applicable when the data segment is a quantum data segment. Such computation models include a quantum cognition model, a sequence of quantum gates, a generator of entangled qubits for quantum key distribution, a noise-mitigation algorithm for minimizing quantum errors, a hybrid quantum-classical optimization loop, a sequence of quantum operations followed by classical operations, a quantum Fourier transform, a generator of entangled states with a controlled-NOT gate, a quantum error correction code, a quantum state preparation and measurement sequence, a quantum walk algorithm as well as a quantum search algorithm among other. In particular, when the computation model is a quantum cognition model the data segment of the second data type contains information about agents, which can be actual human subjects or other types of agents, and their relationships. In this case, the agents are assigned to graph nodes and the relationships between the agents are assigned to graph edges. Some relationships in these embodiments are relationships between agents that are represented as entanglements. For example, the relationship between a pair of agents is treated as entanglement and the edge connecting them connotes entanglement when the agents of the pair share a common contextualization of a given proposition. In those cases, the contextualization and the proposition are tracked in a quantum representation.

In other embodiments, e.g., where non-classicality is not at issue, the at least one specialized processing unit is made up of at least one unit selected from among Liquid Neural Network Processing Units and Neural Ordinary Differential Equations Processing Units. In these embodiments the specialized computation model to be implemented can be an initial value solver for Neural Ordinary Differential Equations by adaptive Runge-Kutta methods, a fast Jacobian Matrix evaluation for implicit Ordinary Differential Equation solution, a real-time simulation of Liquid Neural Networks with a sparse connectivity matrix, a hardware-accelerated bifurcation analysis to identify parameter regimes where the dynamics of Neural Ordinary Differential Equations change qualitatively, a backpropagation through time for Liquid Neural Networks by storing and replaying neural states, a time-stepping algorithm for solving partial differential equations related to Neural Ordinary Differential Equations, a gradient descent algorithm, a reservoir computing task with projection of high-dimensional inputs onto lower-dimensional liquid states, an evaluation of stability of fixed points and limit cycles in Neural Ordinary Differential Equation systems, a sensitivity analysis for quantifying impact of parameter variations on Neural Ordinary Differential Equation solutions, a simulation of spiking neural networks with integrate-and-fire models or Hodgkin-Huxley models and a hardware-accelerated Fast Fourier Transform for frequency domain analysis of Liquid Neural Networks among other.

Of course, it is also possible to run both non-classical and classical computation models at the same time. Indeed, the layered data set can contain three or more data layers that are designated for different computation tasks some of which can be intended for the GPU, others for specialized processors based on classical computation tasks, and still others for non-classical computation tasks. In such embodiments the choice should be made whether the GPU and the at least one specialized processing unit operate asynchronously or synchronously.

The present invention, including the preferred embodiment, will now be described in detail in the below detailed description with reference to the attached drawing figures.

### BRIEF DESCRIPTION OF THE DRAWING FIGURES

FIG. 1A is a diagram illustrating an integrated computing architecture designed for working layered data sets according to the invention

FIG. 1B is a diagram illustrating several aspects of the operation of the CPU of integrated computing architecture of FIG. 1A

FIG. 1C is a diagram illustrating in more detail the operation of the CPU and a portion of the integrated computing architecture of FIG. 1A that handles a first computation task involving a first data subset on a GPU

FIG. 1D is a diagram illustrating the handling of a second computation task involving a second type data subset on specialized processing units of the integrated computing architecture of FIG. 1A

FIG. 2 is a flow diagram illustrating the logic flow deployed by an integrated computing architecture working with layered data sets according to the invention

FIG. 3A is a diagram illustrating another integrated computing architecture according to the invention

FIG. 3B is a diagram illustrating several aspects of the operation of integrated computing architecture of FIG. 3A

FIG. 3C is a diagram focusing on a segment of a data layer shown in FIG. 3A

FIG. 4A (Prior Art) is a diagram illustrating the basic aspects of a quantum bit or qubit using the Bloch sphere

FIG. 4B (Prior Art) is a diagram illustrating the set of orthogonal basis vectors in the complex plane of the qubit shown in FIG. 4A

FIG. 4C (Prior Art) is a diagram illustrating the qubit of FIG. 4A in more detail with the three Pauli matrices associated with measurements

FIG. 4D (Prior Art) is a diagram illustrating the polar representation of the qubit of FIG. 4A

FIG. 4E (Prior Art) is a diagram illustrating the plane orthogonal to a state vector in an eigenstate along the u-axis

FIG. 4F (Prior Art) is a diagram illustrating a simple measuring apparatus for measuring two-state quantum systems such as electron spins (spinors)

FIG. 4G (Prior Art) is a diagram illustrating the fundamental limitations to finding the state vector of an identically prepared ensemble of spinors with single-axis measurements

FIG. 5A is a diagram illustrating the application of a quantum cognition model within integrated computing architecture of FIG. 3A

FIG. 5B is a flow diagram illustrating preparation of the quantum processing unit of the integrated computing architecture of FIG. 3A to deploying the quantum cognition model

FIG. 5C is a diagram visualizing the operations performed by the quantum processing unit of FIG. 3A in assigning quantum states according to the quantum cognition model

FIG. 5D is a diagram visualizing the deployment of value matrices by the quantum processing unit of FIG. 3A

FIG. 5E is a diagram visualizing the computation of an expectation value by the quantum processing unit of FIG. 3A

FIG. 5F is a diagram illustrating the output of the quantum processing unit of FIG. 3A deploying the basic quantum cognition model without considering entanglement

FIG. 6A is a diagram illustrating the principles of entanglement within the quantum cognition model as applied by the quantum processing unit of the integrated computing architecture of FIG. 3A

FIG. 6B is a diagram illustrating the underpinnings of the process of entanglement leading to an anti-symmetric joint quantum state

FIG. 6C is a diagram that illustrates the overall process of formation of the anti-symmetric joint state within the quantum cognition model

FIG. 6D is a diagram with a time line affording a more detailed look at the formation of the anti-symmetric joint state within the quantum cognition model

FIG. 6E is a diagram illustrating the consequences of entanglement between agents in the anti-symmetric joint state

FIG. 6F is a diagram illustrating the sense in which entanglement transcends contextualization by examining the non-local aspects of the quantum cognition representation

FIG. 7A is a diagram illustrating a system that combines the integrated computing architecture of FIG. 3A with a network and applies of basic and advanced features of the quantum cognition model

FIG. 7B is a diagram of the treatment of agents prior to entanglement within the system of FIG. 7A

FIG. 7C is a diagram of the treatment of agents post entanglement within the system of FIG. 7A

FIG. 7D is a diagram translating anti-symmetric entanglement into a repulsive bond within the quantum cognition model

FIG. 7E is a diagram translating symmetric entanglement into attractive bond within the quantum cognition model

### DETAILED DESCRIPTION

The drawing figures and the following description relate to preferred embodiments of the present invention by way of illustration only. It should be noted that from the following discussion, alternative embodiments of the methods and systems disclosed herein will be readily recognized as viable options that may be employed without straying from the principles of the claimed invention. Likewise, the figures depict embodiments of the present invention for purposes of illustration only.

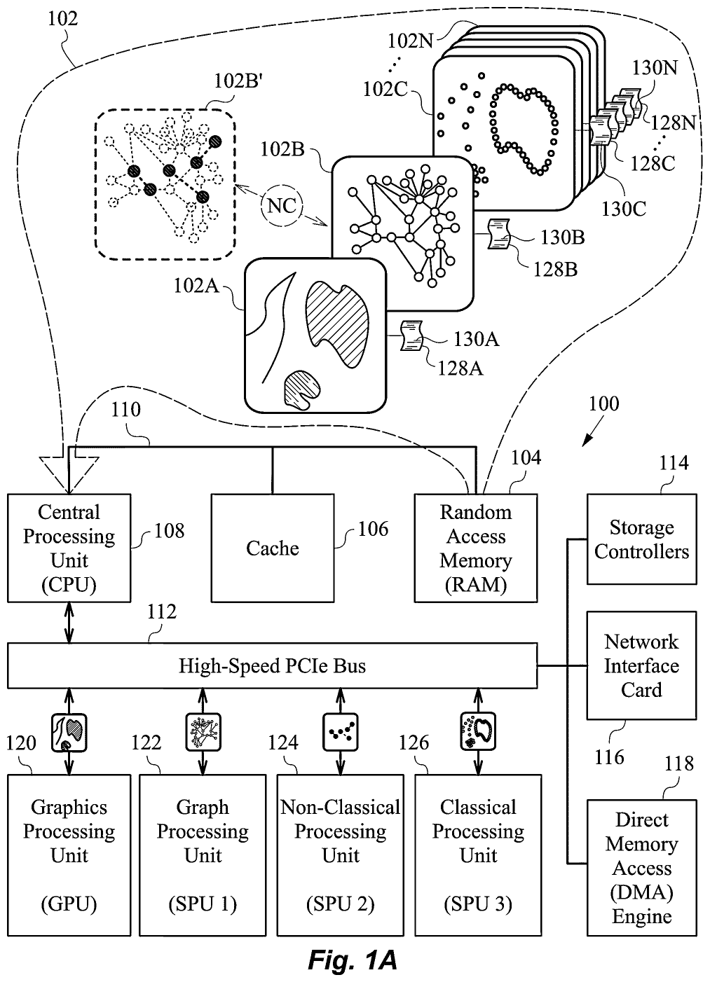

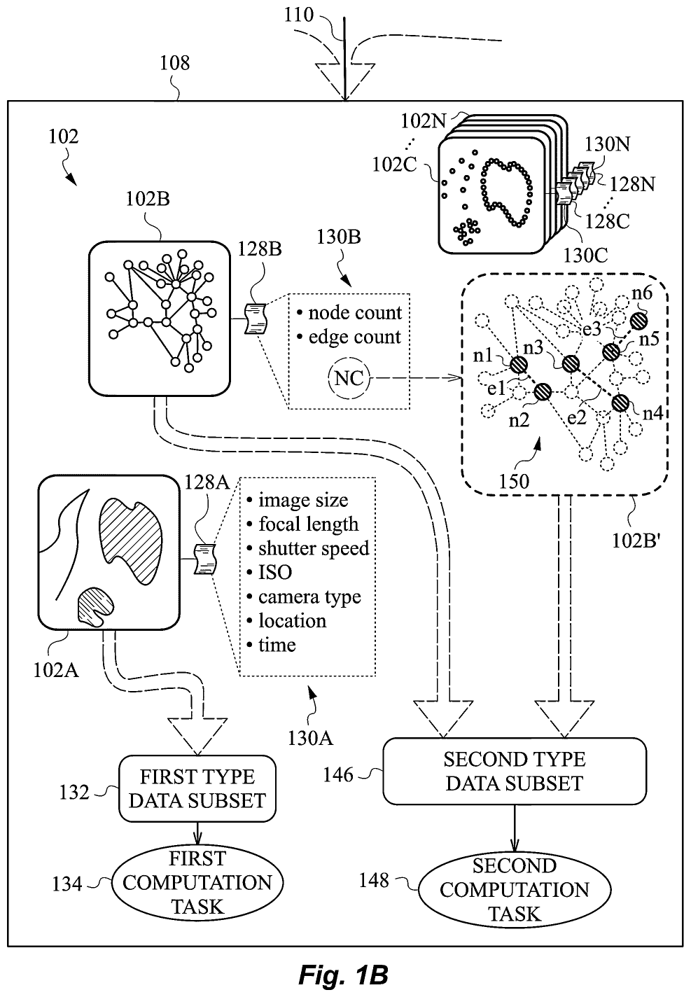

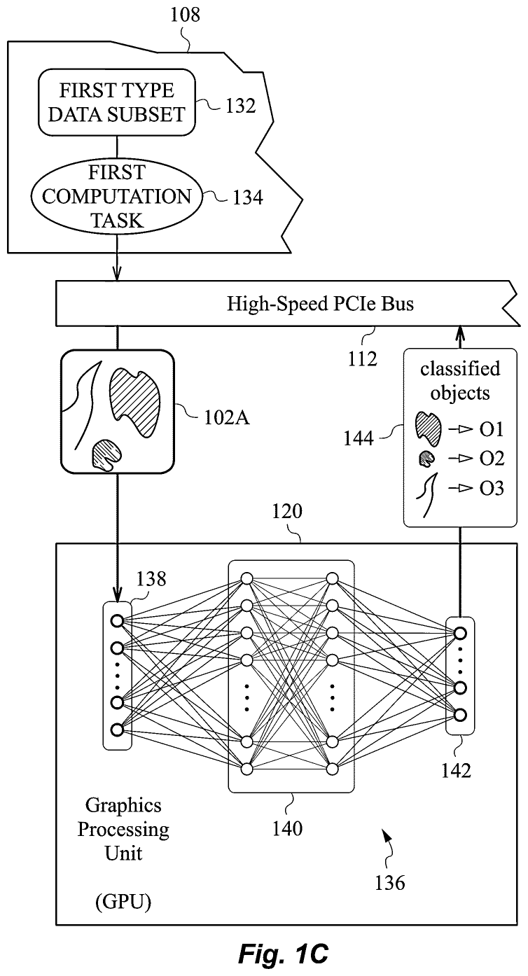

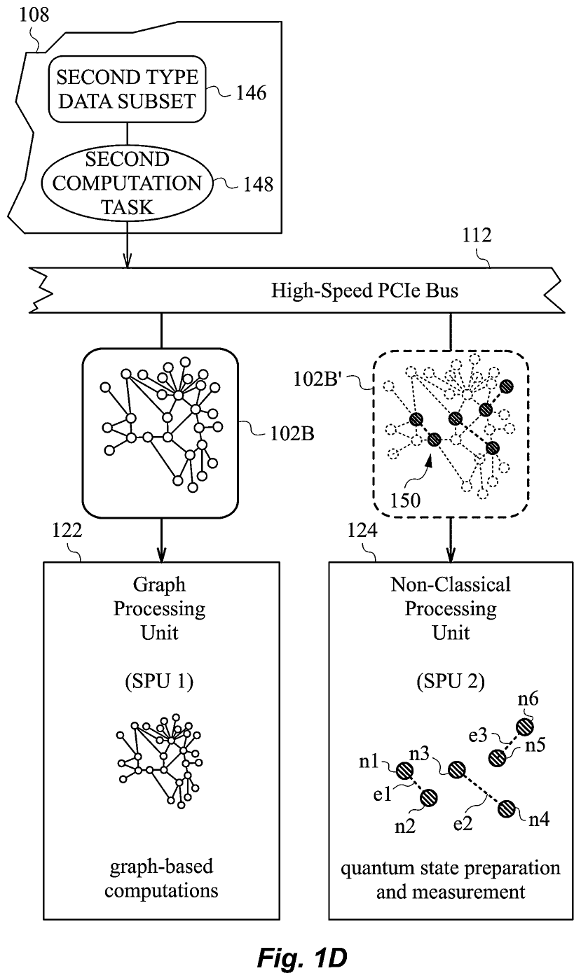

FIG. 1A is diagrammatic illustration of an integrated computing architecture 100 designed for working with a layered data set 102 according to the invention. Layered data set 102 initially resides in a Random Access Memory (RAM) 104 belonging to integrated computing architecture 100, as clarified by dashed outline commencing at RAM 104.

Integrated computing architecture 100 further includes a cache 106 and a Central Processing Unit (CPU) 108. RAM 104, Cache 106 and CPU 108 are connected by a system bus 110. It should be noted that in some embodiments a portion of layered data set 102 resides in Cache 106 (not indicated in FIG. 1A).

System bus 110 is used for communication and transmission of data between RAM 104, Cache 106 and CPU 108. Specifically, layered data set 102 is transmitted from RAM 104 to CPU 108 as indicated by dashed outline terminating with an arrow at CPU 108.

Integrated computing architecture 100 relies on CPU 108 as the primary coordinator and executor of general-purpose tasks and also of computation tasks distributed in accordance with the invention. CPU 108 is thus ideally positioned to use its connection to RAM 104 and Cache 106 via system bus 110 to obtain rapid access to frequently used data during operation.

Integrated computing architecture 100 is equipped with a high-speed bus 112 that is connected to CPU 108. Preferably, high-speed bus 112 is a Peripheral Component Interconnect Express (PCIe bus or PCI-E bus) because such busses are specifically designed for low latency and high data transfer rates. Further, high-speed bus 112 is connected to a number of required resources. These resources include storage controllers 114, a network interface card 116 and a Direct Memory Access (DMA) engine 118. This configuration and these resources allow high-speed bus 112 to manage and efficiently route data in integrated computing architecture 100, as explained in more detail below.

Further, integrated computing architecture 100 has at least one Graphics Processing Unit (GPU) 120 that is connected to high-speed bus 112. GPU 120 is well-suited for performing matrix operations including parallel operations on large matrices. However, GPU 120 is not inherently optimized for computation tasks that either involve differential equations, probabilities, non-linear complexities, non-sequential processes or entail still other complexities including ones encountered in non-classical models such as those found in quantum models including quantum cognition models.

High-speed bus 112 also connects to three different specialized processing units 122, 124 and 126. In the present example embodiment specialized processing unit 122 is a Graph Processing Unit, specialized processing unit 124 is a Non-Classical Processing Unit and specialized processing unit 126 is a Classical Processing Unit but not a GPU. Specialized processing units 122, 124 and 126 differ from GPU 120 in that they are not specialized nor tuned for processing of large numbers of parallelized operation on large matrices. Instead, specialized processing units 122, 124, 126 are designed for other types of operations or computation tasks, such as computation tasks that involve graph-based computations, differential equations and tasks that capture probabilistic and/or complexities such as those found in non-classical models that include quantum cognition models and other computation tasks, as explained in more detail below.

CPU 108 is central to integrated computing architecture 100. It orchestrates data traffic to and from all processing units 120, 122, 124, 126 via high-speed bus 112. Specifically, layered data set 102 has a number of data layers 102A, 102B, 102C through 102N, as diagrammatically illustrated within the dashed outline. Each one of data layers 102A through 102N belonging to layered data set 102 is tagged in its corresponding metadata 128A through 128N that contain layer type descriptors 130A through 130N. It should be noted that tagging data layers 102A, through 102N with layer type descriptors 130A through 130N in metadata 128A through 128N is convenient and preferred. However, in alternative embodiments layer type descriptors 130A through 130N may be contained in data layers 102A through 102N themselves.

Integrated computing architecture 100 is designed for distributing layered data set 102 and more specifically its data layers 102A, 102B, 102C through 102N to processing units 120, 122, 124, 126 based on layer type descriptors 130A through 130N. More specifically still, data layers 102A, 102B, 102C through 102N are distributed by CPU 108 via high-speed bus 112 to processing units 120, 122, 124, 126 according to at least two different computation tasks as gleaned from layer type descriptors 130A through 130N.

Layer type descriptors 130A through 130N in metadata 128A through 128N preferably include information that has parameters such as dimensions, activation functions, attention mechanisms, hyperparameters, positional encodings, feed-forward networks, non-classical data indicators and entanglement suspects. These types of parameters can further include specific indication of the most appropriate processing unit to deploy. For example, any one of data layers 102A through 102N can be tagged in its corresponding metadata 128A through 128N as suited for standard learning or not.

In fact, after each one of data layers 102A through 102N is defined and before the model is fully compiled, a designer can manually tag certain data layers 102A through 102N as most appropriate for specific types of computing tasks and/or processors/coprocessors. For example, the designer can tag data layers 102A through 102N as appropriate for image processing on GPU 120, or for graph-data processing on specialized processing unit 122, or for classical processing such as solving Neural Ordinary Differential Equations (ODEs) on specialized processing unit 126, or else for processing by non-classical models such as quantum models on specialized processing unit 124.

The manual tagging with layer type descriptors 130A through 130N is preferably incorporated into corresponding metadata 128A through 128N as part of the overall design of integrated computing architecture 100. Alternatively, tagging with layer type descriptors 130A through 130N can be included in comments in the code of corresponding data layers 102A through 102N to be interpreted by the compiler or execution engine.

During operation, integrated computing architecture 100 uses system bus 110 to send layered data set 102 from Random Access Memory (RAM) 104, and potentially also from Cache 106 (in situations where a portion of layered data set 102 resides in Cache 106) to CPU 108. This transfer is indicated schematically by the dashed outline commencing at RAM 104 and terminating at CPU 108.

FIG. 1B is a diagram that shows the operation of CPU 108 of integrated computing architecture 100 in more detail, starting with the receipt of layered data set 102 via system bus 110. Each data layer 102A through 102N of layered data set 102 arrives in CPU 108 accompanied by its corresponding metadata 128A through 128N. The diagram of FIG. 1B focuses on the processing of just two data layers, namely data layers 102A and 102B for reasons of clarity. Data layers 102A, 102B are tagged with layer type descriptors 130A, 130B contained in their metadata 128A, 128B.

In a first step, CPU 108 identifies layered data set 102. In the present example it identifies data layers 102A, 102B based on layer type descriptors 130A, 130B contained in their metadata 128A, 128B. The identification is preferably based on data type which includes typical data identifiers as well as data structure.

In the present example, data layer 102A contains image data. Thus, layer type descriptor 130A in metadata 128A identifies image size, focal length, shutter speed, ISO settings, resolution, gray scale range (or color), grid-structure and other text information pertaining to the image, such as location, time taken, captions, camera type and other useful parameters. In the event where data layer 102A contains a video additional identifying information is present in layer type descriptor 130A. Such additional identifying information can include frame rate and motion parameters.

Once CPU 108 has identified data layer 102A as image data based on layer type descriptor 130A it separates or assigns data layer 102A to one of at least two subsets. The subsets are chosen according to the type of data and hence the kind of downstream processing requirements or computation task to be performed on data layer 102A. Image data in data layer 102A is assigned by CPU 108 to a first type data subset 132. Further, CPU 108 assigns first type data subset 132 to a first computation task 134.

First computation task 134 is intended for grid-like data structures such as images or video. In fact, first computation task 134 is for data that follows classical patterns that are ideal for standard learning models and distributed or parallelized matrix operations. Thus, first computation task 134 is intended for GPU 120 (see FIG. 1A).

FIG. 1C illustrates the handling of data layer 102A identified as first type data subset 132 and assigned to first computation task 134 in more detail. CPU 108 routes data layer 102A via high-speed bus 112 to GPU 120. GPU 120 is well-suited for performing matrix operations including parallel operations on large matrices. In this example GPU 120 is set up for a machine learning process involving a neural network 136. Neural network 136 has an input layer 138 for receiving image data of data layer 102A. Neural network 136 has a number of hidden layers 140 that have been trained for classification of objects or features in image data according to any convenient training process known in the art. Finally, neural network 136 has an output layer 142 that classifies objects found in image data of data layer 102A. In the present example, network 136 discerns classified objects 144, specifically objects O1, O2 and O3 from image data of data layer 102A as indicated. Also, in the present example, classified objects 144 are sent back to CPU 108 via high-speed bus 112 for any additional processing or output to a user.

Returning now to FIG. 1B, we see that data layer 102B contains graph data. Thus, layer type descriptor 130B in metadata 128B identifies graph parameters such as number of nodes, number of edges, connectivity and other useful graph parameters. Once CPU 108 has identified data layer 102B as graph data based on layer type descriptor 130B it separates or assigns data layer 102B to one of the two types of data subsets 132, 146. Unlike image data of data layer 102A, graph data in data layer 102B is assigned by CPU 108 to second type data subset 146. Further, CPU 108 assigns second type data subset 146 to a second computation task 148.

FIG. 1D illustrates the handling of data layer 102B identified as second data type subset 146 and assigned to second computation task 148 in more detail. Since data layer 102B is intended for specialized processing unit 122 which is a Graph Processing Unit, CPU 108 routes data layer 102B via high-speed bus 112 to specialized processing unit 122 that is designed for handling graph-based computations. It should be noted that graph-based computations are useful in network analysis, social network analytics and certain machine learning tasks. A person skilled in the art will be familiar with graph-based computations. In general, graph-based computational methods rely on treating edges as representing arguments (functions or data dependencies) and as pointers to nodes. A node with an incoming edge is related to the originating node from which the edge originates by a function. Thus, nodes know how to computer their values in the context of the graph. A person skilled in the art will also appreciate that graph-based computation can rely on a deep learning model.

Turning again to FIG. 1B, we see that layer type descriptor 130B of data layer 102B also includes a suspected non-classical metadata indicator NC. Although suspected non-classical metadata indicator NC is contained in metadata 128B, it is shown separately in FIG. 1B with segment 150 suspected of exhibiting non-classical behavior being explicitly identified.

Preferably, once CPU 108 is alerted that segment 150 in data layer 102B is suspected of non-classical behavior, it prepares an adjusted data layer 102B′ with segment 150 explicitly identified or labeled. Meanwhile, the remainder of the graph information (nodes and connections) of data layer 102B are deemphasized in adjusted data layer 102B′. Adjusted data layer 102B′ with segment 150 explicitly identified is shown enlarged, in dashed outline and labeled with a prime for clarity. Deemphasis can range from complete removal from the graph of nodes and connections that are not part of segment 150 to indication that nodes and connections that art not part of segment 150 are not to be processed.

Specifically, suspected non-classical metadata indicator NC identifies six nodes n1, n2, n3, n4, n5, n6 and three edges e1, e2, e3 forming three node pairs as segment 150 of adjusted data layer 102B′. These three node pairs, namely n1-n2, n3-n4 and n5-n6 are suspected of exhibiting non-classical behavior. All six nodes n1, n2, n3, n4, n5, n6 are indicated by hatching and all three edges e1, e2, e3 are indicated with thick dashed lines in the drawing figure for clarity.

Non-classical behavior in the present case means that the behavior of three pairs of nodes n1-n2, n3-n4 and n5-n6, e.g., the sequence of states assumed by them, defies description by standard Bayesian/Boolean logic. In fact, the states of nodes in pairs n1-n2, n3-n4 and n5-n6 exhibit a correlation that transcends any classical causal relation. The correlation may involve non-classical effects, such as quantum entanglement.

In preferred implementations of the invention, CPU 108 performs a non-classicality test on segment 150 tagged in metadata 128B with suspected non-classical metadata indicator NC. A useful non-classicality test in the present case is factorizability. In this test pairs of nodes n1-n2, n3-n4 and n5-n6 connected by their respective edges e1, e2, e3 are tested for separability of states.

Factorizability is a standard and well-known tool in the field of quantum mechanics. Factorizability is used for determining whether pairs of entities (e.g., electrons, ions or photons) are potentially entangled. When the connected states are factorizable then there is no entanglement. On the other hand, when the connected states are not factorizable then they are considered entangled in the quantum sense. In more complicated cases with more interconnected states advanced tests including the Peres-Horodecki criterion can be deployed by CPU 108 to test for entanglement.

Once CPU 108 has confirmed with the non-classicality test that adjusted data layer 102B′ with segment 150 is suspect for non-classical behavior it assigns data layer 102B′ with segment 150 to second type data subset 146. Further, CPU 108 assigns second data type subset 146 to second computation task 148.

We return to FIG. 1D to follow the handling of adjusted data layer 102B′ identified as second data type subset 146 and assigned to second computation task 148 in more detail. Data layer 102B′ is intended for specialized processing unit 124 which is designed for second computation task 148 that involves entangled data. Thus, CPU 108 routes adjusted data layer 102B′ via high-speed bus 112 to specialized processing unit 124, as shown.

Specialized processing unit 124 can be a Quantum Coprocessor, a Quantum Computer or a Quantum Simulator. The choice of specialized processing unit 124 will depend on the specialized computation model that is to be deployed on segment 150 of adjusted data layer 102B′. There exists a variety of specialized computation models that apply when segment 150 is suspected of being a non-classical or a quantum data segment. The computation models also depend on the tasks to be accomplished by specialized processing unit 124. In the context of the present invention suitable computation models include a quantum cognition model, a sequence of quantum gates, a generator of entangled qubits for quantum key distribution, a noise-mitigation algorithm for minimizing quantum errors, a hybrid quantum-classical optimization loop, a sequence of quantum operations followed by classical operations, a quantum Fourier transform, a generator of entangled states with a controlled-NOT gate, a quantum error correction code, a quantum state preparation and measurement sequence, a quantum walk algorithm as well as a quantum search algorithm among other.

In some cases, specialized processing unit 124 and computation model can be deployed on a noisy intermediate-scale quantum (NISQ) unit. Such quantum processing units belong to the present NISQ era (a term coined by John Preskill in 2018). These units typically contain up to 1,000 qubits (and often fewer than 100) that are not yet sufficiently advanced to achieve fault-tolerance and are not large enough to handle large scale processes. Furthermore, they are noisy due to interactions with their environment and prone to quantum decoherence as no robust quantum error correction is available at present. While NISQ units can implement computation models such as variational quantum eigensolver (VQE) and quantum approximate optimization algorithm (QAOA) they still offload some calculations to classical processors. Using this approach, computation models on NISQ units with classical processor support have found success in quantum chemistry and have potential for applications in fields ranging from physics, materials science, data science, cryptography, biology and finance. Correspondingly, specialized processing unit 124 can be a hybrid unit having a NISQ unit and a classical processor support unit.

In the example shown in FIG. 1D specialized processing unit 124 is instantiated by a classical processing unit configured to run a computation model of quantum state preparation and measurement sequence. Under this computation model each node in node pairs n1-n2, n3-n4, n5-n6 is first assigned to a qubit. The qubits are pair-wise entangled, given that the states they are to represent did not factorize during the test performed by CPU 108.

The initial assignment of the entangled state for each pair can be obtained by various methods known from the fields of physics and/or quantum computing. In the present example the state is estimated based on standard Schmidt decomposition of inner spaces of each pair of qubits representing each node pair. The entangled state is thus a vector belonging to the tensor product space of state space H₁ of the first node in the pair and state space H₂ of the second node of the pair. The entangled state or state vector is contained in the tensor product space formally expressed as:

$${H}_{1} ⊗ {H}_{2} \qquad Eq . 1$$

Each state is a vector belonging to this tensor space and it is assigned to each node pair by specialized processing unit 124. By this convention maximally entangled states will be described by one of the four Bell states:

$$\vert {ϕ}^{\pm } = \frac{1}{\sqrt{2}} ( \vert - , - \pm \vert + , + ) = \frac{1}{\sqrt{2}} ( \vert 00 \pm \vert 11 ) , \qquad Eq . 2 a$$

$$\vert {ψ}^{\pm } = \frac{1}{\sqrt{2}} ( \vert - , + \pm \vert + , - ) = \frac{1}{\sqrt{2}} ( \vert 01 \pm \vert 10 ) . \qquad Eq . 2 b$$

The entangled data thus represented by qubits in specialized processing unit 124 are data that represent situations where a change in the state of one node in a pair, e.g., n1, instantaneously affects the other node of the pair, here node n2. The assignment of the state by specialized processing unit 124 completes the step of quantum state preparation.

During the next step and prior to measurement the state of each pair may be subject to some evolution including application of a certain amount of decoherence. Such steps can be applied by specialized processing unit 124 by following known algorithms and, when using a quantum computer, by applying a known set of quantum gate operations.

During the measurement stage one or both qubits standing in for node pairs n1-n2, n3-n4, n5-n6 are measured. The choice of basis/bases in which measurement(s) of qubit/qubits is/are performed can be randomly selected. Alternatively, the bases can be pre-set. Conveniently, one of the bases can be the z-basis (along the Z-axis) represented by Pauli matrix σ₃. The other orthogonal bases (along the X- and Y-axes) are represented by Pauli matrices σ₁, σ₂. By standard procedure, a measurement in a basis PRᵤ along an arbitrary axis u can then be derived using Pauli matrices as follows:

$${PR}_{u} = \hat{u} \cdot \overline{σ} = {u}_{x} {σ}_{1} + {u}_{y} {σ}_{2} + {u}_{z} {σ}_{3} . \qquad Eq . 3$$

Given that specialized processing unit 124 is a classical processor in the present case, it applies the probabilities of projection onto one of the two eigenvectors in the selected basis using a standard random number generation process. The outputs, or the measurements obtained on the qubits in this manner are sent back to CPU 108 via high-speed bus 112 for any additional processing or output to a user (not shown).

Returning now to FIG. 1B, we observe that CPU 108 identifies remaining data layers 102C through 102N based on layer type descriptors 130C through 130N and separates or assigns these data layers 102C through 102N to one of the two types of data subsets 132, 146. All data to be processed by GPU 120 is thus assigned to first type data subset 132 and all data to be processed by one of specialized computation units 122, 124, 126 is assigned to second type data subset 146. Correspondingly, all data is assigned by CPU 108 to first and second computation tasks 134, 148.

Second computation task 148 is further divided up between specialized processing units 122, 124, 126. Again, as seen by returning to FIG. 1A, in the present exemplary embodiment specialized processing unit 122 is designed for processing graph-based data. Meanwhile, specialized processing unit 126 is designed for classical processing such as solving Neural Ordinary Differential Equations (ODE), and specialized processing unit 124 is designed for handling non-classical models such as quantum models.

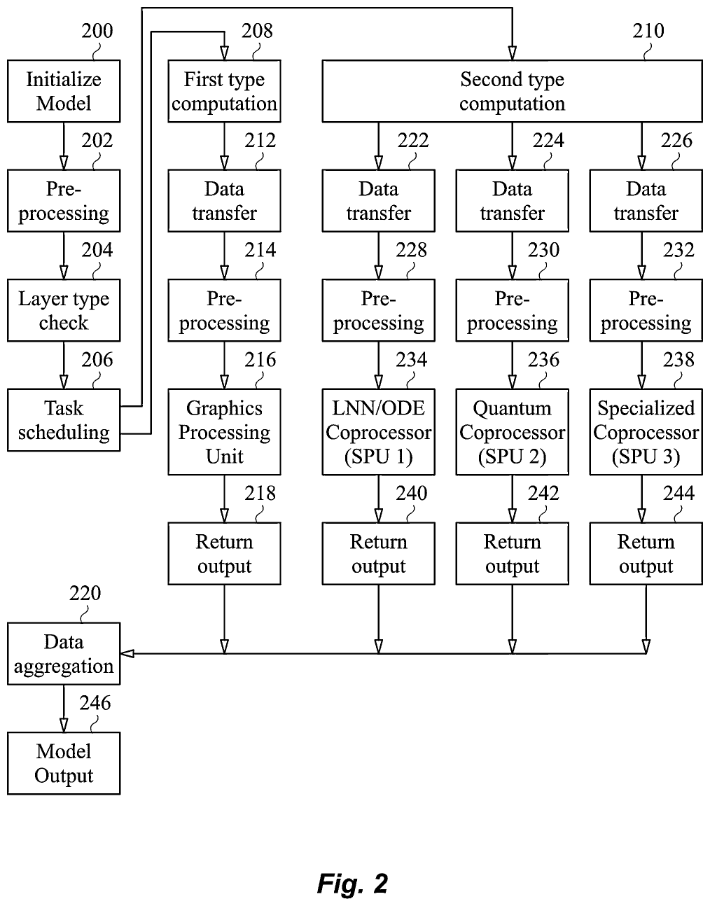

FIG. 2 is a flow diagram illustrating the logic flow deployed by an integrated computing architecture working with layered data sets according to the invention. The logic flow can be deployed by integrated computing architecture 100 of FIG. 1A or by another embodiment of integrated computing architecture according to the invention.

In a first step 200 the overall model for handling layered data sets is initialized. By performing first step 200 integrated computing architecture is set up to receive layered data sets. In a second step 202 layered data sets are pre-processed. Second step 202 can include decoding, formatting, normalizing and other standard pre-processing procedures known to those skilled in the art. In a third step 204 the metadata of the layers belonging to the layered data set is checked for layer type. In step 204 data layers that belong to first type data subsets to be handled by standard techniques or by a first computation task executed by a GPU, and second type data subsets to be handled by specialized techniques or by second computation task executed by specialized processing units are identified. In step 206 first type data subsets and second type data subsets identified in step 204 are received and formally separated or scheduled by task. Task scheduling step 206 prepares data in first type computation batch 208 and second type computation batch 210 to be sent via standard interface connections. In fact, when the logic flow of FIG. 2 is implemented on integrated computing architecture 100 of FIG. 1A the above listed steps 200 through 210 are executed by CPU 108 (see FIGS. 1A and 1B).

First type data subset here in the form of first type computation batch 208 is transferred to at least one Graphics Processing Unit (GPU) in step 212. This step deploys the communication infrastructure of the integrated computing architecture. For example, when the logic flow of FIG. 2 is implemented on integrated computing architecture 100 of FIG. 1A data transfer step 212 deploys high-speed bus 112 of integrated architecture 100 (see FIG. 1A).

In step 214 first type computation batch 208 is pre-processed. Step 214 can include decoding, formatting, normalizing and other standard pre-processing procedures known to those skilled in the art. Once pre-processed, GPU performs first type computation task in step 216. Again, first type computation task involves standard computations that take advantage of GPU strengths. In step 218 GPU duly formats and delivers the output of first type computation. In other words, step 218 yields a return output. Return output is routed back to a data aggregation step 220 via the communication infrastructure of the integrated computing architecture (e.g., high-speed bus 112 in the case of integrated computing architecture 100 as shown in FIG. 1A). Data aggregation 220 can be performed by CPU 108 when using integrated computing architecture 100 of FIG. 1A.

Meanwhile, second type data subset here in the form of second type computation batch 210 is transferred in steps 222, 224, 226 to at least one, and in the present exemplary case to three specialized processing units. Data transfer steps 222, 224, 226 take advantage of the communication infrastructure of the integrated computing architecture (e.g., high-speed bus 112 in the example of integrated architecture 100 of FIG. 1A).

In steps 228, 230, 232 second type computation batch 210 is pre-processed. Steps 228, 230, 232 can include decoding, formatting, normalizing and other standard pre-processing procedures known to those skilled in the art. Some specialized pre-processing may be deployed for quantum models in step 230, such as identifying the level of entanglement (e.g., between maximally entangled states down to less entangled and even minimally entangled). Once pre-processed, second type data subsets forming second type computation batch 210 are separately delivered for execution according to the three different second type computation tasks 234, 236, 238.

The first of second type computation tasks, namely task 234 is executed on a special processing unit embodied by a Liquid Neural Net (LNN) and/or Ordinary Differential Equation (ODE) processing unit. Solving models that involve LNN/ODE is not well suited to GPUs. Specifically, task 234 can involve computations that are well-suited for LNNs based on one or more of the considerations identified below.

1. Temporal Dynamics: LNNs often deal with spiking neurons and time-dependent network dynamics, which aren't inherently suited to the matrix-based, feed-forward nature of GPUs. Specialized hardware embodied by LNN/ODE coprocessor offers better simulation of such temporal dynamics.

2. Adaptive Learning: The plasticity and adaptability in LNNs may be better supported by architectures that can rapidly and efficiently adjust network parameters on the fly.

3. Neuromorphic Hardware: Neuromorphic computing architectures, which emulate the biological structure of neural networks, could be a natural fit for Liquid Neural Networks, allowing for more efficient simulations and potentially leading to real-time learning and adaptation.

Furthermore, it is known that GPUs are not efficient in solving differential equations. This is due to a number of reasons including: 1. Non-Linearity: Differential equations, especially non-linear ones, often require iterative, serial computation, which is antithetical to the parallel computing paradigm at which GPUs excel. 2. Adaptive Time Stepping: Problems like Neural ODEs often employ adaptive time-stepping algorithms to ensure numerical stability and accuracy, which again is a serial process ill-suited for GPUs. 3. Memory Access Patterns: Solving ODEs usually involves irregular memory access patterns and data dependencies that don't align well with the GPU's architecture, which is optimized for regular, batched access patterns. In light of these limitations, task 234 can involve computations that are well-suited for Neural ODEs such as one of the those identified below.

1. Differential Equation Solvers: Architectures optimized for ODEs could implement specialized hardware solvers that perform adaptive time-stepping, root-finding, and other numerical methods more efficiently than general-purpose processors like GPUs.

2. Low-Latency Communication: Neural ODEs often require fine-grained data dependencies that involve irregular memory access patterns. An architecture that allows for low-latency, high-bandwidth communication between processing elements can significantly speed up these computations.

3. Energy Efficiency: A specialized chip could be more power-efficient for the iterative calculations often required by Neural ODEs.

The second of second type computation tasks, namely task 236 is executed on a special processing unit embodied by a Quantum Coprocessor. Solving quantum models is not well suited to GPUs. Specifically, task 236 can involve computations that are not suitable for GPUs because of the considerations identified below.

1. Complexity: Quantum models often involve complex numbers and non-commutative operations that are not easily decomposable into the kinds of linear algebra operations that GPUs are designed for.

2. Hilbert Spaces: Quantum systems are generally described in infinite-dimensional Hilbert spaces, and their approximations in these spaces cannot always be efficiently performed via straightforward matrix operations.

3. Quantum Gates: Quantum algorithms often use specialized quantum gates that do not translate well to standard matrix operations. Simulating these gates on a classical GPU could be inefficient in terms of both time and memory.

In light of these limitations, task 236 involves computations that are not well-suited for the GPU but are well-suited for Quantum Coprocessor. It should be also noted that Quantum processing involves a number of distinguishing features, such as:

1. Quantum Processing Units (QPUs): Real quantum computing hardware is fundamentally different from classical hardware, and specialized quantum processors would be needed to simulate or implement quantum algorithms efficiently.

2. Precision: Quantum models often require high-precision calculations, and a specialized architecture could be optimized to provide this level of precision more efficiently than a general-purpose GPU.

3. Hilbert Space Calculations: As mentioned earlier, quantum systems often require operations in high-dimensional spaces that are difficult to approximate accurately with matrix operations. Specialized hardware could offer more direct and efficient means of performing these calculations.

Finally, the third of second type computation tasks, namely task 238 is performed by a Specialized Processor that is better matched to the computations than GPUs. Specialized Coprocessor for task 238 should be selected based on task 238 and in light of GPU limitations and specifics of task 238 identified below.

1. Granularity of Parallelism: While GPUs are great for coarse-grained parallelism where the same operation is performed on many data elements, they are less efficient for fine-grained parallelism, which is often required for differential equations and quantum simulations.

2. Latency: In algorithms that require frequent synchronization or have dependencies between different parts of the data, the latency overhead in a GPU can negate the benefits of parallelism.

3. Power Efficiency: While GPUs can perform a large number of operations per second, they are not always the most power-efficient option for all types of computations.

4. Overheads: The overhead of transferring data to and from the GPU can also be a bottleneck, particularly when the computation on the GPU is not sufficiently intense to amortize this cost.

To sum up the need for specialized processors in the integrated computing architecture of the invention the following points should be stressed. While it is true that nearly all mathematical models can be approximated by linear algebra, this often involves significant computational overhead, loss of precision, or both. This is why specialized architectures, like neuromorphic chips for Neural ODEs or Quantum Processing Units (QPUs) for quantum models, may offer more efficient alternatives for these types of calculations. While GPUs excel at tasks that can be broken down into matrix operations, certain types of computation like Neural ODEs, Liquid Neural Networks (LNN), and Quantum Models may benefit from specialized architectures that are designed for their specific needs. In each of these cases, the specialized nature of the computations involved suggests that they could benefit from dedicated hardware that is designed with their unique requirements in mind. Such specialized hardware could offer significant advantages in terms of speed, power efficiency, and computational accuracy, making it possible to tackle problems that are currently computationally intractable or highly inefficient on general-purpose architectures like GPUs.

Once first, second and third tasks 234, 236, 238 are computed on specialized processors they are duly formatted and returned as outputs in corresponding return output steps 240, 242, 244. Return outputs 240, 242, 244 are routed back to a data aggregation step 220 via the communication infrastructure of the integrated computing architecture (e.g., high-speed bus 112 in the case of integrated architecture 100 as shown in FIG. 1A). Data aggregation 220 can be performed by CPU 108 when using integrated computing architecture 100 of FIG. 1A.

Aggregated data from data aggregation step 220 is passed to model output step 246. Model output of step 246 can be presented jointly or separately for results from each computation task 216, 234, 236, 238. Joint presentation of model output can be appropriate where original layered data set or sets are related to each other by overall topic. When the layers of the layered data set are related loosely the model output can be presented as separate outputs or groups of outputs.

The splitting of computation tasks 216, 234, 236, 238 integrated computing architecture according to the invention is performed to take advantage of the best computation resources given the nature of the computation tasks. As noted, GPUs are best for first computation task 216 that involves grid-like data structures such as images or video. Meanwhile, specialized processing units are best for the three different computation tasks 234, 236, 238 of the second type that involve specialized models.

In general, where non-classicality is not at issue, specialized processing units for performing computation tasks 234, 236, 238 can be selected from a wide variety of suitable specialized processing units that compute classically according to the nature of the computation task at hand. In other words, specialized processing unit 126 (see FIG. 1A) and/or any additional specialized processing units not shown are preferably selected based on the nature of the computation task. Exemplary specialized processing units can be selected from among Liquid Neural Network Processing Units and Neural Ordinary Differential Equations Processing Units. In these embodiments the specialized computation model and corresponding computation task to be implemented can be an initial value solver for Neural Ordinary Differential Equations by adaptive Runge-Kutta methods, a fast Jacobian Matrix evaluation for implicit Ordinary Differential Equation solution, a real-time simulation of Liquid Neural Networks with a sparse connectivity matrix, a hardware-accelerated bifurcation analysis to identify parameter regimes where the dynamics of Neural Ordinary Differential Equations change qualitatively, a backpropagation through time for Liquid Neural Networks by storing and replaying neural states, a time-stepping algorithm for solving partial differential equations related to Neural Ordinary Differential Equations, a gradient descent algorithm, a reservoir computing task with projection of high-dimensional inputs onto lower-dimensional liquid states, an evaluation of stability of fixed points and limit cycles in Neural Ordinary Differential Equation systems, a sensitivity analysis for quantifying impact of parameter variations on Neural Ordinary Differential Equation solutions, a simulation of spiking neural networks with integrate-and-fire models or Hodgkin-Huxley models and a hardware-accelerated Fast Fourier Transform for frequency domain analysis of Liquid Neural Networks among other.

Of course, as evident from the flow diagram of FIG. 2, it is also possible to run both non-classical and classical computation tasks based on corresponding non-classical and classical models concurrently. Indeed, layered data 102 set can contain many more data layers besides those expressly shown in FIG. 1A, that are designated for different computation tasks. Some of these computation tasks can be intended for the GPU, while others for specialized processing units in charge of classical computation tasks, and still others for non-classical computation tasks. In such embodiments the choice should be made whether the GPU and the at least one specialized processing unit operate asynchronously or synchronously.

### Coprocessor Selection in Integrated Computing Architecture

### 1. Coprocessor Selection Algorithm: The Intelligent Task Distributor

The deployment of the integrated computing architecture of the invention benefits not only from the diverse array of processing units, but also in intelligent and dynamic computation task distribution performed by the CPU. In some embodiments the CPU has an algorithm for selecting the specialized processing units or coprocessors. Such coprocessor selection algorithm is an intelligent task distributor. The selection algorithm or Coprocessor Selection Algorithm is the orchestrator at the heart of the integrated computing architecture. It assigns computation tasks efficiently and seamlessly to the most suitable processing unit. Such assignment ensures that each task is executed with unparalleled performance, efficiency and accuracy. The algorithm's decision-making prowess is rooted in a combination of explicit criteria and implicit pattern recognition, guaranteeing that each task is entrusted to the hardware best equipped to handle the unique requirements of the computation task. The algorithm's sophistication is particularly evident in its ability to discern and manage quantum-related tasks, leveraging specific metadata indicators and non-classicality tests to route such tasks to the Quantum Processing Unit (QPU), thereby unlocking the transformative potential of quantum computing for specialized applications.

### A. The Decision-Making Engine: The Brain of the Architecture

The Coprocessor Selection Algorithm functions as the intelligent command center of the integrated computing architecture, orchestrating the intricate ballet of data and tasks among the various processing units. It scrutinizes each incoming task and its associated data, making real-time decisions on the optimal processing unit for execution. The algorithm's decision-making process is not merely a series of if-then statements, but a sophisticated evaluation based on well-defined criteria, ensuring that each task is assigned to the most suitable hardware, thereby maximizing performance and efficiency. The algorithm's intelligence shines through in its ability to identify and handle quantum-related tasks, leveraging specific metadata indicators and non-classicality tests to route such tasks to the QPU. This empowers the architecture to exploit the unique capabilities of quantum computing, opening doors to groundbreaking applications and solutions.

### B. Explicit Decision Criteria: The Pillars of Intelligent Task Distribution

The Coprocessor Selection Algorithm employs a multi-faceted approach to task distribution, considering a range of factors to make informed and strategic decisions:
Data Type and Structure: The inherent nature of the data serves as a cornerstone in coprocessor selection. The algorithm meticulously identifies the data type (e.g., images, graphs, quantum states) and its underlying structure (e.g., matrices, tensors, sparse matrices) to pinpoint the most appropriate processing unit. For instance, tasks involving large-scale matrix operations are typically entrusted to GPUs, renowned for their parallel processing capabilities and prowess in handling large matrices. Conversely, tasks dealing with sparse matrices or graph-structured data may find their ideal execution environment in specialized coprocessors, designed to excel in these specific domains.
Computational Model: The specific computational model or algorithm required for the task is another critical determinant in coprocessor selection. The algorithm dissects the model's characteristics, such as its reliance on matrix operations, differential equations, probabilistic models, or quantum gates, to identify the processing unit with the most harmonious architecture and capabilities. For example, tasks involving quantum simulations would necessitate the utilization of a Quantum Coprocessor, while those requiring the solution of differential equations might be better handled by a specialized ODE solver.
Layer Type Descriptors: The metadata associated with each data layer acts as a treasure trove of insights into the computational requirements of the task. The algorithm leverages these layer type descriptors, which can include information about data dimensions, activation functions, attention mechanisms, and even indicators of non-classical data or entanglement suspects, to further refine its decision-making process. This ensures that tasks with specific requirements, such as those involving quantum cognition or non-sequential operations, are directed to the most capable coprocessor, thereby optimizing the utilization of the architecture's diverse resources.
Performance and Efficiency Considerations: In addition to the aforementioned criteria, the algorithm also takes into account the performance and efficiency characteristics of each processing unit. It considers factors such as the computational intensity of the task, the available memory and bandwidth of each unit, and the potential communication overhead involved in data transfer. By dynamically assessing these factors, the algorithm ensures that tasks are assigned to the processing unit that can execute them most efficiently, maximizing overall system performance and minimizing energy consumption. This real-time optimization guarantees that the architecture operates at its peak potential, delivering exceptional results while conserving resources.

### C. Identifying Quantum-Suitable Problems: The Quantum Litmus Test

The algorithm's ability to discern the quantum nature of a computational task is a testament to its sophistication and adaptability. It employs a multi-pronged approach, encompassing both explicit indicators and rigorous non-classicality tests, to identify problems that can harness the unique capabilities of quantum computing.
1. Metadata Indicators: The Quantum Roadmap. The layer type descriptors associated with the data can contain explicit indicators that act as a roadmap, guiding the algorithm towards the potential for quantum advantage. These indicators could include flags for non-classical data, entanglement suspects, or specific quantum algorithms or models mentioned in the task description. The presence of such indicators serves as a strong signal that the task might benefit from the QPU's specialized capabilities.
2. Non-Classicality Tests: Unveiling Quantum Signatures. In the absence of explicit indicators, the algorithm doesn't falter. It employs a battery of non-classicality tests on the data to assess its suitability for quantum computing. These tests act as a litmus test, revealing the hidden quantum signatures within the data:
   Factorizability Test: The Entanglement Probe. This test scrutinizes the states described by the data, determining whether they are separable or entangled. The presence of entanglement, a hallmark of quantum systems, strongly suggests the potential for quantum advantage and triggers the routing of the task to the QPU.
   Contextuality Test: The Quantum Contextuality Probe. This test examines if the data exhibits contextuality, a phenomenon where the outcome of a measurement is intrinsically dependent on the context in which it is performed. Contextuality is a defining characteristic of quantum systems and its presence in the data serves as a compelling indicator for leveraging the QPU's capabilities.
   Quantum Advantage Assessment: The Efficiency Oracle. The algorithm doesn't rely solely on qualitative indicators. It employs a quantitative assessment of potential quantum advantage by comparing the computational complexity of classical and quantum algorithms for the given task. If a substantial quantum advantage is predicted, the task is swiftly dispatched to the QPU, ensuring optimal utilization of resources and maximizing computational efficiency.

The combination of explicit metadata indicators and rigorous non-classicality tests empowers the Coprocessor Selection Algorithm to confidently identify quantum-suitable problems, even in the absence of clear directives. This intelligent decision-making capability ensures that the integrated computing architecture harnesses the full potential of quantum computing, paving the way for groundbreaking advancements in various fields.

### D. Routing to the Quantum Processing Unit (QPU): The Quantum Conduit

The identification of a quantum-suitable task triggers a seamless transition, where the algorithm orchestrates the routing of the task, along with its associated data and instructions, to the Quantum Processing Unit (QPU). The QPU, equipped with specialized hardware and software tailored for quantum computations, serves as the architecture's quantum powerhouse, harnessing the principles of quantum mechanics to execute the task with exceptional efficiency and precision. The algorithm ensures that this transition is smooth and efficient, facilitating seamless communication and data transfer between the CPU and the QPU. This dynamic interplay between classical and quantum processing units optimizes the utilization of quantum resources, ensuring that the architecture delivers exceptional performance across a diverse range of computational tasks, particularly those that can exploit the unique advantages of quantum computing.

### E. The Adaptive Learning Engine: Evolving Intelligence

The Coprocessor Selection Algorithm's implicit prediction capability, while already powerful, can be further amplified through the integration of machine learning techniques. By training the algorithm on a vast and diverse dataset of tasks and their corresponding optimal coprocessor assignments, the algorithm can evolve into a self-learning engine, capable of recognizing patterns and making informed predictions even in the absence of explicit guidance. This adaptive learning capability allows the algorithm to stay ahead of the curve, efficiently handling new and evolving computational tasks that may not fit neatly into predefined categories. The algorithm's continuous learning ensures that the integrated computing architecture remains agile and responsive, ready to tackle the ever-increasing complexity and diversity of modern workloads.

### F. The Future of Computing: Unleashing the Power of Integration

The enhanced Coprocessor Selection Algorithm, with its refined criteria, explicit mechanisms for identifying quantum-related tasks, and its implicit prediction capabilities, establishes the integrated computing architecture as a groundbreaking innovation. By intelligently distributing tasks among its diverse processing units, the architecture unlocks the full potential of both classical and quantum computing, paving the way for a new era of computational capabilities across various fields. This invention represents not just an incremental improvement but a quantum leap in computing architecture, poised to revolutionize how we approach and solve complex problems in the years to come.

### 2. Diverse Array of Specialized Coprocessors

The integrated computing architecture's adaptability shines through its capacity to seamlessly incorporate a wide spectrum of specialized coprocessors, each meticulously designed to accelerate specific computational tasks and unleash the full potential of the system. The Coprocessor Selection Algorithm intelligently identifies tasks suitable for each coprocessor based on data types, computational models, and layer-specific metadata, ensuring efficient task distribution and optimal performance. The architecture's modular and extensible nature empowers it to evolve in tandem with advancements in computing technology, catering to the ever-expanding landscape of applications. The following list highlights potential coprocessors that can be integrated based on the unique demands of each application:
Graphics Processing Unit (GPU): The cornerstone of parallel processing, excelling at matrix operations and powering many machine learning and deep learning workloads. The Coprocessor Selection Algorithm would typically route tasks involving large-scale matrix operations, image recognition, and scientific simulations to the GPU.
Quantum Processing Unit (QPU): The vanguard of quantum computing, harnessing the unique properties of quantum mechanics to tackle problems intractable for classical computers. The algorithm would identify tasks involving quantum simulations, cryptography, and optimization as prime candidates for execution on the QPU, particularly when non-classicality tests or metadata indicators suggest a potential quantum advantage.
Natural Language Processing (NLP) Coprocessor: Dedicated to accelerating language understanding and generation tasks, enabling advanced applications in machine translation, sentiment analysis, and conversational AI. The algorithm would recognize tasks involving natural language data and complex language models as suitable for this coprocessor.
Cryptographic Coprocessor: A guardian of data security and privacy, accelerating encryption, decryption, and other cryptographic operations to safeguard sensitive information. The algorithm would direct tasks involving sensitive data or requiring secure communication to this coprocessor.
Computer Vision Coprocessor: Empowering the architecture with advanced image and video processing capabilities, enabling real-time object recognition, image classification, and video analysis. Tasks involving image or video data, particularly those requiring real-time processing, would be routed to this coprocessor by the algorithm.
Signal Processing Coprocessor: A maestro of signal analysis and manipulation, adept at handling audio processing, radar signal processing, and sensor data fusion, crucial for applications in telecommunications, healthcare, and autonomous systems. The algorithm would identify tasks involving complex signal processing and real-time analysis as suitable for this coprocessor.
Neuromorphic Coprocessor: Mimicking the structure and function of the human brain, this coprocessor holds the promise of revolutionizing tasks involving pattern recognition, learning, and decision-making. The algorithm could potentially route tasks requiring brain-inspired computation or those involving spiking neural networks to this coprocessor.
Field-Programmable Gate Array (FPGA): A versatile and reconfigurable hardware platform, capable of being tailored to specific computational tasks, offering flexibility and potential performance gains for a wide range of applications. The algorithm's implicit prediction capabilities could identify tasks that could benefit from the FPGA's flexibility and customizability.
Other Specialized Coprocessors: The architecture is designed to be extensible and can accommodate other specialized coprocessors as needed. These could include coprocessors optimized for specific domains or algorithms, such as those for scientific computing, financial modeling, bioinformatics, or real-time analytics. The Coprocessor Selection Algorithm, with its intelligent decision-making capabilities, would ensure that these specialized coprocessors are utilized effectively to maximize the architecture's performance and efficiency.

The integrated computing architecture disclosed herein, with its intelligent Coprocessor Selection Algorithm and its ability to seamlessly integrate a diverse array of specialized coprocessors, represents a significant advancement in the field of computing. By enabling the dynamic and efficient distribution of tasks among various processing units, the architecture unlocks the full potential of both classical and quantum computing, paving the way for a new era of computational capabilities. The present invention's adaptability, scalability, and future-proofing capabilities position it as a pioneering solution for addressing the ever-increasing complexity and diversity of computational tasks in the modern world, promising to revolutionize fields ranging from artificial intelligence and machine learning to quantum computing and beyond.

### Embodiments Using Quantum Cognition Model

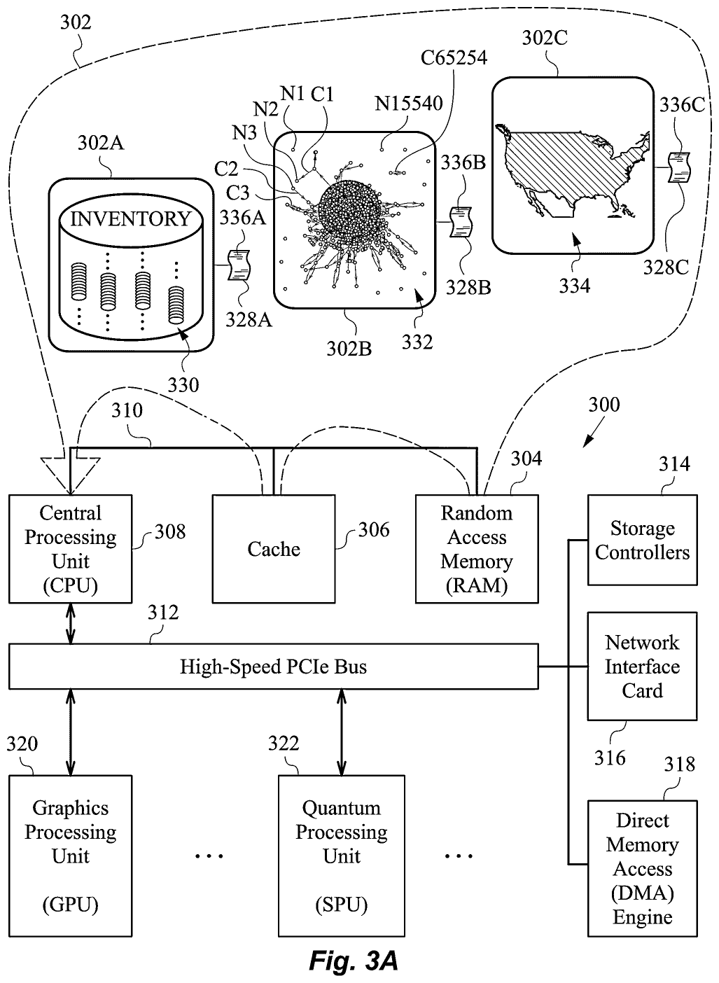

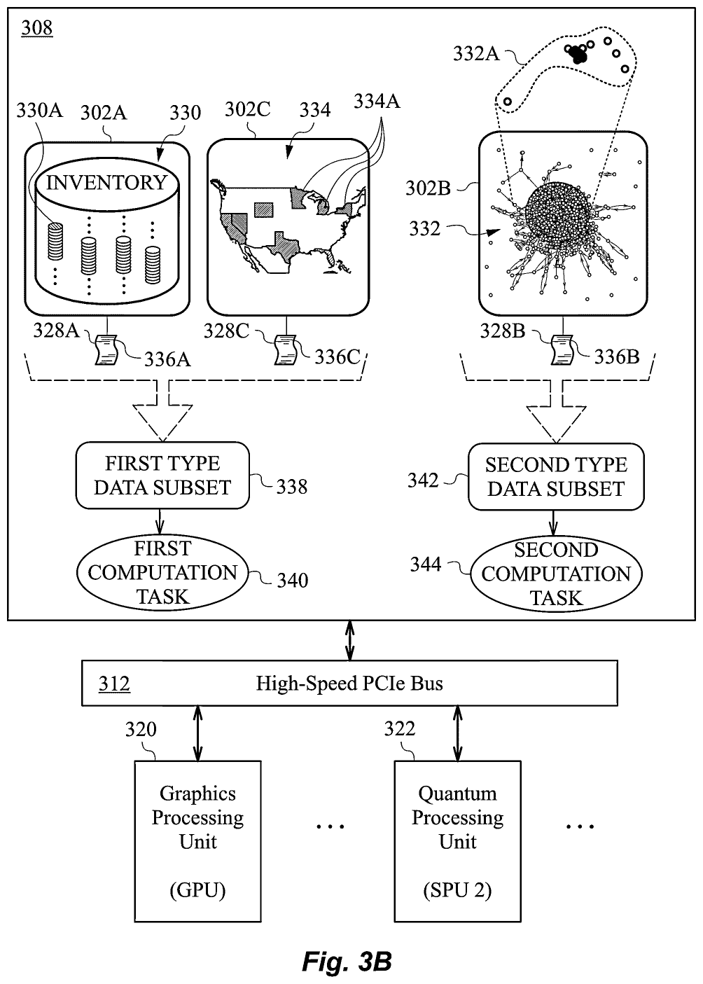

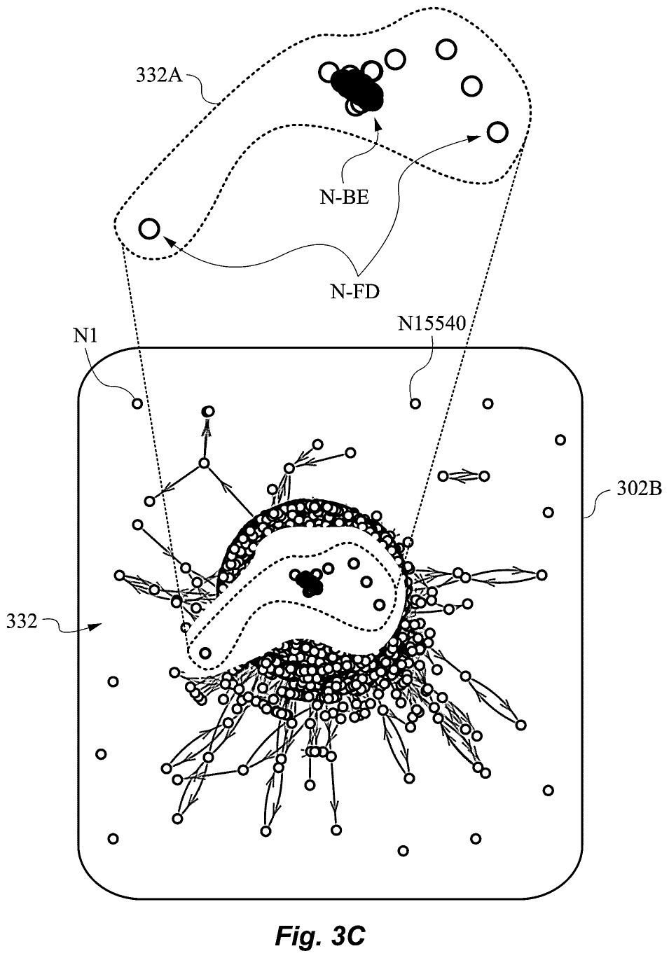

FIG. 3A diagrammatically illustrates another integrated computing architecture 300 for working with a layered data set 302 according to the invention. Layered data set 302 has data layers 302A, 302B, 302C that are shown explicitly. Additional data layers can also be contained in layered data set 302, but they are not shown for reasons of clarity.

Integrated computing architecture 300 has a Random Access Memory (RAM) 304 and a Cache 306. In this embodiment data layers 302A and 302C initially reside in Cache 306 while data layer 302B initially resides in RAM 304. As in the previous embodiment, layered data set 302 is shown within a dashed outline that commences at RAM 304, which holds data layer 302B, and at Cache 306, which holds data layers 302A, 302C.

Integrated computing architecture 300 further includes a Central Processing Unit (CPU) 308. RAM 304, Cache 306 and CPU 308 are connected by a system bus 310. System bus 310 is used for communication and transmission of data between RAM 304, Cache 306 and CPU 308. Specifically, layered data set 302 is transmitted from RAM 304 and from Cache 306 to CPU 308 as indicated by dashed outline terminating with an arrow at CPU 308.

Integrated computing architecture 300 relies on CPU 308 as the primary coordinator and executor of general-purpose tasks and also of the different types of computation tasks distributed in accordance with the invention. CPU 308 is thus ideally positioned to use its connection to RAM 304 and Cache 306 via system bus 310 to obtain rapid access to layered data set 302 as well as any other frequently used data during operation.

Integrated computing architecture 300 is equipped with a high-speed bus 312 that is connected to CPU 308. As in the previous embodiment, high-speed bus 312 is a Peripheral Component Interconnect Express (PCIe bus or PCI-E bus) given that such busses are specifically designed for low latency and high data transfer rates. Further, high-speed bus 312 is connected to a number of required resources. These resources include storage controllers 314, a network interface card 316 and a Direct Memory Access (DMA) engine 318. This configuration and these resources allow high-speed bus 312 to manage and efficiently route data of layered data set 302 in accordance with computation task within integrated computing architecture 300.

Integrated computing architecture 300 has a Graphics Processing Unit (GPU) 320 that is connected to high-speed bus 312. GPU 320 is optimized for performing matrix operations and other operations falling within computation tasks that are classical and well-suited for standard processing. High-speed bus 312 also connects to other specialized processing units of which only one, namely specialized processing unit (SPU) 322 is shown in FIG. 3A for reasons of clarity. In the present embodiment specialized processing unit 322 is a Quantum Processing Unit. Quantum Processing Unit 322 is optimized for performing computation tasks that are based on a quantum cognition model. CPU 308 is central to integrated computing architecture 300. It orchestrates data traffic to and from processing units 320, 322 and any other processing units via high-speed bus 312.

Layered data set 302 has data layers 302A, 302B, 302C as diagrammatically illustrated within the dashed outline. Each one of data layers 302A, 302B, 302C belonging to layered data set 302 is tagged in its corresponding metadata 328A, 328B, 328C that contain layer type descriptors 336A, 336B, 336C. Once again, tagging data layers 302A, 302B, 302C with layer type descriptors 336A, 336B, 336C in metadata 328A, 328B, 328C is convenient and preferred.

Data layer 302A contains an inventory of items 330 represented symbolically by tokens. In this particular embodiment items 330 include standard goods, services, equities and consumables that are bought and sold by market participants or market agents.

Data layer 302B contains a graph 332 that expressly shows market participants or market agents represented by vertices or nodes N of graph 332. Graph 332 has 15,540 nodes representing market agents N1, N2, N3, . . . , N15540. Only market agents N1, N2, N3 and N15540 are expressly called out in FIG. 3A for reasons of clarity.

Furthermore, the buy and sell relationships between agents N are expressly shown as directed edges or directed connections C of graph 332. Graph 332 has 65,254 connections representing buy and sell relationships C1, C2, C3, . . . , C65254. Again, only directed connections C1, C2, C3 and C65254 are expressly called out in FIG. 3A for reasons of clarity. The direction of each connection C indicates which agent provides or sells items 330 and which agent receives or buys items 330. Some agents are both suppliers and customers to each other as indicated by two opposite directed connections between them.

Data layer 302C contains a geographical region 334 where agents N are physically located. In this particular embodiment geographical region 334 is the United States. In other words, layered data set 302 in the present embodiment has data layers 302A, 302B, 302C that jointly focus on agents N that buy and sell or trade items 330 within the United States 334.

The operation of integrated computing architecture 300 can deploy the logic flow shown above in FIG. 2 or an alternative logic flow that breaks up the steps between resources in a different manner. In particular, information in metadata 328A, 328B, 328C can be handled in both CPU 308 and also further processed/used in GPU 320 and/or in Quantum Processing Unit 322. This may apply when metadata 328A, 328B, 328C is rich and includes information that can be deployed in GPU 320 and/or in Quantum Processing unit 322.

FIG. 3B shows a portion of integrated computing architecture 300 of FIG. 3A that focuses on CPU 308, high-speed bus 312, GPU 320 and Quantum Processing Unit 322. The operations involved in a specific exemplary application of integrated computing architecture 300 supported by layered data set 302 are explained in reference to FIG. 3B and also by referring back to FIG. 3A.

System bus 310 provides to CPU 308 layered data set 302 tagged with layer type descriptors 336A, 336B, 336C contained in metadata 328A, 328B, 328C accompanying data layers 302A, 302B, 302C that make up layered data set 302 (see also FIG. 3A). In the present embodiment layer type descriptors 336A, 336B, 336C are coordinated between data layers 302A, 302B, 302C. This coordination is shown here with a specific example.

When a specific item 330A is selected from inventory of items 330 of data layer 302A, then the corresponding subset of information that is relevant is indicated in the other two data layers 302B, 302C. In other words, given buy and sell activity for a specific item 330A only certain information contained in data layers 302B and 302C becomes relevant. Preferably, what information is relevant is indicated in metadata 328B, 328C and/or it may be integrated into layer type descriptors 336B, 336C.

In the present example, specific item 330A is only traded between a certain agent subgroup or segment 332A from among agents N shown in graph 332 contained in data layer 302B. FIG. 3B illustrates just agent segment 332A in a dashed outline above graph 332. Further, specific item 330A is only traded in a certain portion 334A of geographical region 334. Of this portion 334A just three states are explicitly referenced in FIG. 3B while the remaining are indicated by hatching. Thus, item 330A is seen as being traded only in the states of California, Florida, Minnesota, Nevada, New York, Texas, Wisconsin and Wyoming in this example.

CPU 308 identifies and separates layered data 302 based on coordinated layer type descriptors 336A, 336B, 336C and the choice of specific item 330A. In the present example data layers 302A and 302C are identified and separated into a first type data subset 338, since they do not require handling by any specialized models. In fact, first type data subset 338 is assigned to a first computation task 340 that can be performed entirely by classical models. That is because data provided to describe inventories with items 330 as well as assignments of market agents N within geographical regions is classical in nature and mostly involves simple lists, tables and operations performed on them.

Meanwhile, data layer 302B is identified and separated by CPU 308 into a second type data subset 342, which does require handling by a specialized model. In particular, entity segment 332A identified in layer type descriptor 336B as non-classical data further indicates that segment 332A is an entanglement suspect. In other words, entity segment 332A is identified as a segment of data layer 302B that requires the application of a quantum model, specifically a quantum cognition model in the present example. Hence, CPU 308 assigns second type data subset 342 to a second computation task 344. In the present example only the segment containing segment 332A is actually identified and assigned to second computation task 344. That is because at this stage and in this example only the market in item 330A is analyzed. With first and second computation tasks 340, 344 assigned, CPU 308 routes them over high-speed bus 312 to GPU 320 and Quantum Processing Unit 322, respectively.

First computation task 340 arrives in GPU 320 and is processed for standard business and geography metrics. These can include any standard classical analysis such as computing historical levels of supply of item 330A, tracking geographic distribution of item 330A, trends regarding item 330A, sorting by various parameters and/or extracting lists and tables referencing item 330A. All of these can be performed with standard mathematical operations well-suited to GPU 320.

FIG. 3C illustrates data layer 302B and agent segment 332A in more detail to aid in the explanation of the operation of Quantum Processing Unit 322. The location of segment 332A is shown within graph 332 and also enlarged within the dashed outline above graph 332. Graph 332 is constructed with embedding rules that put the most connected agents N near the center and the least connected agents N at the periphery. This type of embedding or packing rule is sometimes referred to as “Closest Packing Center” by those skilled in the art. More specifically, in the present example graph 332 is prepared with the rules of “Closest Packing Center” afforded by the Wolfram Mathematica software system supplied by Wolfram Research (see also “Spring Electrical Embedding” in Wolfram Mathematica).

Note that besides agents N1 and N15540 nine (9) other nodes or vertices corresponding to other agents N in FIG. 3C have no connections C to other agents N. In other words, there are no known buying and selling activities that eleven (11) agents N engaged in with any other agents N in graph 332. Therefore, they are embedded or placed beyond the periphery of graph 332 by the embedding convention. In the present interpretation of graph 332 this means that the eleven (11) unconnected agents N are interested in buying or selling item 330A but have not done so in practice.

Agents N that are closest to the center (not expressly labeled) have the most connections C and are hence considered most or best connected. Furthermore, by the above-described embedding rules agents N that are highly connected amongst each other form clusters. Agents N that do form clusters in graph 332 are considered to be alike in terms of their behavior as evidenced by their market connections (graph edges C). By contrast, agents N that are far apart on graph 332 are considered as being different in terms of their behavior as evidenced by market connections (graph edges C). Differently put, these far apart agents N exhibit anti-clustering behavior.

Enlarged agent segment 332A shown within the dashed outline above graph 332 clearly illustrates the clustering and anti-clustering effects of the embedding used in the layout of graph 322. Note that all connections C are left out in enlarged segment 332A for clarity. Specifically, agents N-BE form a tight cluster within graph 322. Meanwhile, agents such as a pair of agents N-FD are very far apart within graph 322. This means that in the context of trade in item 330A agents N-BE form the same or almost the same relationships (e.g., supplier/vendor relationships) and hence cluster. Meanwhile, in the context of trade in item 330A agents N-FD form very different or even entirely different relationships and defy clustering.

In order to explain the subsequent operations performed by Quantum Processing Unit 322 on data layer 302B that contains graph 322 with segment 332A related to trade in item 330A it will be necessary to introduce a quantum cognition representation. In particular, a quantum cognition representation of agents N involved in trade in item 330A is required. In the present case, the quantum cognition representation applied to agents N is reconciled with a quantum cognition model. The below section provides an in-depth review of a specific quantum cognition model adopted in the present embodiment in sufficient detail to allow a person of average skill in the art that includes quantum computing and quantum information to deploy this model in practice.

### I. Quantum Cognition Model—Background

The quantum cognition model used herein relies on a number of concepts from quantum mechanics and field theory. These concepts are introduced in the sub-sections below. The above-presented equations 1 through 3 are also explained in context in these sub-sections.

### 1. A Brief Review of Quantum Mechanics Fundamentals

In most practical applications of quantum models, the process of measurement is succinctly and elegantly described in the language of linear algebra or matrix mechanics (frequently referred to as the Heisenberg picture). Since all those skilled in the art are familiar with linear algebra, many of its fundamental theorems and corollaries will not be reviewed herein. In the language of linear algebra, a quantum wave ψ is represented in a suitable eigenvector basis by a state vector |ψ [symbol] . To provide a more rigorous definition, we will take advantage of the formal bra-ket notation introduced by Dirac and routinely used in the art.

In the bra-ket convention a column vector ψ is written as |ω [symbol] and its corresponding row vector (dual vector) is written as [symbol] ψ|. Additionally, because of the complex-valuedness of quantum state vectors, flipping any bra vector to its dual ket vector and vice versa implicitly includes the step of complex conjugation. After initial introduction, most textbooks do not expressly call out this step (i.e., [symbol] ψ| is really [symbol] ψ*| where the asterisk denotes complex conjugation). The reader is cautioned that many simple errors can be avoided by recalling this fundamental rule of complex conjugation.

We now recall that a measure of norm or the dot product (which is related to a measure of length and is a scalar quantity) for a standard vector [symbol] is normally represented as a multiplication of its row vector form by its column vector form as follows: d= [symbol] . This way of determining norm carries over to the bra-ket formulation. In fact, the norm of any state vector carries a special significance in quantum mechanics.

Expressed by the bra-ket [symbol] ψ|ψ [symbol] , we note that this formulation of the norm is always positive definite and real-valued for any non-zero state vector. That condition is assured by the step of complex conjugation when switching between bra and ket vectors. State vectors describe probability amplitudes while their norms correspond to probabilities. The latter are real-valued and by convention mapped to a range between 0 and 1 (with 1 representing a probability of 1 or 100% certainty). Correspondingly, all state vectors are typically normalized such that their inner product (a generalization of the dot product) is equal to one, or simply put: [symbol] ψ|ψ [symbol] = [symbol] χ|χ [symbol] = . . . =1. This normalization enforces conservation of probability on objects composed of quantum mechanical state vectors.

Using the above notation, we can represent any state vector |ψ [symbol] in its ket form as a sum of basis ket vectors |εⱼ [symbol] that span the Hilbert space [symbol] of state vector |ψ [symbol] . In this expansion, the basis ket vectors |εⱼ [symbol] are multiplied by their correspondent complex coefficients cⱼ. In other words, state vector |ψ [symbol] decomposes into a linear combination as follows:

$$\vert ψ = {\sum }_{j = 1}^{n} {c}_{j} \vert {ε}_{j} \qquad Eq . 4$$

where n is the number of vectors in the chosen basis. This type of decomposition of state vector |ψ [symbol] is sometimes referred to as its spectral decomposition by those skilled in the art.

Of course, any given state vector |ψ [symbol] can be composed from a linear combination of vectors in different bases thus yielding different spectra. However, the normalization of state vector |ψ [symbol] is equal to one irrespective of its spectral decomposition. In other words, bra-ket [symbol] ψ|ψ [symbol] =1 in any basis. From this condition we learn that the complex coefficients cⱼ of any expansion have to satisfy:

$${p}_{tot} = 1 = {\sum }_{j = 1}^{n} {c}_{j}^{*} {c}_{j} \qquad Eq . 5$$

where pₜₒₜ is the total probability. This ensures the conservation of probability, as already mentioned above. Furthermore, it indicates that the probability pⱼ associated with any given eigenvector |εⱼ [symbol] in the decomposition of |ψ [symbol] is the norm of the complex coefficient cⱼ, or simply put:

$${p}_{j} = {c}_{j}^{*} {c}_{j} . \qquad Eq . 6$$

In view of the above, it is not accidental that undisturbed evolution of any state vector |ψ [symbol] in time is found to be unitary or norm preserving. In other words, the evolution is such that the total of norms cⱼ*cⱼ does not change with time.

To better understand the last point, we use the polar representation of complex numbers by their modulus r and phase angle θ. Thus, we rewrite complex coefficient cⱼ as:

$${c}_{j} = {r}_{j} {e}^{i {θ}_{j}} , \qquad Eq . 7 a$$

where i=\sqrt{−1} (we will use i rather than j for the imaginary number). In this form, complex conjugate of complex coefficient cⱼ* is just:

$${c}_{j}^{*} = {r}_{j} {e}^{- i {θ}_{j}} , \qquad Eq . 7 b$$

and the norm becomes:

$${c}_{j}^{*} {c}_{j} = {r}_{j} {e}^{- i {θ}_{j}} {r}_{j} {e}^{i {θ}_{j}} = {r}_{j}^{2} . \qquad Eq . 7 c$$

The step of complex conjugation thus makes the complex phase angle drop out of the product (since e^{-iθ}e^{iθ}=e^{i(θ-θ)}=e⁰=1). This means that the complex phase of coefficient cⱼ does not have any measurable effect on the real-valued probability pⱼ associated with the corresponding eigenvector |εⱼ [symbol] . Note, however, that relative phases between different components of the decomposition will introduce measurable effects (e.g., when measuring in a different basis).

Given the above insight about complex phases, it should not be a surprise that temporal evolution of state vector |ψ [symbol] corresponds to the evolution of phase angles of complex coefficients cⱼ in its spectral decomposition (see Eq. 4). In other words, evolution of state vector |ψ [symbol] in time is associated with a time-dependence of angle θⱼ of each complex coefficient cⱼ. The complex phase thus exhibits a time dependence e^{iθ}^{ⱼ}=e^{iω}^{ⱼ}^{t}, where the j-th angular frequency ωⱼ is associated with the j-th eigenvector |εⱼ [symbol] and t stands for time. For completeness, it should be pointed out that ωⱼ is related to the energy level of the correspondent eigenvector |ε [symbol] by the famous Planck relation:

$${E}_{j} = {ω}_{j} , \qquad Eq . 8$$

where [symbol] stands for the reduced Planck's constant h, namely:

$$= \frac{h}{2 π} .$$

Correspondingly, evolution of state vector |ψ [symbol] is encoded in a unitary matrix U that acts on state vector |ψ [symbol] in such a way that it only affects the complex phases of the eigenvectors in its spectral decomposition. The unitary nature of evolution of state vectors ensures the fundamental conservation of probability. Of course, this rule applies when there are no disturbances to the overall system and states exhibiting this type of evolution are often called stationary states.

In contrast to the unitary evolution of state vectors that affects the complex phases of all eigenvectors of the state vector's spectral decomposition, the act of measurement picks out just one of the eigenvectors. Differently put, the act of measurement is related to a projection of the full state vector |ψ [symbol] onto the subspace defined by just one of eigenvectors |εⱼ [symbol] in the vector's spectral decomposition (see Eq. 4). Based on the laws of quantum mechanics, the projection obeys the laws of probability. More precisely, each eigenvector |εⱼ [symbol] has the probability pⱼ dictated by the norm cⱼ*cⱼ (see Eq. 6) of being picked for the projection induced by the act of measurement. Besides the rules of probability, there are no hidden variables or any other constructs involved in predicting the projection. This situation is reminiscent of a probabilistic game such as a toss of a coin or the throw of a die. It is also the reason why Einstein felt uncomfortable with quantum mechanics and proclaimed that he did not believe that God would “play dice with the universe”.

No experiments to date have been able to validate Einstein's position by discovering hidden variables or other deterministic mechanisms behind the choice. In fact, experiments based on the famous Bell inequality and many other investigations have confirmed that the above understanding encapsulated in the projection postulate of quantum mechanics is complete. Furthermore, once the projection occurs due to the act of measurement, the emergent element of reality that is observed, i.e., the measurable quantity, is the eigenvalue λⱼ associated with eigenvector |εⱼ [symbol] selected by the projection.

Projection is a linear operation represented by a projection matrix P that can be derived from knowledge of the basis vectors. The simplest state vectors decompose into just two distinct eigenvectors in any given basis. These vectors describe the spin states of spin ½ particles such as electrons and other spinors. The quantum states of twistors, such as photons, also decompose into just two eigenvectors. In the present case, we will refer to spinors for reasons of convenience.

It is customary to define the state space of a spinor by eigenvectors of spin along the z-axis. The first, |ε_{z+} [symbol] is aligned along the positive z-axis and the second, |ε_{z-} [symbol] is aligned along the negative z-axis. Thus, from standard rules of linear algebra, the projection along the positive z-axis (z+) can be obtained from constructing the projection matrix or, in the language of quantum mechanics the projection operator P_{z+} from the z+ eigenvector |ε_{z+} [symbol] as follows:

$${P}_{z +} = \vert {ε}_{z +} {ε}_{z +} \vert = {[ \begin{matrix}1 \\ 0\end{matrix} ] [ \begin{matrix}1 & 0\end{matrix} ]}^{*} = [ \begin{matrix}1 & 0 \\ 0 & 0\end{matrix} ] , \qquad Eq . 9$$

where the asterisk denotes complex conjugation, as above (no change here because vector components of |ε_{z+} [symbol] are not complex in this example). Note that in Dirac notation obtaining the projection operator is analogous to performing an outer product in standard linear algebra. There, for a vector [symbol] we get the projection matrix onto it through the outer product, namely: Pₓ= [symbol] ^{T}.

### 2. A Brief Introduction to Qubits

We have just seen that the simplest quantum state vector |ψ [symbol] corresponds to a pre-emerged quantum entity that can yield one of two distinct observables under measurement. These measures are the two eigenvalues λ₁, λ₂ of the correspondent two eigenvectors |ε₁ [symbol] , |ε₂ [symbol] in the chosen spectral decomposition. The relative occurrence of the eigenvalues will obey the probabilistic rule laid down by the projection postulate. In particular, eigenvalue λ₁ will be observed with probability p₁ (see Eq. 6) equal to the probability of projection onto eigenvector |ε₁ [symbol] . Eigenvalue λ₂ will be seen with probability p₂ equal to the probability of projection onto eigenvector |ε₂ [symbol] .

Because of the simplicity of the two-state quantum system represented by such two-state vector |ψ [symbol] , it has been selected in the field of quantum information theory and quantum computation as the fundamental unit of information. In analogy to the choice made in computer science, this system is commonly referred to as a qubit and so the two-state vector becomes the qubit: |qb [symbol] =|ψ [symbol] . Operations on one or more qubits are of great interest in the field of quantum information theory and its practical applications. Since the detailed description will rely extensively on qubits and their behavior, we will now introduce them with a certain amount of rigor.

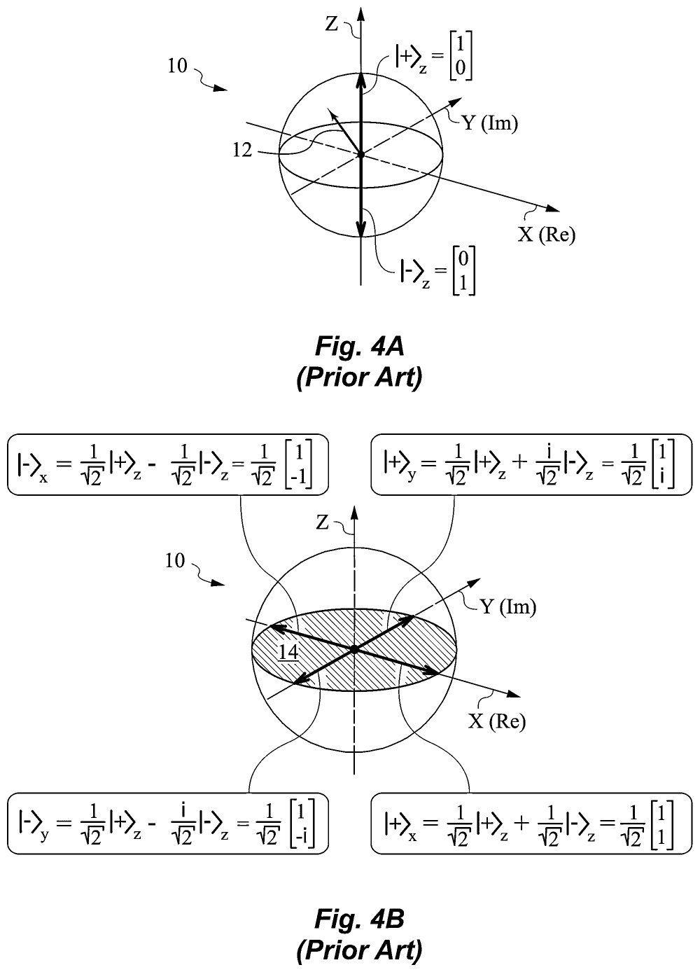

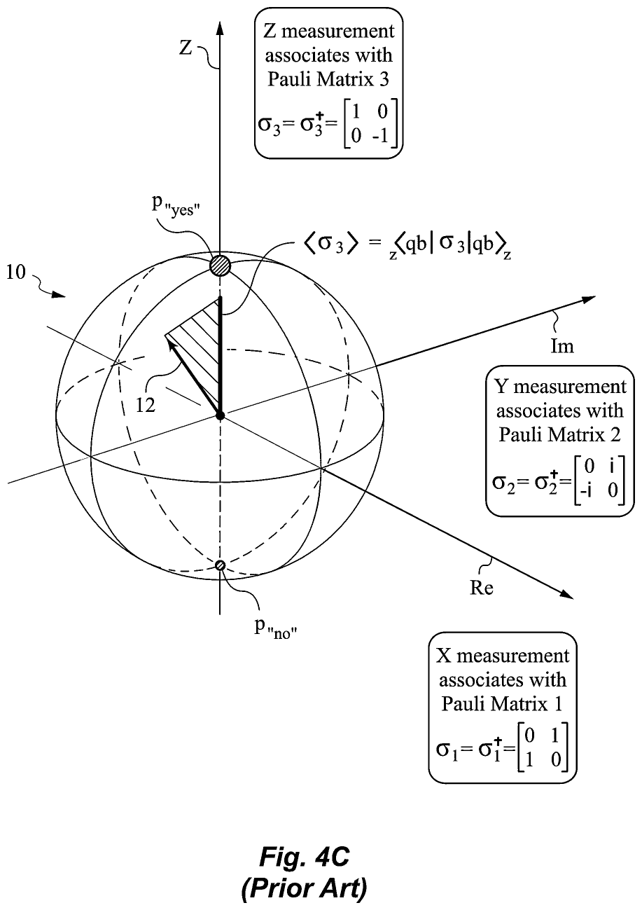

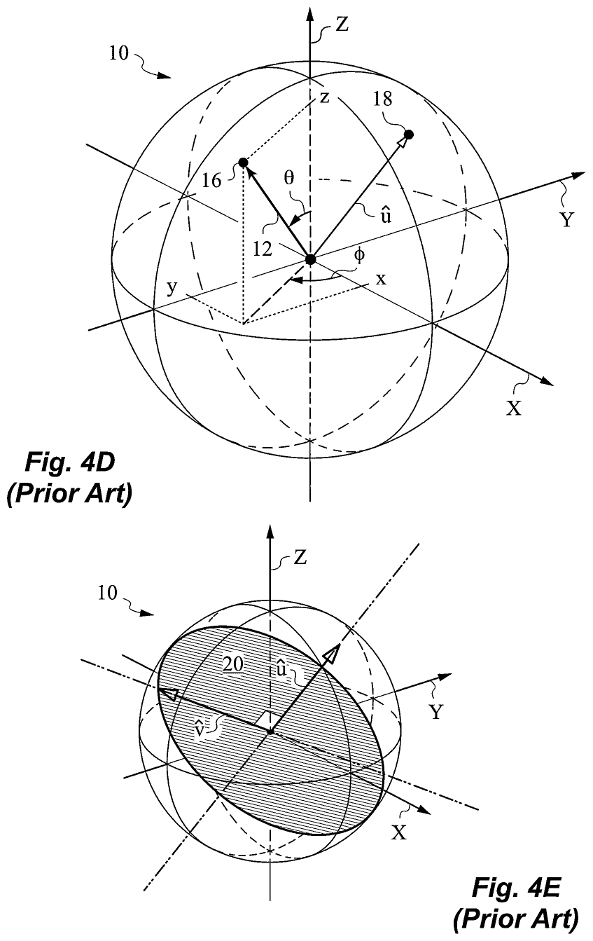

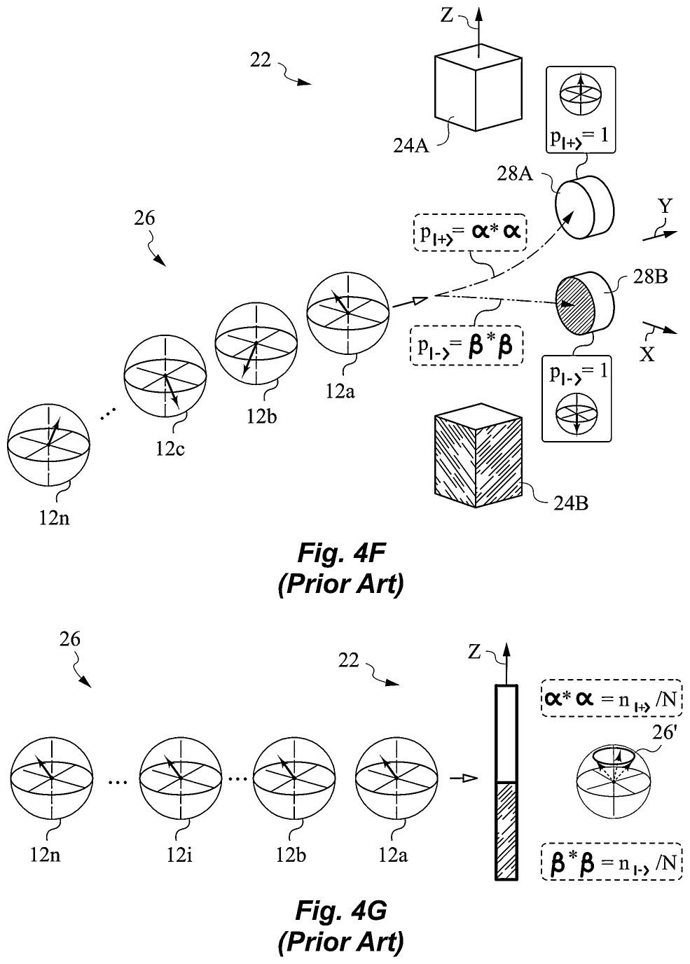

From the above preliminary introduction, it is perhaps not surprising to find that the simplest two-state qubit, just like a simple spinor or twistor on which it is based, can be conveniently described in 2-dimensional complex space called [symbol] ². The description finds a more intuitive translation to our 3-dimensional space, [symbol] ³, with the aid of the Bloch or Poincare Sphere. This concept is introduced by FIG. 4A, in which the Bloch Sphere 10 is shown centered on the origin of orthogonal coordinates indicated by axes X, Y, Z. Note that drawing figures that introduce the underlying principles of quantum mechanics and field theory are all labeled as Prior Art.

Before allowing oneself to formulate an intuitive view of qubits by looking at Bloch sphere 10, the reader is cautioned that the representation of qubits inhabiting [symbol] ² by mapping them to a ball in [symbol] ³ is a useful tool. However, the actual mapping is not one-to-one. Formally, the representation of spinors by the group of transformations defined by SO(3) (Special Orthogonal matrices in [symbol] ³) is double-covered by the group of transformations defined by SU(2) (Special Unitary matrices in [symbol] ²)

In the Bloch representation, a qubit 12 represented by a ray in [symbol] ² is spectrally decomposed into the two z-basis eigenvectors. These eigenvectors include the z-up or |+ [symbol] _{z} eigenvector, and the z-down or |− [symbol] _{z} eigenvector. The spectral decomposition theorem assures us that any state of qubit 12 can be decomposed in the z-basis as long as we use the appropriate complex coefficients. In other words, any state of qubit 12 can be described in the z-basis by:

$$\vert ψ {〉}_{z} = \vert qb {〉}_{z} = α \vert + {〉}_{z} + β \vert - {〉}_{z} , \qquad Eq . 10$$

where α and β are the corresponding complex coefficients. In quantum information theory, basis state |+ [symbol] _{z} is frequently mapped to logical “yes” or to the value “1”, while basis state |− [symbol] _{z} is frequently mapped to logical “no” or to the value “0”.

In FIG. 4A basis states |+ [symbol] _{z} and |− [symbol] _{z} are shown as vectors and are written out in full form for clarity of explanation. (It is worth remarking that although basis states |+ [symbol] _{z} and |− [symbol] _{z} are indeed orthogonal in [symbol] ², they fall on the same axis (Z axis) in the Bloch sphere representation in [symbol] ³. That is because the mapping is not one-to-one but rather homomorphic, as already mentioned above.) Further, in our chosen representation of qubit 12 in the z-basis, the X axis corresponds to the real axis and is thus also labeled by Re. Meanwhile, the Y axis corresponds to the imaginary axis and is additionally labeled by Im.

To appreciate why complex coefficients α and β contain sufficient information to encode qubit 12 pointed anywhere within Bloch sphere 10 we now refer to FIG. 4B. Here the complex plane 14 spanned by real and imaginary axes Re, Im that are orthogonal to the Z axis and thus orthogonal to eigenvectors |+ [symbol] _{z} and |− [symbol] _{z} of our chosen z-basis is hatched for better visualization. Note that eigenvectors for the x-basis |+ [symbol] ₓ, |− [symbol] ₓ as well as eigenvectors for the y-basis |+ [symbol] _{y}, |− [symbol] _{y} are in complex plane 14. Most importantly, note that each one of the alternative basis vectors in the two alternative basis choices we could have made finds a representation using the eigenvectors in the chosen z-basis. As shown in FIG. 1B, the following linear combinations of eigenvectors |+ [symbol] _{z} and |− [symbol] _{z} describe vectors |+ [symbol] ₓ, |− [symbol] ₓ and |+ [symbol] _{y}, |− [symbol] _{y}:

$$\vert + {〉}_{x} = \frac{1}{\sqrt{2}} \vert + {〉}_{z} + \frac{1}{\sqrt{2}} \vert - {〉}_{z} , \qquad Eq . 11 a$$

$$\vert - {〉}_{x} = \frac{1}{\sqrt{2}} \vert + {〉}_{z} - \frac{1}{\sqrt{2}} \vert - {〉}_{z} , \qquad Eq . 11 b$$

$$\vert + {〉}_{y} = \frac{1}{\sqrt{2}} \vert + {〉}_{z} + \frac{i}{\sqrt{2}} \vert - {〉}_{z} , \qquad Eq . 11 c$$

$$\vert - {〉}_{y} = \frac{1}{\sqrt{2}} \vert + {〉}_{z} - \frac{i}{\sqrt{2}} \vert - {〉}_{z} . \qquad Eq . 11 d$$

Clearly, admission of complex coefficients α and β permits a complete description of qubit 12 anywhere within Bloch sphere 10 thus furnishing the desired map from [symbol] ^{a} to [symbol] ³ for this representation. The representation is compact and leads directly to the introduction of Pauli matrices.

FIG. 4C shows the three Pauli matrices σ₁, σ₂, σ₃ (sometimes also referred to as σₓ, σ_{y}, σ_{z}) that represent the matrices corresponding to three different measurements that can be performed on spinors. Specifically, Pauli matrix σ₁ corresponds to measurement of spin along the X axis (or the real axis Re). Pauli matrix σ₂ corresponds to measurement of spin along the Y axis (or the imaginary axis Im). Finally, Pauli matrix σ₃ corresponds to measurement of spin along the Z axis (which coincides with measurements in the z-basis that we have selected). The measurement of spin along any of these three orthogonal axes will force projection of qubit 12 to one of the eigenvectors of the corresponding Pauli matrix. The measurable value will be the eigenvalue that is associated with the eigenvector.

To appreciate the possible outcomes of measurement we notice that all Pauli matrices σ₁, σ₂, σ₃ share the same two orthogonal eigenvectors, namely |ε [symbol] =[1, 0] and |ε₂ [symbol] [0,1]. Further, Pauli matrices are Hermitian (an analogue of real-valued symmetric matrices) such that:

$${σ}_{k} = {σ}_{k}^{} , \qquad Eq . 12$$

for k=1, 2, 3 (for all Pauli matrices) and with the “dagger” indicating the Hermitian conjugate. These properties ensure that the eigenvalues λ₁, λ₂, λ₃ of Pauli matrices σ₁, σ₂, σ₃ are real and the same for each matrix. In particular, for spin ½ particles such as electrons, the Pauli matrices are multiplied by a factor of [symbol] /2 to obtain the corresponding spin angular momentum matrices sₖ. Hence, the eigenvalues are shifted to

$${λ}_{1} = \frac{ℏ}{2} and {λ}_{2} = - \frac{ℏ}{2}$$

(where [symbol] is the reduced Planck's constant already defined above). Here we also notice that Pauli matrices σ₁, σ₂, σ₃ are constructed to apply to spinors, which change their sign under a 2π rotation and require a rotation by 4π to return to initial state (formally, an operator S is a spinor if S(θ+2π)=−S(θ)).

As previously pointed out, in quantum information theory and its applications the physical aspect of spinors becomes unimportant and thus the multiplying factor of [symbol] /2 is dropped. Pauli matrices σ₁, σ₂, σ₃ are used in unmodified form with corresponded eigenvalues λ₁=1 and λ₂=−1 mapped to two opposite logical values, such as “yes” and “no”. For the sake of rigor and completeness, one should state that the Pauli matrices are traceless, each of them squares to the Identity matrix I, their determinants are −1 and they are involuntary. A more thorough introduction to their importance and properties can be found in the many foundational texts on Quantum Mechanics, including the excellent textbook by P. A. M. Dirac, “The Principles of Quantum Mechanics”, Oxford University Press, 4^{th} Edition, 1958 in the section on the spin of the electron.

Based on these preliminaries, the probabilistic aspect of quantum mechanics encoded in qubit 12 can be re-stated more precisely. In particular, we have already remarked that the probability of projecting onto an eigenvector of a measurement operator is proportional to the norm of the complex coefficient multiplying that eigenvector in the spectral decomposition of the full state vector. This rather abstract statement can now be recast as a complex linear algebra prescription for computing an expectation value [symbol] O [symbol] of an operator matrix O for a given quantum state |ψ [symbol] as follows:

$$〈 O {〉}_{ψ} = 〈 ψ \vert O \vert ψ 〉 , \qquad Eq . 13 a$$

where the reader is reminded of the implicit complex conjugation between the bra vector [symbol] ψ| and the dual ket vector |ψ [symbol] . The expectation value [symbol] O [symbol] _{ψ} is a number that corresponds to the average result of the measurement obtained by operating with matrix O on a system described by state vector |ψ [symbol] . For better understanding, FIG. 4C visualizes the expectation value [symbol] σ₃ [symbol] for qubit 12 whose ket in the z-basis is written as |qb [symbol] _{z} for a measurement along the Z axis represented by Pauli matrix σ₃ (note that the subscript on the expectation value is left out, since we know what state vector is being measured).

Although the drawing may suggest that expectation value [symbol] σ₃ [symbol] is a projection of qubit 12 onto the Z axis, the value of this projection is not the observable. Instead, the value [symbol] σ₃ [symbol] is the expectation value of collapse of qubit 12 represented by ket vector |qb [symbol] _{z}. In other words, it is a value that can range anywhere between 1 and −1 (“yes” and “no”) and will be found upon collecting the results of a large number of actual measurements.

In the present case, since operator σ₃ has a complete set of eigenvectors (namely |+ [symbol] _{z} and |− [symbol] _{z}) and since the qubit |qb [symbol] _{z} we are interested in is described in the same z-basis, the probabilities are easy to compute. The expression follows directly from Eq. 13a:

$$〈 {σ}_{3} {〉}_{ψ} = {\sum }_{j} {λ}_{j} \vert 〈 ψ \vert {ε}_{j} 〉 {\vert}^{2} , \qquad Eq . 13 b$$

where λⱼ are the eigenvalues (or the “yes” and “no” outcomes of the experiment) and the norms | [symbol] ψ|εⱼ [symbol] |² are the probabilities that these outcomes will occur. Eq. 13b is thus more useful for elucidating how the expectation value of an operator brings out the probabilities of collapse to respective eigenvectors |εⱼ [symbol] that will obtain when a large number of measurements are performed in practice.

For the specific case in FIG. 4C, we show the probabilities from Eq. 13b can be found explicitly in terms of the complex coefficients α and β. Their values are computed from the definition of quantum mechanical probabilities already introduced above (see Eqs. 5 and 6):

$${p}_{1} = {p}_{“ yes ”} = \vert 〈 qb \vert {ε}_{1} 〉 {\vert}^{2} = \vert ( α * 〈 + \vert + β * 〈 - \vert ) \vert + {〉}_{z} {\vert}^{2} = α * α$$

$${p}_{2} = {p}_{“ no ”} = \vert 〈 qb \vert {ε}_{2} 〉 {\vert}^{2} = \vert ( α * 〈 + \vert + β * 〈 - \vert ) \vert - {〉}_{z} {\vert}^{2} = β * β$$

$${p}_{1} + {p}_{2} = {p}_{“ yes ”} + {p}_{“ no ”} = α * α + β * β = 1$$

These two probabilities are indicated by visual aids at the antipodes of Bloch sphere 10 for clarification. The sizes of the circles that indicate them denote their relative values. In the present case p_{“yes”}->p_{“no”} given the exemplary orientation of qubit 12.

Representation of qubit 12 in Bloch sphere 10 brings out an additional and very useful aspect to the study, namely a more intuitive polar representation. This representation will also make it easier to point out several important aspects of quantum mechanical states that will be pertinent to the present application in the quantum cognition model.

FIG. 4D illustrates qubit 12 by deploying polar angle θ and azimuthal angle ϕ routinely used to parameterize the surface of a sphere in [symbol] ³. Qubit 12 described by state vector |qb [symbol] _{z} has the property that its vector representation in Bloch sphere 10 intersects the sphere's surface at point 16. That is apparent from the fact that the norm of state vector |qb [symbol] _{z} is equal to one and the radius of Bloch sphere 10 is also one. Still differently put, qubit 12 is represented by quantum state |qb [symbol] _{z} that is pure; i.e., it is considered in isolation from the environment and from any other qubits for the time being. Pure state |qb [symbol] _{z} is represented with polar and azimuth angles θ, ϕ of the Bloch representation as follows:

$$\vert qb {〉}_{z} = cos \frac{θ}{2} \vert + {〉}_{z} + {e}^{i ϕ} sin \frac{θ}{2} \vert - {〉}_{z} , \qquad Eq . 14$$

where the half-angles are due to the state being a spinor (see definition above and recall the double-cover). The advantage of this description becomes even more clear in comparing the form of Eq. 14 with Eq. 10. State |qb [symbol] _{z} is insensitive to any overall phase or overall sign thus permitting several alternative formulations.

Additionally, we note that the Bloch representation of qubit 12 provides for an easy parameterization of point 16 in terms of {x,y,z} coordinates directly from polar and azimuth angles θ, ϕ. In particular, the coordinates of point 16 are just:

$$\{ x , y , z \} = \{ sin θ cos ϕ , sin θ sin ϕ , cos θ \} , \qquad Eq . 15$$

in agreement with standard transformation between polar and Cartesian coordinates where radius r is 1.

We now return to the question of measurement equipped with some basic tools and a useful representation of qubit 12 as a unit vector terminating at the surface of Bloch sphere 10 at point 16 (whose coordinates {x,y,z} are found from Eq. 15) and pointing in some direction characterized by angles θ, ϕ. The three Pauli matrices σ₁, σ₂, σ₃ can be seen as associating with measurements along the three orthogonal axes X, Y, Z in real 3-dimensional space [symbol] ³.

A measurement represented by a direction in [symbol] ³ can be constructed from the Pauli matrices. This is done with the aid of a unit vector û pointing along a proposed measurement direction, as shown in FIG. 4D. Using the dot-product rule, we now compose the desired operator σᵤ using unit vector û and the Pauli matrices as follows (compare also with Eq. 3):

$${σ}_{u} = \hat{u} \cdot \overline{σ} = {u}_{x} {σ}_{1} + {u}_{y} {σ}_{2} + {u}_{z} {σ}_{3} . \qquad Eq . 16$$

Having thus built up a representation of quantum mechanical state vectors, we are in a position to understand a few facts about the pure state of qubit 12. Namely, an ideal or pure state of qubit 12 is represented by a Bloch vector of unit norm pointing along a well-defined direction. It can also be expressed by Cartesian coordinates {x,y,z} of point 16. Unit vector û defining any desired direction of measurement can also be defined in Cartesian coordinates {x,y,z} of its point of intersection 18 with Bloch sphere 10.

When the direction of measurement coincides with the direction of the state vector of qubit 12, or rather when the Bloch vector is aligned with unit vector û, the result of the quantum measurement will not be probabilistic. In other words, the measurement will yield the result |= [symbol] ᵤ with certainty (probability equal to 1 as may be confirmed by applying Eq. 13b), where the subscript u here indicates the basis vector along unit vector û. Progressive misalignment between the direction of measurement and qubit 12 will result in an increasing probability of measuring the opposite state, |− [symbol] ᵤ.

The realization that it is possible to predict the value of qubit 12 with certainty under above-mentioned circumstances suggests we ask the opposite question. When do we encounter the least certainty about the outcome of measuring qubit 12? With the aid of FIG. 4E, we see that in the Bloch representation this occurs when we pick a direction of measurement along a unit vector \hat{v} that is in a plane 20 perpendicular to unit vector û after establishing the state |+ [symbol] ᵤ (or the state |− [symbol] ᵤ) by measuring qubit 12 eigenvalue “yes” along û (or “no” opposite to û). Note that establishing a certain state in this manner is frequently called “preparing the state” by those skilled in the art. After preparation in state |+ [symbol] ᵤ or in state |− [symbol] ᵤ, measurement of qubit 12 along vector \hat{v} will produce outcomes |+ [symbol] ᵥ and |− [symbol] ᵥ with equal probabilities (50/50).

Indeed, we see that this same condition holds among all three orthogonal measurements encoded in the Pauli matrices. To wit, preparing a certain measurement along Z by application of matrix σ₃ to qubit 12 makes its subsequent measurement along X or Y axes maximally uncertain (see also plane 14 in FIG. 4B). This suggests some underlying relationship between Pauli matrices σ₁, σ₂, σ₃ that encodes for this indeterminacy. Even based on standard linear algebra we expect that since the order of application of matrix operations usually matters (since any two matrices A and B typically do not commute) the lack of commutation between Pauli matrices could be signaling a fundamental limit to the simultaneous observation of multiple orthogonal components of spin or, by extension, of qubit 12.

In fact, we find that the commutation relations for the Pauli matrices, here explicitly rewritten with the x,y,z indices rather than 1,2,3, are as follows:

$$[ {σ}_{x} , {σ}_{y} ] = i {σ}_{z} ; [ {σ}_{y} , {σ}_{z} ] = i {σ}_{x} ; [ {σ}_{z} , {σ}_{x} ] = i {σ}_{y} . \qquad Eq . 17$$

The square brackets denote the traditional commutator defined between any two matrices A, B as [A,B]=AB−BA. When actual quantities rather than qubits are the subject of investigation, this relationship leads directly to the famous Heisenberg Uncertainty Principle. This fundamental limitation on the emergence of elements of reality prevents the simultaneous measurement of incompatible observables and places a bound related to Planck's constant h (and more precisely to the reduced Planck's constant [symbol] on the commutator. This happens because matrices encoding real observables bring in a factor of Planck's constant and the commutator thus acquires this familiar bound.

The above finding is general and extends beyond the commutation relations between Pauli matrices. According to quantum mechanics, the measurement of two or more incompatible observables is always associated with matrices that do not commute. Another way to understand this new limitation on our ability to simultaneously discern separate elements of reality, is to note that the matrices for incompatible elements of reality cannot be simultaneously diagonalized. Differently still, matrices for incompatible elements of reality do not share the same eigenvectors. Given this fact of nature, it is clear why modern-day applications strive to classify quantum systems with as many commuting observables as possible up to the famous Complete Set of Commuting Observables (CSCO).

Whenever the matrices used in the quantum description of a system do commute, then they correspond to physical quantities of the system that are simultaneously measurable. A particularly important example is the matrix that corresponds to the total energy of the system known as the Hamiltonian H. When an observable is described by a matrix M that commutes with Hamiltonian H, and the system is not subject to varying external conditions, (i.e., there is no explicit time dependence) then that physical quantity that corresponds to operator M is a constant of motion.

### 3. A Basic Measurement Arrangement

In practice, pure states are rare due to interactions between individual qubits as well as their coupling to the environment. All such interactions lead to a loss of quantum state coherency, also referred to as decoherence, and the consequent emergence of noise and “classical” statistics. Thus, many additional tools have been devised for practical applications of quantum models under typical conditions. However, under conditions where the experimenter has access to entities exhibiting relatively pure quantum states many aspects of the quantum mechanical description can be recovered from appropriately devised measurements.

To recover the desired quantum state information it is important to start with collections of states that are large. This situation is illustrated by FIG. 4F, where an experimental apparatus 22 is set up to perform a measurement of spin along the Z axis. Apparatus 22 has two magnets 24A, 24B for separating a stream of quantum systems 26 (e.g., electrons) according to spin. The spin states of systems 26 are treated as qubits 12a, 12b, . . . , 12n for the purposes of the experiment. The eigenvectors and eigenvalues are as before, but the subscript “z” that was there to remind us of the z-basis decomposition, which is now implicitly assumed, has been dropped.

Apparatus 22 has detectors 28A, 28B that intercept systems 26 after separation to measure and amplify the readings. It is important to realize that the act of measurement is performed during the interaction between the field created between magnets 24A, 24B and systems 26. Therefore, detectors 28A, 28B are merely providing the ability to amplify and record the measurements for human use. These operations remain consistent with the original result of quantum measurements. Hence, their operation can be treated classically. (The careful reader will discover a more in-depth explanation of how measurement can be understood as entanglement that preserves consistency between measured events given an already completed micro-level measurement. By contrast, the naive interpretation allowing amplification to lead to macro-level superpositions and quantum interference, to wit the Schroedinger's Cat paradox, is incompatible with the consistency requirement. A detailed analysis of these fine points is found in any of the previously mentioned foundational texts on quantum mechanics.)

For systems 26 prepared in various pure states that are unknown to the experimenter, the measurements along Z will not be sufficient to deduce these original states. Consider that each system 26 is described by Eq. 10. Thus, each system 26 passing through apparatus 22 will be deflected according to its own distinct probabilities p_{|+} [symbol] =α*α (or p_{“yes”}) and p_{|-} [symbol] =β*β (or p_{“no”}). Hence, other than knowing the state of each system 26 with certainty after its measurement, general information about the preparation of systems 26 prior to measurement will be very difficult to deduce.

FIG. 4G shows the more common situation, where systems 26 are all prepared in the same, albeit unknown pure state (also see “state preparation” defined above). Under these circumstances, apparatus 22 can be used to deduce more about the original pure state that is unknown to the experimenter. In particular, a large number of measurements of |+ [symbol] (“yes”) and |− [symbol] (“no”) outcomes, for example N such measurements assuming all qubits 12a through 12n are properly measured, can be analyzed probabilistically. Thus, the number n_{|+} [symbol] of |+ [symbol] measurements divided by the total number of qubits 12 that were measured, namely N, has to equal α*α. Similarly, the number n_{|-} [symbol] of |− [symbol] measurements divided by N has to equal β*β. From this information the experimenter can recover the projection of the unknown pure state onto the Z axis. In FIG. 4G this projection 26′ is shown as an orbit on which the state vector can be surmised to lie. Without any additional measurements, this is all the information that can be easily gleaned from a pure Z axis measurement with apparatus 22.

### 4. Overview of Practical Cases

By now it will have become apparent to the reader that the quantum mechanical underpinnings of qubits are considerably more complicated than the physics of regular bits. Regular bits can be treated in a manner that is completely divorced from their physicality. A computer scientist dealing with a bit does not need to know what the physical system embodying the bit happens to be, as long as it satisfies the typical criteria of performance (e.g., low probability of bit errors and containment of other failure modes). Unfortunately, as already remarked, this is not true for qubits.

To deal with quantum systems exhibiting interactions between themselves and with the environment that has degrees of freedom inaccessible to an observer a more practical representation had to be adopted. That is because in such open systems states are typically not just rays in Hilbert space and measurements are not obtained by applying simple projections operators. Moreover, the evolution of the states is usually not unitary. A suitable representation in view of these real-life limitations is embodied by the density matrix, which was devised in the first half of the 20^{th} century and is usually attributed to John von Neumann (also sometimes to Lev Landau and Felix Bloch). We want to focus more on how this matrix accommodates mixed states and pure states that include coherent superpositions.

Let us start by looking at coherent superpositions. From Eq. 11a we know a pure state of up along X axis, or |+ [symbol] ₓ, can be expressed in terms of the up- and down-states along Z axis, i.e., by using the z-basis eigenvectors |+ [symbol] _{z} and |− [symbol] _{z}. Recall that the required superposition is actually:

$$\vert + {〉}_{x} = \frac{1}{\sqrt{2}} \vert + {〉}_{z} + \frac{1}{\sqrt{2}} \vert - {〉}_{z} .$$

This means that if we were to measure the z-component of spin (using the σ₃ operator or equivalently experimental apparatus 22 introduced in FIG. 4F) over a statistical sample of quantum systems 26 prepared as |+ [symbol] ₓ then we would find states |+ [symbol] _{z} and |− [symbol] _{z} to be equally likely (50/50). After all, the superposition has c₁=α=1/\sqrt{2} and thus probability p₁=(1/\sqrt{2})²=½ for state |+ [symbol] _{z} and c₂=α=1/\sqrt{2} leading to probability p₂=(1/\sqrt{2})²=½ for state |− [symbol] _{z}. If we were to measure the x-component of spin for this superposition via the σ₁ operator, however, we would find |+ [symbol] ₓ with certainty every time (100% chance). (Of course, we would not actually observe the states, but rather their eigenvalues.)

Now consider a case in which we have a statistical sample or, what those skilled in the art refer to as an ensemble, of quantum systems 26 in which half of the states are |+ [symbol] _{z} and the other half of the states are |− [symbol] _{z}. Once again, by applying the σ₃ operator instantiated by experimental apparatus 22 we would find these states to be equally likely (50/50). Yet, a measurement along X axis represented by the σ₁ operator (we would obviously have to rotate apparatus 22 to perform this measurement) on the same ensemble would now discover state |+ [symbol] ₓ only half of the time. The other half of the time the state along X axis would be down or |− [symbol] ₓ. In other words, the ensemble exhibits an equiprobable distribution (50/50 chance) of states |+ [symbol] ₓ and |− [symbol] ₓ!

We have just uncovered a fundamental inability of measurements along just one single axis to determine the difference between a coherent superposition and a statistical ensemble. Needless to say, a proper description of the superposition and the statistical ensemble (sometimes referred to as “Gemisch” (German for “mixture” or “mixed state”) by those skilled in the art) should take account of this. The density matrix is the right description and can be used in either case.

Let us examine its representation of the pure state expressed by the coherent superposition of Eq. 11a first. We construct the density matrix for this pure state by forming a projection onto it and then multiplying it by the probability of occurrence of this pure state. In our case the probability of occurrence of state |+ [symbol] _{z} is 100% or 1. It must clearly be so, since we are not dealing with a mixture of different states but a coherent superposition. The density operator thus has only one component (i=1) and is computed using the outer product (introduced in conjunction with projection operators) as follows:

$$\hat{ρ} = {\sum }_{i} {p}_{i} \vert {ψ}_{i} 〉 〈 {ψ}_{i} \vert , \qquad Eq . 18$$

yielding in our case:

$$\hat{ρ} = ( \frac{1}{\sqrt{2}} \vert + {〉}_{z} + \frac{1}{\sqrt{2}} \vert - {〉}_{z} ) ( \frac{1}{\sqrt{2}} {}_{z} 〈 + \vert + \frac{1}{\sqrt{2}} {}_{z} 〈 - \vert ) = [ \begin{matrix}\frac{1}{2} & \frac{1}{2} \\ \frac{1}{2} & \frac{1}{2}\end{matrix} ] .$$

The trace class density operator \hat{ρ} thus obtained encodes pure state |+ [symbol] ₓ computed from its traditional z-basis decomposition. (We note here that the basis in which the computation is done turns out to be unimportant.)

Matrix \hat{ρ} for pure state |+ [symbol] _{z} looks a bit unwieldy and it may not be immediately apparent that it encodes a coherent superposition. Of course, it is idempotent and thus a good candidate density operator for representing a pure state (a state whose point 16 in the Bloch representation is on the surface of the Bloch ball). However, we can compute the average value of observable σ₁ corresponding to the X axis measurement of spin for a reliable cross-check. The computation is performed by tracing over the product of two matrices. The first matrix is the observable of interest, represented here by operator matrix O, and the second one is just matrix \hat{ρ} as follows:

$$\overline{O} = Tr \hat{ρ} O , \qquad Eq . 19$$

where the over-bar denotes average value. It is worth recalling that the trace operation will yield the same answer irrespective of matrix order whether or not the matrices commute. Now, to deploy Eq. 19 for our cross-check we set O=σ₁ and obtain:

$$\overline{{σ}_{1}} = Tr ( [ \begin{matrix}\frac{1}{2} & \frac{1}{2} \\ \frac{1}{2} & \frac{1}{2}\end{matrix} ] [ \begin{matrix}0 & 1 \\ 1 & 0\end{matrix} ] ) = 1.$$

This means that the average value for a measurement along X axis is 1, or spin up. In fact, for the pure state under consideration this is exactly the expectation value which is written as [symbol] σ₁ [symbol] and whose prescription we have already introduced above (see Eqs. 13a & 13b) Spin up along X axis for sure indicates state |+ [symbol] ₓ. We have thus confirmed that the more general density matrix formalism correctly reproduces the expectation value.

We turn now to the mixed state introduced above. It is an ensemble of states |+ [symbol] _{z} and |− [symbol] _{z} occurring with equal probabilities. Clearly, this is not a coherent superposition of the two states, but rather a stream of these states with 50/50 probability. The density operator applied from Eq. 18 now yields:

$$\hat{ρ} = \frac{1}{2} ( \vert + {z}_{} {}_{z} + \vert + \vert - {z}_{} {}_{z} - \vert ) = [ \begin{matrix}\frac{1}{2} & 0 \\ 0 & \frac{1}{2}\end{matrix} ] = \frac{1}{2} I ,$$

where I is the 2×2 identity matrix. The application of Eq. 19 to find the average value of spin along any one of the three axes X, Y and Z (and indeed along any arbitrary direction indicated by unit vector û) will yield zero. We further note that the Von Neumann Entropy, which is defined as S=−Tr(ρ ln(ρ)), is maximum for our mixed state and minimum (zero) for the coherent superposition. Given perfect knowledge of our pure state versus the equiprobable statistics of our mixture this is the expected result. We also note that the same density operator is obtained when describing the Einstein Podolsky Rosen (EPR) states.

The density matrix becomes an especially useful tool when dealing with entangled states. Such states may include entangled states that obey either Bose-Einstein or Fermi-Dirac statistics. These types of states are not found in classical information theory, but are of great interest in quantum information theory. Using the z-basis decomposition implicitly, the two possible two-qubit states that exhibit entanglement are (also see Eqs. 2a & 2b):

$$\vert {ϕ}^{\pm } = \frac{1}{\sqrt{2}} ( \vert - , - \pm \vert + , + ) = \frac{1}{\sqrt{2}} ( \vert 00 \pm \vert 11 ) , \qquad Eq . 20 a$$

$$\vert {ψ}^{\pm } = \frac{1}{\sqrt{2}} ( \vert - , + \pm \vert + , - ) = \frac{1}{\sqrt{2}} ( \vert 01 \pm \vert 10 ) . \qquad Eq . 20 b$$

We use here the convention that wave functions ϕ denote entities that obey Bose-Einstein statistics (they are correlated). Wave functions ψ denote entities that obey Fermi-Dirac statistics and are subject to the Pauli Exclusion Principle (they are anti-correlated). The latter cannot occupy the same quantum state, as evident from inspecting Eq. 20b. Maximally entangled states of Eqs. 20a & 20b are also sometimes called Bell states by those skilled in the art.

Applying unitary evolution operators to pure and to entangled states, including the maximally entangled Bell states, is at the foundation of quantum computing. In fact, quantum logic gates are implementations of exactly such operators. Therefore, the ability to translate an algorithm into a form that can be “programmed” in quantum logic is of great interest. Considerable resources have been allocated to quantum computing. The algorithm of Peter Shor for prime number factoring is one of the promising applications for such quantum logic gates when finally developed.

Still, despite the excitement and massive resources allocated to the development of quantum computers, many challenges and open questions remain. These include the number of quantum gates that can be made to cooperate reliably in the given physical instantiation, generation of entangled states, the overall physical system and conditions under which the gates are implemented, types of gates (e.g., Hadamard gate, Pauli gates, Phase shift gates, Toffoli gate etc.), quantum error correction codes and their practical efficacy as well as many others. Early ideas in this field can be found in Feynman, Richard P., “Simulating Physics with Computers”, International Journal of Theoretical Physics 21 (6-7), pp. 467-488, 1982. Subsequent development is found in textbooks such as Nielsen, Michael A. and Chuang, Isaac L., “Quantum Computation and Quantum Information”, Cambridge University Press, 2000. Finally, current literature should be consulted for the progress being made in this exciting subject.

II. Basic Quantum Cognition Model—Applications without Entanglement

We now return to the application of an embodiment of a quantum cognition model in Quantum Processing Unit 322 of integrated computing architecture 300 using the above explained concepts from quantum mechanics and field theory. Recall that in the present embodiment specific item 330A was selected from inventory of items 330 contained in data layer 302A. Further, from among all market agents N shown in graph 322 only a certain agent subgroup or agent segment 332A of agents have exhibited trading activity in specific item 330A. FIG. 3B illustrated just agent segment 332A in a dashed outline above graph 332.

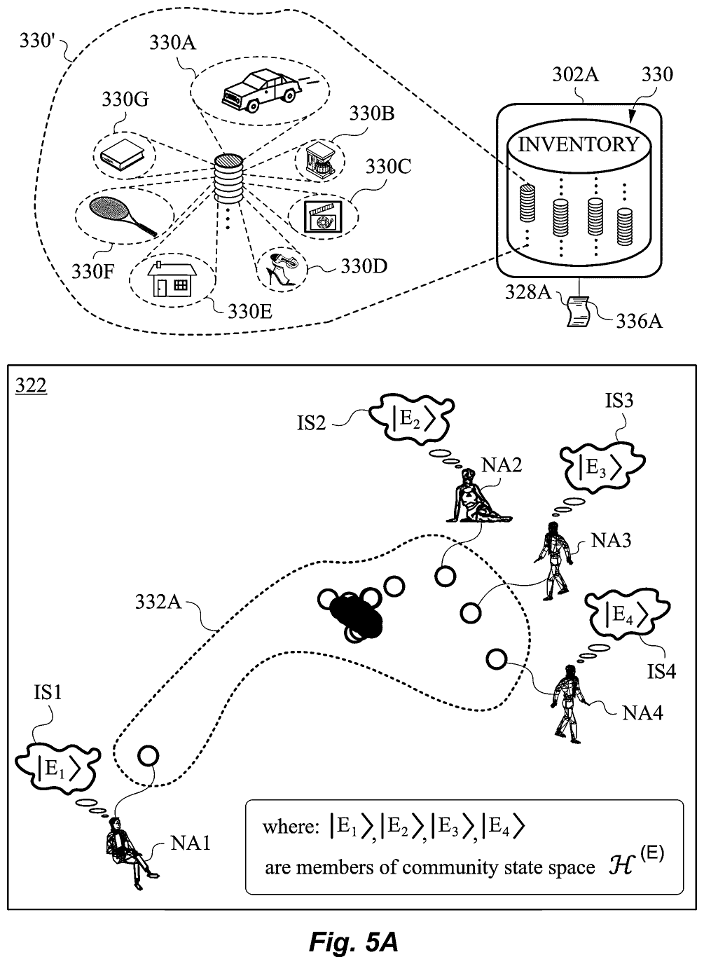

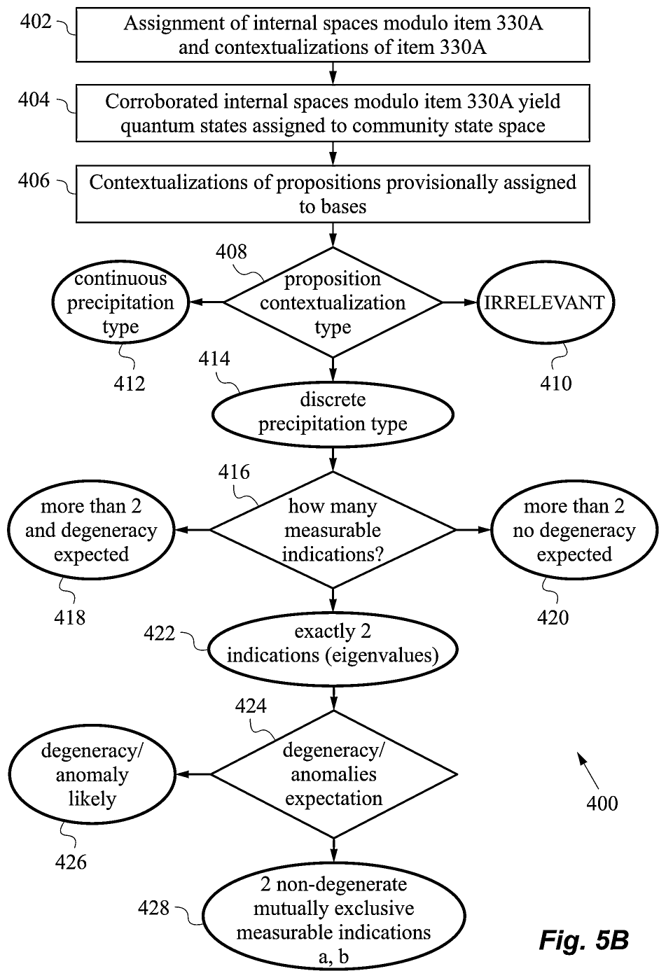

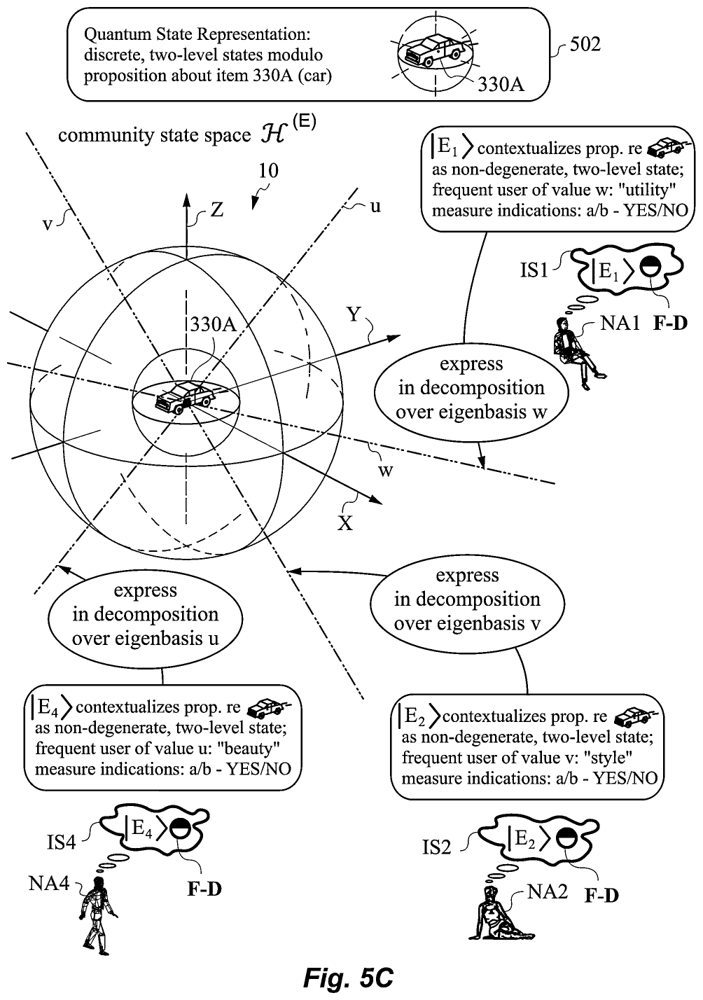

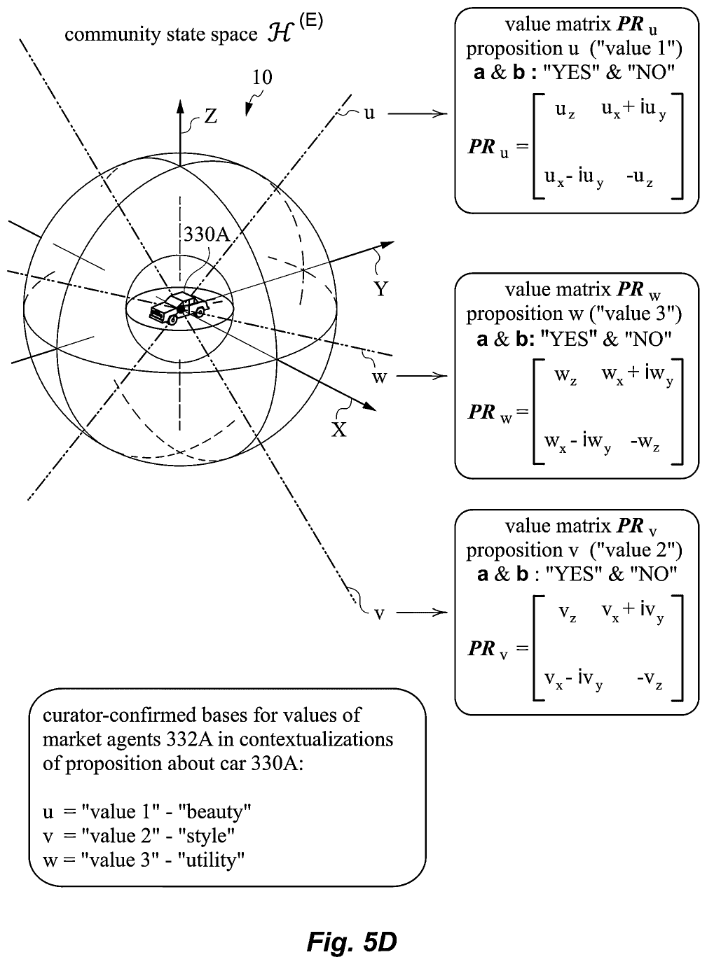

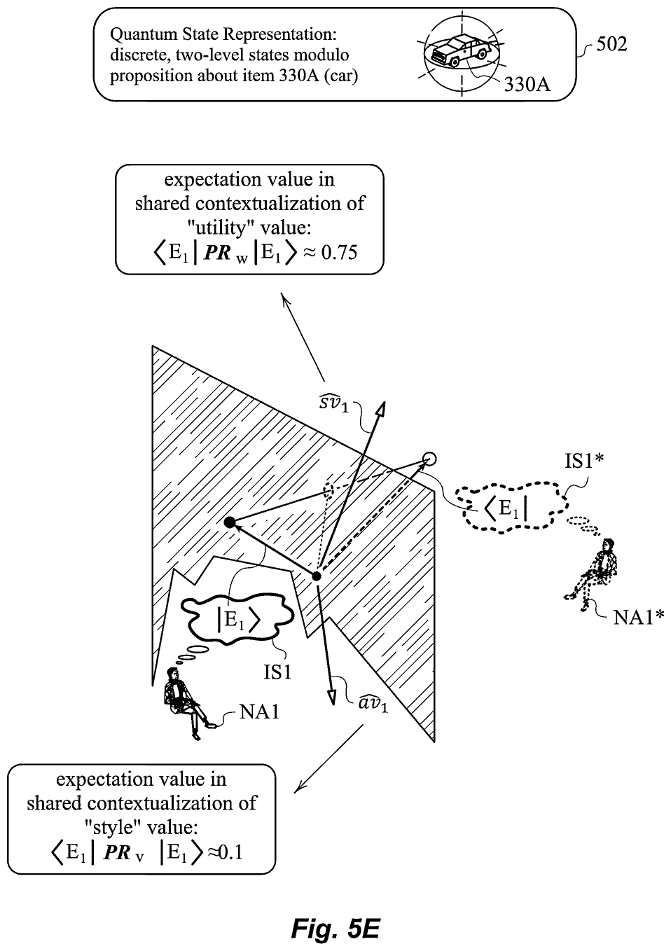

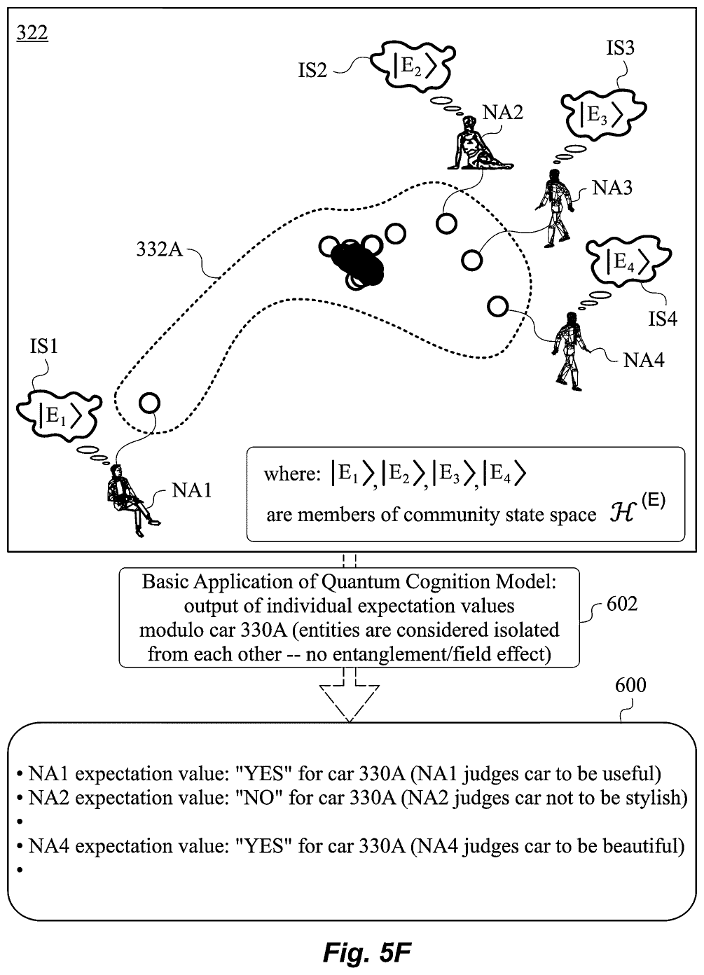

FIG. 5A illustrates the conditions necessary for applying the present quantum cognition model to treat segment 332A of agents in Quantum Processing Unit 322. FIG. 5A also shows inventory of items 330 of data layer 302A in more detail in order to explain key concepts in applying the present quantum cognition model. These key concepts are propositions that are perceived by agents in segment 332A as well as the contextualization (also referred to as context or contextuality) that agents belonging to segment 332A adopt in evaluating the propositions.

A portion 330′ of inventory of items 330 is shown enlarged within a dashed outline. As seen in portion 330′, specific item 330A on which our explanations will rely is a car. Other items 330B-G in portion 330′ include a coffee maker, a movie, a pair of shoes, a house, a tennis racket and a book, respectively. In the present quantum cognition model each item of inventory 330 associates with a proposition about that item. Thus, car 330A is taken as presenting a proposition to certain agents 332, namely agents in segment 332A that transact over cars. Car 330A does not present a proposition to agents that do not conceive or consider transacting over cars. In other words, to those agents that are not interested in car 330A it is irrelevant; they see no proposition and no need to contextualize anything.

Of course, Quantum Processing Unit 322 is designed to work with many propositions about different items form inventory 330. In other words, item 330A that is instantiated by the car depicted in FIG. 5A is merely an exemplary item or object. We will frequently focus just on car 330A for purposes of a more clear and practical explanation of the present quantum cognition model.

Meanwhile, inventory of items 330 contains a large number of additional eligible items besides those shown in portion 330′. As understood herein, items in inventory 330 include objects, goods, services, experiences (aka experiential goods) and any other items that agents 332 are open to considering. In other words, at least some of agents 332 will be open to formulating propositions in their minds modulo those items of inventory 330. Preferably, a human curator familiar with human experience and specifically with the lives and cognitive expectations of agents 332 under consideration should review the final inventory of items 330. The curator should not include among items 330 any that do not register any response, i.e., those generating a null response among agents 332 and are thus irrelevant.

In addition to formulating propositions about items 330, it is important that agents 332 also contextualize the propositions they formulate modulo the items 330 in a manner that is of interest. For example, in the case of car 330A, it is important that agents 332A perceive car 330A as presenting a legitimate proposition in their minds. In other words, agents 332A confronted with car 330A as a proposition conceive in trading car 330A. Furthermore, it is important that agents 332A also contextualize the proposition in a useful manner, in particular in a manner that can lead to a buy-sell transaction between them. In terms of the quantum mechanical concepts introduced above, these two requirements correspond to agents 332A perceiving in the same space (perceiving the proposition) and agents 332A also adopting certain bases (contextualizations) modulo the proposition. More strictly still, that corresponds to being in the same space in the quantum sense (e.g., same Hilbert Space) and adopting certain contexts or bases for measurement in the quantum sense.

Optionally, a curator may perform an analysis of data obtained from agents 332A prior to running the quantum cognition model to eliminate non-conforming agents 332A. Such data may indicate that agents 332A are not really in the market for car 332A and thus do not perceive the proposition, i.e., it is irrelevant to them. Even if agents 332A perceive the proposition, they may adopt a contextualization that is not useful. For example, agents 332A may contextualize car 330A as worth stealing or in still another context that is illegal. Contextualizations that are not of interest may be considered as mis-contextualizions and thus either agents 332A that mis-contextualize and/or items 330 that provoke such mis-contextualizations may be left out. All null responses (irrelevant) and mis-contextualizations should preferably be confirmed by prior encounters with the potentially problematic item by agents 332A. The curator may be able to further understand the reasons for irrelevance and mis-contextualization to thus rule out the specific item from inventory of items 330.

FIG. 5B is a flow diagram 400 illustrating the steps performed by Quantum Processing Unit 322 to set up agents 332A to be treated in accordance with the present quantum cognition model. The steps in FIG. 5B will be explained in reference to FIG. 5A.

In a first step 402 Quantum Processing Unit 322 assigns internal spaces IS1, IS2, IS3 and IS4 modulo item 330A, in the present example car 330A, to select four agents 332A expressly visualized and expressly designated as NA1, NA2, NA3 and NA4 in FIG. 5A. (The remaining agents 332A not among the four being expressly considered at this time will be considered later for reasons explained below.) In doing so, Quantum Processing Unit 322 confirms the relevance of the proposition presented by car 330A to agents NA1, NA2, NA3 and NA4 and the contextualizations that agents NA1, NA2, NA3 and NA4 adopt modulo the proposition. Thus, step 402 taken by Quantum Processing Unit 322 is the first formal step in treating agents NA1, NA2, NA3 and NA4 in accordance with the present quantum cognition model.

In step 404 internal spaces IS1, IS2, IS3 and IS4 modulo item 332A are corroborated to exist and corresponding entity wavefunctions or states |E₁ [symbol] , |E₂ [symbol] , |E₃ [symbol] and |E₄ [symbol] are posited. At this point, states |E₁ [symbol] , |E₂ [symbol] , |E₃ [symbol] and |E₄ [symbol] are simply considered to be members of a community values space or a community state space [symbol] ^{(E)}. Community state space [symbol] ^{(E)} is a common space in the quantum sense, e.g., a common Hilbert Space as will be appreciated by one skilled in the art. Any specific quantum representation of states |E₁ [symbol] , |E₂ [symbol] , |E₃ [symbol] and |E₄ [symbol] will apply in a community state space [symbol] ^{(E)} postulated to exist between agents NA1, NA2, NA3 and NA4.

It should be remarked here that all steps performed to arrive at a quantum cognition representation of agents NA1, NA2, NA3 and NA4 in the form of internal quantum states |E₁ [symbol] , |E₂ [symbol] , |E₃ [symbol] and |E₄ [symbol] due to propositions about car 330A also apply to obtaining quantum representation(s) of any additional or separate agent or agents. Such agent or agents may or may not share the same community state space [symbol] ^{(E)} but may nonetheless be of interest.

In step 406, Quantum Processing Unit 322 takes it as a given from prior step 404 that car 330A registers or is perceived as a proposition in community state space [symbol] ^{(E)}. Based on this and the most commonly known contextualizations of car 330A as found from available data and/or based on findings of the human curator a number of corresponding bases are provisionally assigned. Different bases correspond to different ways of contextualizing and thus valuing or evaluating the proposition about car 330A. Still differently put, different judgement criteria that can be adopted by agents NA1, NA2, NA3 and NA4 in valuing proposition about car 330A correspond to different bases within community state space [symbol] ^{(E)}. The choice of bases will be explained in considerably more detail below.

Next step 408 performed by Quantum Processing Unit 322 is important from the point of view of the quantum cognition model as it relates to the type of contextualization of underlying proposition about items 330, and in the present example about of car 330A by agents NA1, NA2, NA3 and NA4. Different contextualization types will lead to different actions or outcomes by agents NA1, NA2, NA3 and NA4. In the context of the quantum cognition model we refer to actions, outcomes or any other measurable indications or measurables produced by agents NA1, NA2, NA3 and NA4 as precipitations. Put differently, precipitations correspond to measurable indications or measurement outcomes in the quantum sense.

We consider two precipitation types and a null result or “IRRELEVANT” designated by 410. The careful reader will have noticed that items 330 that induce a null response encoded here by “IRRELEVANT” 410 should have been previously eliminated. However, since step 408 determines the precipitation for each agent NA1, NA2, NA3 and NA4 the “IRRELEVANT” 410 result is indicated here for the sake of completeness of flow diagram 400.

The first precipitation type being considered herein is a continuous precipitation type 412. The second type is a discrete precipitation type 414. Although continuous precipitation type 412 certainly admits of a quantum cognition representation we will focus on discrete precipitation type 414 in the present discussion. That is because despite the fact that continuous precipitation type 412 can be used in apparatus and methods of the invention, it is more difficult to model with graphs and the mathematical formalism is more involved. Furthermore, such continuous precipitation type 412 does not typically yield clearly discernible, mutually exclusive measurable indications or responses by agents NA1, NA2, NA3 and NA4 in their contextualization (e.g., modulo the proposition about car 330A in the present example). In other words, in the case of car 330A as an example, continuous precipitation type 412 in the contextualization of say “LIKE” could yield a wide spread in the degree of liking of car 330A for a multitude of reasons and considerations. Of course, a skilled artisan will be able to adopt the present teachings to continuous cases using standard tools known in the art.

In preferred embodiments of the invention, we seek simple precipitation types corresponding to simple contextualization of underlying proposition about items 330 and of car 330A in this specific example. In other words, we seek to confirm the community or group of agents NA1, NA2, NA3 and NA4 in whose minds or internal spaces IS1, IS2, IS3 and IS4 the proposition about car 330A induces discrete precipitation type 414. This precipitation type should apply individually to each one of agents NA1, NA2, NA3 and NA4 selected, and in fact to all agents of segment 332A.

It is further preferred that the contextualization be just in terms of a few mutually exclusive states and correspondent mutually exclusive responses or, more generally measurable indications that the agent can exhibit. Most preferably, the contextualization of underlying proposition about car 330A corresponds to discrete precipitation type 414 that manifests only two orthogonal internal states and associated mutually exclusive responses or precipitations such as “YES” and “NO”. In fact, for most of the present quantum cognition model we will be concerned with exactly such cases for reasons of clarity of explanation and mathematical simplicity. Once again, review by the human curator is highly desirable in estimating the number of internal states and corroborating that two mutually exclusive states are appropriate for agents NA1, NA2, NA3 and NA4 (and ideally for all market agents belonging to segment 332A) confronted with the proposition presented by car 330A.

Additionally, discrete precipitation type 414 into just two orthogonal states associated with two distinct eigenvalues corresponds to the physical example of spinors that we have already explored in the above review contained in the sub-sections of Section I. Many mathematical and applied physics tools have been developed over the past decades to handle these types of entities. Thus, although more complex precipitation types and numerous orthogonal states can certainly be handled by the tools available to those skilled in the art (see, e.g., references on working in the energy or Hamiltonian eigen-basis of general systems), cases where entities' internal states are mapped to two-level quantum systems are by far the most efficient. Also, two-level systems tend to keep the computational burden on Quantum Processing Unit 322 within a reasonable range and do not require excessively large amounts of data files to set up in practice. Two-level systems will also tend to keep the computational burden low even when the more robust descriptions of agent states in terms of correspondent density matrices have to be implemented.

For the above reasons we now continue with the case of discrete precipitation type 414 modulo the proposition about car 330A admitting of only discrete and orthogonal eigenstates. In other words, internal quantum states |E₁ [symbol] , |E₂ [symbol] , |E₃ [symbol] and |E₄ [symbol] residing in internal spaces IS1, IS2, IS3 and IS4 of agents NA1, NA2, NA3 and NA4 decompose into superpositions of these few discrete and orthogonal eigenstates.

In this most preferred case, discrete precipitation type 414 induces agents NA1, NA2, NA3 and NA4 to contextualize the proposition presented by car 330A in terms of just two mutually exclusive states manifesting in mutually exclusive measurable indications or responses such as “YES” and “NO”. Thus, the manner in which agents NA1, NA2, NA3 and NA4 contextualize the proposition about car 330A in this preferred two-level form can be mapped to quantum-mechanically well-understood entities such as simple spinors or qubits.

Now, before proceeding to the next step performed by Quantum Processing Unit 322 with agents NA1, NA2, NA3 and NA4 that do fall into the above preferred discrete precipitation type 414 with two eigenstates and two eigenvalues, it is important to ensure proper quantum behavior of the assigned internal quantum states |E₁ [symbol] , |E₂ [symbol] , |E₃ [symbol] and |E₄ [symbol] in common values space or community state space [symbol] ^{(E)}, as will be appreciated by one skilled in the art.

We now turn our attention to step 416 in which Quantum Processing Unit 322 confirms the number of measurable indications or eigenvalues associated with discrete precipitation type 414 to be two (2), as selected for the most preferred case. We should briefly remark on the other possibilities that we are not discussing in detail. In case 418 more than two eigenvalues are expected and some of them are associated with different state vectors. This is a classic case of a quantum mechanical system with degeneracy. In other words, the system has several linearly independent state vectors that have the same eigenvalues or measurable indications. Those skilled in the art will recognize that this typical situation is encountered often when working in the “energy-basis” dictated by the Hamiltonian.

In case 420 more than two eigenvalues are expected and all of them are associated with different state vectors. Such systems can correspond to more complicated quantum entities including spin systems with more than two possible projections along the axis on which they precipitate (e.g., total spin 1 systems). Quantum mechanical systems that are more than two-level but non-degenerate are normally easier to track than systems with degeneracy. Those skilled in the art will recognize that cases 418 and 420 can be treated with available tools.

In the preferred embodiment of the instant invention, however, we concentrate on case 422 selected in step 416 in which there are only two eigenvalues or two measurable indications. In other words, we prefer to construct the apparatus and methods of invention on the two-level system. As mentioned above, it is desirable for the human curator that understands agents NA1, NA2, NA3 and NA4 to review these findings to limit possible errors due to misjudgment of whether the precipitation is non-degenerate and really two-level. This is preferably done by reviewing historical data of responses, actions and any measurable indications that are available (e.g., from any historical data files available about agents NA1, NA2, NA3 and NA4) that are used by Quantum Processing Unit 322 in making the determinations. We thus arrive at a corroborated selection of internal quantum states |E₁ [symbol] , |E₂ [symbol] , |E₃ [symbol] and |E₄ [symbol] that apparently form a community or group and exhibit discrete precipitation with just two eigenvalues and whose internal quantum states |E₁ [symbol] , |E₂ [symbol] , |E₃ [symbol] and |E₄ [symbol] in internal spaces IS1, IS2, IS3 and IS4 can therefore be assigned to two-level wave functions or quantum states.

A final two-level system review step 424 may optionally be performed by Quantum Processing Unit 322. This step should only be undertaken when agents NA1, NA2, NA3 and NA4 can be considered based on all available data and, in the human curator's opinion, as largely independent of their social group and overall social environment. In other words, the level of quantum entanglement of internal quantum states |E₁ [symbol] , |E₂ [symbol] , |E₃ [symbol] and |E₄ [symbol] with the environment is low as determined with standard tools.

In human terms, low levels of entanglement are likely to apply to agents that are extremely individualistic and formulate their own opinions without apparent influence by others within their community/group or outside of it. When such radically individualistic agents beyond social influences are found, their further examination is advantageous to bound potential error in assignments of internal quantum states |E₁ [symbol] , |E₂ [symbol] , |E₃ [symbol] and |E₄ [symbol] and/or in the case of more rigorous procedures, any errors in the estimation of internal quantum states |E₁ [symbol] , |E₂ [symbol] , |E₃ [symbol] and |E₄ [symbol] or more robust expressions formulated with the aid of density matrices.

Preferably, Quantum Processing Unit 322 should divide case 422 into sub-group 426 and sub-group 428. Sub-group 426 is reserved for agents NA1, NA2, NA3 and NA4 that despite having passed previous selections exhibit some anomalies or couplings. These are potentially due to entanglements with the environment. Agents NA1, NA2, NA3 and NA4 with internal quantum states |E₁ [symbol] , |E₂ [symbol] , |E₃ [symbol] and |E₄ [symbol] manifesting substantial levels of entanglement and/or other anomalies that may cause degeneracy or other unforeseen issues should be put in sub-group 426. These agents may be eliminated from being used in any predictions or simulations if only pure states are used. They may be retained, however, if a suitable density matrix representation is possible, as will be appreciated by those skilled in the art.

Meanwhile, sub-group 428 is reserved for confirmed well-behaved agents NA1, NA2, NA3 and NA4 whose internal quantum states |E₁ [symbol] , |E₂ [symbol] , |E₃ [symbol] and |E₄ [symbol] reliably manifest in two-level, non-degenerate, measurable indications a and b (e.g., “YES” and “NO”) modulo underlying proposition about the chosen item which, in the present example, is car 330A. These well-behaved agents NA1, NA2, NA3 and NA4 can be assigned two-level state vectors |E₁ [symbol] , |E₂ [symbol] , |E₃ [symbol] and |E₄ [symbol] by Quantum Processing Unit 322 as explained in more detail below.

In addition to selecting agents NA1, NA2, NA3 and NA4 that can be assigned to two-level states |E₁ [symbol] , |E₂ [symbol] , |E₃ [symbol] and |E₄ [symbol] , Quantum Processing Unit 322 examines common values space or community state space [symbol] ^{(E)}. In particular, Quantum Processing Unit 322 confirms that that all two-level states |E₁ [symbol] , |E₂ [symbol] , |E₃ [symbol] and |E₄ [symbol] (found to exhibit the desired discrete, non-degenerate, two-level precipitation type with respect to the proposition about car 330A) really inhabit a common values space that can be represented by single community state space [symbol] ^{(E)}. For the remaining portion of the present teachings, it will be assumed that all agents NA1, NA2, NA3 and NA4 are indeed found to be in sub-group 428 and thus justify assignment of state vectors or quantum states |E₁ [symbol] , |E₂ [symbol] , |E₃ [symbol] and |E₄ [symbol] in community state space [symbol] ^{(E)}.

FIG. 5C is a diagram to help visualize the operations performed by Quantum Processing Unit 322 in the formal assignment of quantum states. This drawing figure focuses in particular on three selected agents NA1, NA2 and NA4 with their respective internal spaces IS1, IS2 and IS4. All three agents NA1, NA2 and NA4 are posited in common values space [symbol] ^{(E)} based on the steps described above.

An overall context 502 for the quantum cognition model is included at the top of FIG. 5C. Context 502 reminds us that in their quantum cognition representation quantum states |E₁ [symbol] , |E₂ [symbol] and |E₄ [symbol] of agents NA1, NA2 and NA4 behave as discrete, two-level systems based on the determinations made by Quantum Processing Unit 322 as described above. Each of those can be conveniently represented with the aid of Bloch sphere 10 introduced above.

Quantum Processing Unit 322 formally posits or creates selected agents NA1, NA2 and NA4 that belong to the community by virtue of sharing community values space [symbol] ^{(E)} modulo the proposition about car 330A. The action of positing is connected with the quantum mechanical action associated with the application of creation operators. Also, annihilation operators are used for un-positing or removing quantum states |E₁ [symbol] , |E₂ [symbol] and |E₄ [symbol] of agents NA1, NA2 and NA4 from consideration (e.g., when an agent loses all interest in cars). Just to recall the physics assumptions being used herein when creating and annihilating states, it is important to know what type of state is being created or annihilated. Symmetric wave functions are associated with elementary (gauge) and composite bosons. Bosons have a tendency to occupy the same quantum state under suitable conditions (e.g., low enough temperature and appropriate confinement parameters). The operators used to create and annihilate bosons are specific to them. Meanwhile, fermions do not occupy the same quantum state under any conditions and give rise to the Pauli Exclusion Principle. The operators used to create and annihilate fermions are specific to them as well.

In the case of agents NA1, NA2 and NA4 it is known that they exhibit anti-clustering behavior from FIG. 3C. In other words, agents NA1, NA2 and NA4 by virtue of being far apart within graph 322 indicate that in the context of trade in car 330A they exhibit N-FD or anti-consensus statistics. Therefore, in FIG. 5C each one of agents NA1, NA2 and NA4 has its corresponding quantum state |E₁ [symbol] , |E₂ [symbol] and |E₄ [symbol] supplemented by an F-D anti-consensus statistic indicator. In other words, the quantum behavior of agents NA1, NA2 and NA4 is spinor-like or electron-like (they obey the Pauli Exclusion Principle). Thus, formally, agent states |E₁ [symbol] , |E₂ [symbol] and |E₄ [symbol] corresponding to agents NA1, NA2 and NA4 exhibiting F-D anti-consensus statistic are created by fermionic creation operator ĉ^{†} and posited in shared community space [symbol] ^{(E)}.

FIG. 5C thus shows agent NA1 with internal space IS1 already assigned to a two-level quantum state vector or quantum state |E₁ [symbol] with an F-D marking. Similarly, agents NA2, NA4 with internal spaces IS2, IS4 have two-level quantum states |E₂ [symbol] , |E₄ [symbol] with F-D markings. Further, based on historical data files Quantum Processing Unit 322 has determined that the most likely value applied by agent NA1 in contextualization of the proposition about car 330A concerns the car's “utility”. Since the precipitation type of agent's NA1 quantum state |E₁ [symbol] is two-level the two possible measurable indications a, b map to a “YES” indication and a “NO” indication. Simply put, agent NA1 will judge car 330A to be useful (“YES”) or not useful (“NO”). Thus, the measurable indications a, b in this case are two mutually exclusive responses “YES” and “NO”. The corresponding eigenstates “UP” and “DOWN” are taken to be along axis w represented in Bloch sphere 10.

Meanwhile, agent NA2 with internal space IS2 is assigned their discrete, two-level estimated quantum states |E₂ [symbol] with an F-D marking. The latter serves to remind us that agent NA2 also exhibits F-D anti-consensus statistic with respect to other agents when contextualizing proposition about car 330A. In this case, Quantum Processing Unit 322 has determined that the most common value applied by agent NA2 in contextualizing the proposition about car 330A concerns the car's “style”. Thus, in any measurement the a or “YES” indication indicates that agent NA2 judges car 330A to be stylish. The corresponding eigenstate is taken as “UP” along v. The b or “NO” indication indicates that agent NA2 judges car 330A to not be stylish. The corresponding eigenstate is taken as “DOWN” along axis v represented in Bloch sphere 10.

Agent NA4 with internal state IS4 is also assigned their discrete, two-level estimated quantum states |E₄ [symbol] with an F-D marking designating anti-consensus statistic with respect to other agents when contextualizing proposition about car 330A. In the case of agent NA4 Quantum Processing Unit 322 determined that the most common value applied by agent NA4 in contextualizing the proposition about car 330A concerns its “beauty”. Thus, in any measurement the a or “YES” indication indicates that market agent NA4 judges car 330A to be beautiful. The corresponding eigenstate is taken “UP” along the u axis represented in Bloch sphere 10. The b or “NO” indication indicates that agent NA4 judges car 330A to not be beautiful. The corresponding eigenstate is taken “DOWN” along the u axis. Thus decomposed in the u-eigenbasis quantum state |E₄ [symbol] of agent NA4 is processed and finally placed in community state space [symbol] ^{(E)}.

Proceeding in this manner, Quantum Processing Unit 322 assigns community agent states |Eᵢ [symbol] to any other F-D type agents belonging to segment 332A and posited in community state space [symbol] ^{(E)}. In the present example, this is done for agent NA3 (not expressly shown in FIG. 5C).

In general, measurable indications a, b transcend the set of just mutually exclusive responses that can be articulated in data files or other types of information available about agents N, and specifically segment 332A of agents in this example. Such measurable indications can include actions, choices between non-communicable internal responses, as well as any other choices that agents N can make internally but are unable to communicate about externally. Because such “internal” choices are difficult to track, unless agents N are under direct observation by another human that understands them, they may not be of practical use in constructing quantum states in accordance with the quantum cognition model of the present invention.

On the other hand, mutually exclusive responses that can be easily articulated by agents N are suitable in the context of the present invention. The actual decomposition into the corresponding eigenvectors or eigenstates and eigenvalues that correspond to the measurable indications a, b, as well as the associated complex coefficients, probabilities and other aspects of the well-known quantum formalism will be appreciated by those skilled in the art and in light of the above introductory sub-sections of Section I.

It is important to realize that the assignment by Quantum Processing Unit 322 of quantum states will most often be an estimate. Of course, may not be an estimate in the case of confirmed and very recent measurement. Measurement occurs when any particular agent Nᵢ, this includes agents in segment 332A, has just yielded one of the measurable indications, which corresponds to an eigenvalue λᵢ that associates with an eigenvector in that eigenbasis. At that point, Quantum Processing Unit 322 simply sets quantum state |Eᵢ [symbol] to that eigenvector. The estimate of quantum state |Eᵢ [symbol] is valid for the proposition about car 330A in the context of agents 332A. The estimate reflects the contextualization adopted by agent NAᵢ at a certain time and will generally change as the quantum state of agent NAᵢ evolves with time. The same is true for the measured state since all states evolve (only eigenvalues observed during quantum measurements represent facts that are immutable records of which a history can be made).

Updates to the estimates and prior measurements of all quantum states are preferably derived from contextualizations that have been actually measured within a time period substantially shorter than or less than a decoherence time. Since no contextualizations are identical, even if only due to temporal evolution of the state, similar contextualizations should be used in estimating states whenever available. In other words, estimates based on propositions about car 330A should be used whenever available to Quantum Processing Unit 322. This strategy allows Quantum Processing Unit 322 to always have access to an up-to-date estimated or measured quantum state.

Quantum states modulo certain propositions may exhibit very slow evolution on human time scales, e.g., on the order of months, years or even decades. States with very long decoherence times are advantageous because they do not require frequent updates after obtaining a good first estimate or preferably even a measurable indication. For states that evolve more quickly, frequent updates will be required to continuously maintain fresh states.

Preferably, Quantum Processing Unit 322 curates what we will consider herein to be estimated quantum probabilities pₐ, p_{b} for the corresponding measurable indications a, b of all quantum states |Eᵢ [symbol] . Of course, a human expert curator or other subject informed about the human meaning of the information available about agents NAᵢ should be involved in setting the parameters. The expert human curator should also verify the measurement in case the derivation of measurable indications actually generated is elusive or not clear from data files. Such review by an expert human curator will ensure proper derivation of estimated quantum probabilities pₐ, p_{b}.

In some embodiments Quantum Processing Unit 322 may be connected to external resources such as networks and data repositories (not shown) such that it has access to documented data generated by agents NAᵢ in real time or nearly real time. Quantum Processing Unit 322 can then monitor the state and online actions of agents NAᵢ without having to rely on any intermediary resources. Of course, since Quantum Processing Unit 322 is part or integrated computing architecture 300 that is typically found within one local device, this may only be practicable for tracking a few very specific agents NAᵢ, in the present case that means tracking just agents that are members of the relatively small segment 332A.

In the present example, contextualization of the proposition about car 330A by any one of agents belonging to segment 332A that manifests the two-level, non-degenerate precipitation type is taken to exhibit two of the most typical opposite responses or measurable indications, namely “YES” and “NO”. In general, however, mutually exclusive measurable indications or responses can also be opposites such as “high” and “low”, “left” and “right”, “buy” and “sell”, “near” and “far”, and so on. The proposition about car 330A may evoke actions or feelings that cannot be manifested simultaneously, such as liking and disliking the same item at the same time, or performing and not performing some physical action, such as buying and not buying an item at the same time. Frequently, situations in which two or more mutually exclusive responses are considered to simultaneously exist lead to nonsensical or paradoxical conclusions. Thus, in a more general sense mutually exclusive responses in the sense of the invention are such that the postulation of their contemporaneous existence would lead to logical inconsistencies and/or disagreements with fact. This does not mean that any one of agents of segment 332A may not internally experience such conflicts, and indeed the quantum cognition model supports such internal states! However, it does mean that agents cannot act out opposite measurable indications in practice (i.e., you can't buy and not buy car 330A at the exact same time).

Sometimes, after exposure to the proposition about car 330A any one of agents from segment 332A may react in an unanticipated way and no legitimate response can be obtained in the contextualization of the proposition adopted in the quantum cognition model. The quality of tracking will be affected by such “non-results”. Under these circumstances devoting resources to assigning and monitoring of quantum states and monitoring of their expectation value becomes an unnecessary expenditure. Such non-response can be accounted for by classical null response probability pₙᵤₗₗ. In some cases, non-results or spurious responses can be due to being outside the range of validity for the quantum representation of the specific agent. In a preferred embodiment, Quantum Processing Unit 322 confirms the range of validity to eliminate form consideration agents in segment 332A whose quantum states fall outside of this range of validity.

In preferred embodiments of Quantum Processing Unit 322 it is preferable to remove non-responsive agents of segment 332A after a certain amount of time. The amount of time may be corroborated by the human curator and it should be long in comparison with the decoherence time. Therefore, any agents of segment 332A observed to generate “non-results” for a comparatively long time are removed from community state space [symbol] ^{(E)} by action with a corresponding annihilation operator. This is tantamount to removing the agent from tracking. This action is also referred to as annihilation in the field of quantum field theory. It is here executed in analogy to its action in a field theory by the application of fermionic or bosonic annihilation operator ĉ or â by Quantum Processing Unit 322. The type of annihilation operator depends on whether the agent's quantum state exhibits B-E consensus or F-D anti-consensus statistic during its original creation.

FIG. 5D illustrates another important function performed by Quantum Processing Unit 322. This function is to convert into quantum representation agent values (not to be confused with numeric values—here we mean entity/subject values or judgment criteria). Specifically, the values we mean here are those that agents NAᵢ apply in their contextualizations, apprehensions, frames of mind, judgments and/or assessments. FIG. 5D continues with the same example, namely the one focused on agents NA1, NA2 and NA4. Instead of reviewing the quantum states, however, Quantum Processing Unit 322 now trains on the eigenvectors that make up the u-, v- and w-eigenbases. These eigenbases are associated with contextualizations of the underlying proposition using the values of “beauty”, “style” and “utility”, respectively.

Since quantum states |Eᵢ [symbol] are two-level they can be spectrally decomposed in bases with two eigenvectors. In particular, the spectral decompositions of quantum states |E₁ [symbol] , |E₂ [symbol] , |E₄ [symbol] belonging to agents NA1, NA2 and NA4 as shown in FIG. 5C have already introduced the u-, v- and w-eigenbases. Each of these three eigenbases has two eigenvectors that are not explicitly drawn here (see, e.g., FIGS. 4A & 4B and corresponding description). In other words, the eigenvectors in this example come in pairs. There is one “UP” and one “DOWN” eigenvector in each of the three eigenbases. Equivalently put, we have eigenvectors that are parallel and anti-parallel with the u, v and w rays shown in FIGS. 5C & 5D.

By convention already introduced above, we take “UP” eigenvectors to mean that the agent is experiencing a state of positive judgment in that value (contextualization yields positive value judgment). Therefore, the “UP” eigenvector is associated with the first eigenvalue λ₁ that we take to stand for the “YES” measurable indication a. The “DOWN” eigenvectors mean the state of negative judgment in that value. Hence, the second eigenvalue λ₂ that goes with the “DOWN” eigenvector is taken to stand for “NO” measurable indication b.

In the quantum cognition model of contextualization as implemented by Quantum Processing Unit 322 the eigenvector pairs describe the different values that agents may deploy. Agents NA1, NA2 and NA4 can contextualize the proposition about car 330A with any chosen value described by the eigenvector pairs but they can only choose one at a time. In fact, in many applications of the present quantum cognition model it is advantageous to obtain measurable indications a, b (or eigenvalues λ₁, λ₂) from agents NA1, NA2 and NA4 in different eigenvector bases or, equivalently, in different contextualizations.

Based on the rules of linear algebra, quantum states |E₁ [symbol] , |E₂ [symbol] , |E₄ [symbol] forming the quantum representation of agents NA1, NA2 and NA4 modulo underlying proposition about car 330A can be expressed in any contextualization or using any of the available values. This is ensured by the spectral decomposition theorem. We have already used this theorem above in FIG. 5C for quantum state decompositions in terms of eigenvectors. To wit, we have expressed quantum state |E₁ [symbol] of agent NA1 in the w-basis, quantum state |E₂ [symbol] of agent NA2 in the v-basis, and quantum state |E₄ [symbol] of agent NA2 in the u-basis.

In FIG. 5D we proceed further and introduce value matrices PRⱼ whose eigenvectors are the very eigenvectors we have already deployed. Conveniently, we thus express the different bases or eigenbases with corresponding value matrices PRⱼ that have these eigenvectors in their eigenbases. Value matrices PRⱼ represent quantum mechanical operators (Hermitian matrices). In the case of our two-level systems these are related to the Pauli matrices already introduced above.

The quantum mechanical prescription for deriving the proper operator for “beauty” value matrix PRᵤ is based on knowledge of the unit vector û along ray u. The derivation has already been presented above in Eq. 16. To accomplish this task, we decompose unit vector û into its x-, y- and z-components. We also deploy the three Pauli matrices σ₁, σ₂, σ₃. By standard procedure, we then derive value matrix PRᵤ as follows:

$$P {R}_{u} = \hat{u} \cdot \overline{σ} = {u}_{x} {σ}_{1} + {u}_{y} {σ}_{2} + {u}_{z} {σ}_{3} . \qquad Eq . 21 a$$

The same procedure yields the two remaining value matrices PRᵥ, PR_{w} that, in our quantum representation, stand for contextualizations using the values of “style” and “utility”, respectively. Once the decompositions of unit vectors \hat{v}, ŵ along rays v, w are known, these are expressed as follows:

$${PR}_{v} = \hat{v} \cdot \overline{σ} = {v}_{x} {σ}_{1} + {v}_{y} {σ}_{2} + {v}_{z} {σ}_{3} , and \qquad Eq . 21 b$$

$${PR}_{w} = \hat{w} \cdot \overline{σ} = {w}_{x} {σ}_{1} + {w}_{y} {σ}_{2} + {w}_{z} {σ}_{3} . \qquad Eq . 21 c$$

All three value matrices PRᵤ, PRᵥ, PR_{w} obtained from these equations are shown in FIG. 5D in association with their corresponding rays u, v and w.

Per standard rules of quantum mechanics, we take value matrices PRⱼ to act on or be applied to quantum states |Eᵢ [symbol] to yield eigenvalues λₖ associated with measurable indications modulo the proposition about car 330A as exhibited by agents NA1, NA2 and NA4. The eigenvalues, of course, stand for the “YES” and “NO” measurable indications. The practitioner is reminded that prior to the application of the corresponding value matrix the quantum state should be expressed in the eigenbasis of that value matrix. In the case of values represented with value matrices PRᵤ, PRᵥ, PR_{w} we are clearly not dealing with eigenvector bases that are completely orthogonal (see FIG. 4E and discussion of the Uncertainty Principle in Section I). Thus, contextualizations with these values are not completely incompatible. However, they are far from compatible, since u-, v- and w- produce clearly different unit vectors.

In some embodiments it will be advantageous to select two or more different eigenvector bases (depending on dimensionality of state space [symbol] ^{(E)}) represented by two or more value matrices PRⱼ that are non-commuting and thus subject to the Heisenberg Uncertainty relation. Measurements obtained over agents NA1, NA2 and NA4 contextualizing with incompatible values as encoded by such non-commuting value matrices PRⱼ will be useful in further explorations and in constructing views of the representations. The measurable indications obtained when contextualizing with such non-commuting value matrices PRⱼ cannot have simultaneous reality. In other words, they cannot be measured/observed for any one of agents NA1, NA2 and NA4 at the same time.

The basic quantum cognition model of the present section (section II) allows for evaluation of expected judgements or indications from agents taken individually. In other words, the basic quantum cognition model does not take into account interactions between agents and any possible joint or entangled states that they may enter.

FIG. 5E visualizes the computation of an expectation value for a measurement on a specific agent taken individually or by itself, in the present case market agent NA1. We see single agent NA1 with a pure quantum state |E₁ [symbol] representing their internal state IS1 at some initial time tₒ. A reasonably pure quantum state representation for market agent NA1 has been confirmed by Quantum Processing Unit 322 (see above). Quantum state |E₁ [symbol] fits the description of discrete and two-level modulo the proposition about car 330A. Overall context 502 for the quantum representation valid in this example is included at the top of FIG. 5E.

The most commonly adopted contextualization practiced by agent NA1 in considering the proposition about car 330A as gleaned from data available to Quantum Processing Unit 322. In the present example, this most commonly adopted contextualization is in terms of “utility”. In other words, agent NA1 typically apprehends proposition presenting car 330A from the point of view of utility. Once again, it is the job of Quantum Processing Unit 322 appraised of information about agent NA1 to formally translate quantum state |E₁ [symbol] , under the “utility” value contextualization into a corresponding quantum cognition representation.

The “utility” value used in the contextualization is presented in the form of value matrix PR_{w}. Since the system is two-level, value matrix PR_{w} has two eigenvectors |sv₁ [symbol] , |sv₂ [symbol] and two corresponding eigenvalues λ₁, λ₂.

In the present example, eigenvector |sv₁ [symbol] is taken for “useful” with corresponding eigenvalue λ₁ standing for the measurable indication agent NA1 yields when it finds that there is utility. In our example, this measurable indication will be also referred to by λ₁ to simplify the notation. Furthermore, it will be counted as a measurable indication or response of: λ₁=“YES” response for “utility” value.

Second eigenvector |sv₂ [symbol] is taken for “not useful” with corresponding eigenvalue λ₂ standing for the measurable indication that agent NA1 yields when considering car 330A as not useful. This negative measurable indication referred to by λ₂ is counted as a measurable indication or response of: λ₂=“NO” response for “utility” value.

Finally, in keeping with the above convention, the complex coefficients for the spectral decomposition of quantum state |E₁ [symbol] of agent NA1 in the basis offered by value matrix PR_{w} are represented by the familiar α, β. This means that Quantum Processing Unit 322 outputs the manifestly Hermitian value matrix PR_{w}:

$${PR}_{w} = \vert \begin{matrix}{W}_{z} & {W}_{x} + {iW}_{y} \\ {W}_{x} - {iW}_{y} & - {W}_{z}\end{matrix} \vert , \qquad Eq . 22$$

where capital W (rather than lower-case we were using before) now stands for the corresponding ray in Hilbert space. Also, Quantum Processing Unit 322 outputs quantum state |E₁ [symbol] decomposed in the eigenbasis of value matrix PR_{w}:

$$\vert {E}_{1} {W}_{} = {α}_{W} \vert s {v}_{1} {W}_{} + {β}_{W} \vert s {v}_{2} {W}_{} , \qquad Eq . 23 a$$

where we use the capital W subscripts to remind ourselves that the quantum cognition representation is in the eigenbasis of value matrix PR_{w}.

Given this decomposition we will expect that a measurement using the contextualization expressed with value matrix PR_{V} will yield the following probabilities for “YES” and “NO” measurable indications or responses of agent NA1 encoded in eigenvalues λ₁, λ₂:

p_{“YES”}=α_{W}*α_{W}(probability of market entity NA1 manifesting eigenvalue λ₁);

p_{“NO”}=β_{W}*β_{W}(probability of market entity NA1 manifesting eigenvalue λ₂).

At this point, data about agent NA1 is used by Quantum Processing Unit 322 to estimate the complex coefficients and the probabilities. Advantageously, the deployment of the invention in a network environment can capture large amounts of “thick” and recent data to help in estimating these coefficients and probabilities. In some cases the estimate may be very good, e.g., when based on a recent measurement. For example, there may exist a recent record, e.g., in a data file of agent NA1 effectively stating: “I find car 330A to be of excellent utility value”. In this case the decomposition is simple and consists only of the first eigenvector |sv₁ [symbol] _{W} with p_{“YES”}=p_{|sv}_{₁} [symbol] =α_{W}=1 (p_{“no”}=p_{|sv}_{₂} [symbol] =β_{V}=0). In the opposite case, where agent NA1 effectively stated: “I find car 330A to have no utility value” we again obtain an excellent estimate. Namely, the decomposition consists only of the second eigenvector |sv₂ [symbol] _{W} with p_{“NO”}=β_{W}=1 (p_{“YES”}=α_{W}=0). The reason why even such measurements should be treated as estimates is due to temporal evolution and decoherence effects that set in with the passage of time. This is also the reason why fresh data is of utmost importance for propositions whose evaluation by a human mind changes quickly with time.

Quantum Processing Unit 322 can also assign a mixed state for agent NA1 in case he or she is known to exhibit a less common but still often deployed alternative contextualization. For example, in a simple case agent NA1 may be known from historical records to deploy the alternative contextualization of “style” value with respect to proposition about car 330A. For the sake of the present example, the probability that agent NA1 actually adopts this alternative contextualization is 10%. This is expressed with an alternative value matrix PRᵥ.

Given this information, Quantum Processing Unit 322 produces an estimate of quantum state |E₁ [symbol] decomposed in the eigenbasis of alternative value matrix PRᵥ:

$$\vert {E}_{1} {V}_{} = {α}_{V} \vert a {v}_{1} {V}_{} + {β}_{V} \vert a {v}_{2} {V}_{} , \qquad Eq . 23 b$$

with the subscript V denoting that the quantum cognition representation is in the eigenbasis of alternative value matrix PR_{V}.

Given that agent NA1 may have some probability of being in a pure state in the eigenbasis of PR_{V}, the two pure states can be combined. The correct quantum mechanical prescription has already been provided in section I and leads to the following density operator for our example:

$$\hat{ρ} = {\sum }_{i} {p}_{i} \vert {ψ}_{i} {ψ}_{i} \vert = ( 0.9 ) \vert {E}_{1} {W W}_{} {E}_{1} \vert + ( 0.1 ) \vert {E}_{1} {V V}_{} {E}_{1} \vert . \qquad Eq . 24$$

The pᵢ's in this case represent the relative probabilities (summing to one in order to preserve the normalization condition discussed above) that agent NA1 will apply contextualization “utility” value and “style” value, respectively. In our example the probability of agent quantum state |E₁ [symbol] _{W} is 90% (0.9) since contextualization with alternative value matrix PR_{V} and hence of |E₁ [symbol] _{V} has a likelihood of 10% (0.1). In any particular case, these probabilities are computed from the historical records about agent NA1 and may be further corroborated/vetted by the human curator.

FIG. 5E illustrates quantum state |E₁ [symbol] and its dual bra vector state [symbol] E₁|. This drawing indicates by unit vector [symbol] ₁ the “useful” eigenvector in the most commonly adopted contextualization of “utility” value expressed by value matrix PR_{w}. The drawing further shows by unit vector [symbol] ₁ the “stylish” eigenvector in the alternative contextualization of “style” value. Per our quantum representation we postulate that at the time agent NA1's quantum state |E₁ [symbol] is measured and collapses to either of these two eigenvectors the corresponding eigenvalue manifests. Specifically, collapse of |E₁ [symbol] to |sv₁ [symbol] will coincide with agent NA1 manifesting λ₁=“YES” meaning “yes car 330A is useful”. The collapse of |E₁ [symbol] to |αv₁ [symbol] will coincide with agent NA1 manifesting λ₁=“YES” meaning “yes car 330A is stylish”. Also in agreement with the quantum cognition model, the probability of collapse will start at zero at initial time tₒ and will keep increasing for as long as the proposition about car 330A is being apprehended by agent NA1.

Eigenvectors [symbol] ₂, [symbol] ₂ representing the state |E₁ [symbol] of agent NA1 at the moment of measuring eigenvalues λ₂=“NO” for “no car 330A is not useful” and λ₂=“NO” for “no car 330A is not stylish” are omitted for reasons of clarity. Also note that in the case of the mixture discussed above, agent NA1 is only expected to have its quantum state |E₁ [symbol] be one of eigenvectors [symbol] ₁ and [symbol] ₁. Differently put, agent NA1 is expected to be in one of the “YES”-eigenstates, but we do not know (based on a classical probability for relative probabilities in the mixture) which one. In other words, we have 90/10 chances for agent NA1 adopting the “utility” value or “style” value contextualization modulo the proposition about car 330A. In either case, agent NA1 is expected to yield the measurable indication “YES”.

Since the reader will already intuit in their own capacity as curator of human experience that it is hard to judge the same car 330A in contextualizations based on “utility” value and based on “style” value simultaneously, we expect that matrices PR_{w} and PRᵥ will not commute. As a result, the fact that eigenvectors [symbol] ₁ and [symbol] ₁ are not aligned is not surprising. In practice, the relative orientation of these eigenvectors should be confirmed not just by the human curator but also by reviewing large numbers of measurements and deploying the rules of commutator algebra well known to those skilled in the art.

The expectation value of agent's NA1 judgment of car 330A in the “utility” value basis (measured by applying value matrix PR_{w}) is obtained by taking the regular prescription. That prescription involves ket state |E₁ [symbol] , its complex conjugated dual bra state [symbol] E₁| and value matrix PR_{w}. Similarly, we can also obtain the expectation value of agent's NA1 judgment of car 330A in the “style” value basis (measured by applying alternative value matrix PRᵥ). The same prescription holds and calls for agent's ket state |E₁ [symbol] , its bra state [symbol] E₁| and now alternative value matrix PRᵥ instead of value matrix PR_{w}.

Just from a cautious geometrical intuition built from examining FIG. 5E, we see that these expectation values will be very different. We state this fact more formally by using the expectation value formula explicitly as follows:

$${E}_{1} \vert P {R}_{w} \vert {E}_{1} \neq {E}_{1} \vert P {R}_{v} \vert {E}_{1} , or \qquad Eq . 25$$

$${PR}_{w} {\vert E 1}_{} \neq {PR}_{v} {\vert E 1}_{} .$$

In practice, the range of expectation value (given our +1 and −1 eigenvalues) will be between +1 and −1. From a simple visual inspection of the geometry (the reader is yet again cautioned that FIG. 5E is a Bloch-related representation) we see the projection for [symbol] PR_{w} [symbol] _{|E1} [symbol] to be close to about 0.75, while [symbol] PRᵥ [symbol] _{|E1} [symbol] appears to be close to about 0.1.

In FIG. 5E agent NA1 is indicated with internal state IS1 and their internal complex-conjugated state IS1*. Both the state and its complex-conjugate are about car 330A that represents what the proposition is about. In a sense, these two states are “reflections” of each other that arise due to the complex conjugation. We thus posit agent NA1 and a “mirror image” of agent NA1 namely agent NA1*. Agent NA1* can be thought of as the same agent NA1 after some amount of evolution. Agent NA1* can also be thought of as a completely different agent that currently contextualizes car 330A but whose ket state (the non complex-conjugated state) is represented by internal state IS1*. In other words, the |notional [symbol] state or ket state of agent NA1* is in fact the bra state or the [symbol] counter-notional| state of agent NA1.

This “flipping” between bras and kets can be understood as a change of mind about car 330A from the point of view of a “party” represented by agent NA1 to the point of view of a “counter-party” represented by agent NA1*. In the vernacular, such opposite thinking about the same underlying proposition may express itself as: 1) “yes the car is useful to me” and 2) “yes the car is useful to others”. Differently put, this pair of complex-conjugate internal states can be associated with a “party” and a “counter-party” mentality. They both certainly “see eye to eye”. They also agree on judging car 330A in the same contextualization of “utility” value but still are distinct in the sense that may act as a “supplier” of car 330A and the other like a “user” of car 330A.

FIG. 5F summarizes what Quantum Processing Unit 322 provides as output of the basic application of the quantum cognition model where agents NA1, NA2, NA3, NA4 are considered in isolation. More precisely, in the basic application of the quantum cognition model agents NA1, NA2, NA3, NA4 do not interact with each other and make their choices independently of each other as they each adopt their own contextualizations of the proposition modulo car 330A. Their contextualizations are known. Further, quantum states |E₁ [symbol] , |E₂ [symbol] , |E₃ [symbol] , |E₄ [symbol] of agents NA1, NA2, NA3, NA4 in their known contextualizations can be well estimated because their initial measurable indications are also known. Preferably, these known measurable indications modulo the proposition were recently collected from each agent NA1, NA2, NA3, NA4 independently. Note that although the measurable indications are known, they are not necessarily the same. Being fresh, however, they allow one to set the estimates of the quantum states to be the eigenvectors of the corresponding value matrix that is the quantum cognition representation of the correspondent contextualization of the proposition. The known measurable indications, of course, belong to the set of all possible measurable indications that are the eigenvalues of the agent value matrix.

A final output 600 of Quantum Processing Unit 322 is thus obtained under the application of the basic quantum cognition model 602. Output 600 consists of expectation values computed according to the above teachings for each agent NA1, NA2, NA3, NA4. These expectation values can be sent back to Central Processing Unit 308 via bus 312 (see FIG. 3B) as the output of Quantum Processing Unit 322. Output 600 is useful to a final user who is attempting to estimate what agents NA1, NA2, NA3, NA4 will do when presented with analogous propositions in the future. Of course, these estimations will hold only under the assumptions of the basic quantum cognition model. In other words, agents NA1, NA2, NA3, NA4 are completely independent and no interactions between them are taken into account.

III. Advanced Quantum Cognition Model—Applications with Entanglement

The basic quantum cognition model explained in section II leaves out interaction effects. These effects are usually present and, in many cases, will override choices that any one of market agents N would make independently. In other words, interaction effects can render estimates obtained with the basic quantum cognition model of limited practical use.

To deal with interaction effects the quantum cognition model has to take into account more complicated quantum states, specifically entangled quantum states. Entangled states are created by interactions, and more specifically by social interactions. The social interactions that produce entanglement, in close analogy to those in physics proper (where symmetry-preserving interactions produce entangled states), occur between agents N at times prior to their making of choices about any given proposition.

To understand entangled states the quantum cognition model relies on the F-D anti-consensus and B-E consensus statistics of agents N modulo the proposition. These statistics were introduced in the prior section II, but they were not used in the basic quantum cognition model addressed in that section because interactions and entangled states were not taken into account in the basic quantum cognition model.

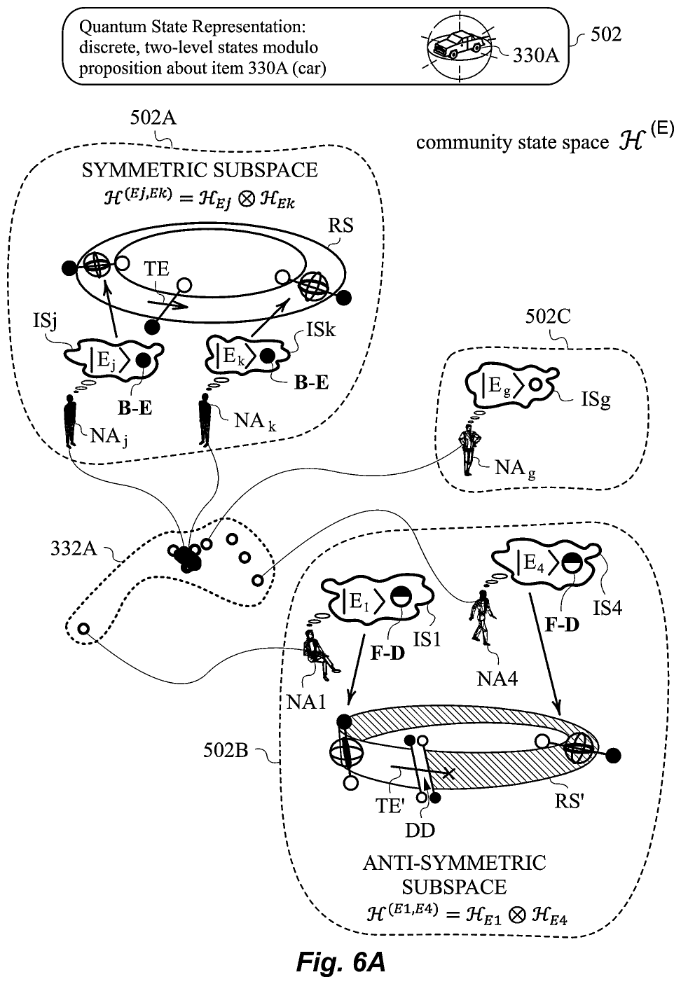

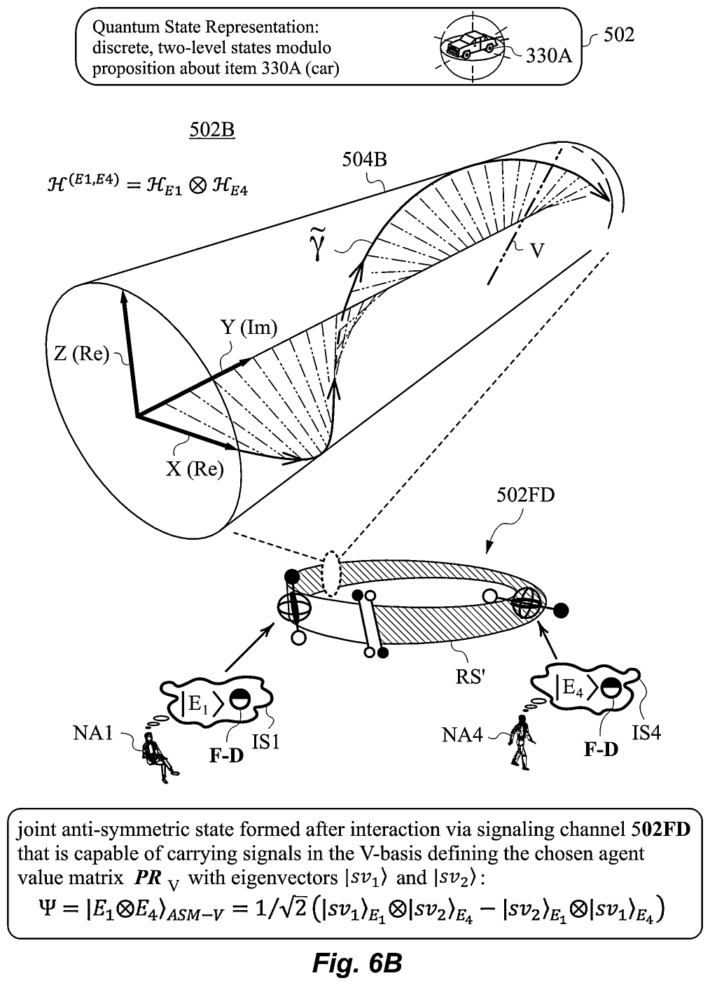

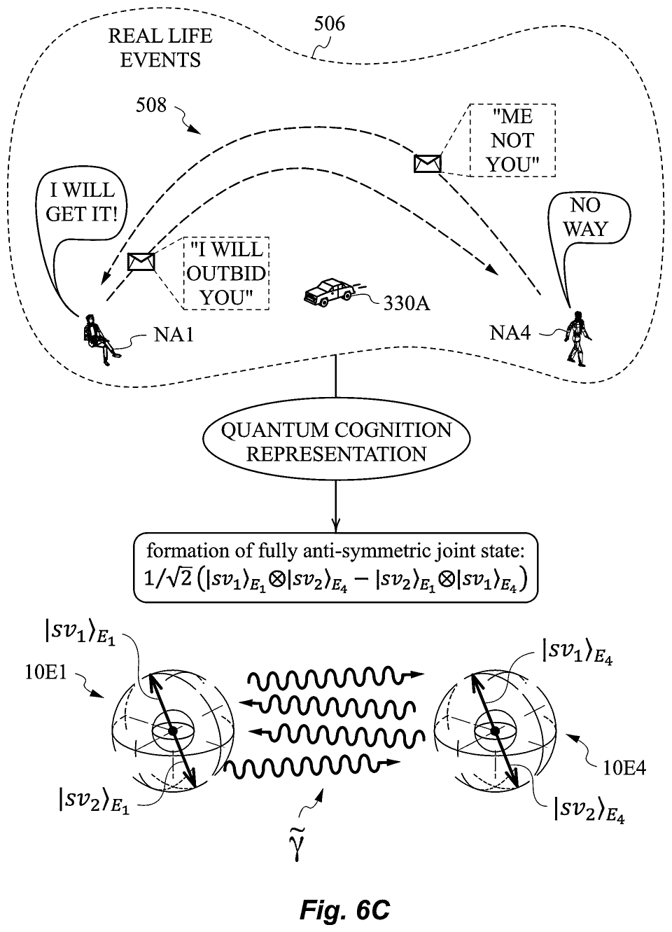

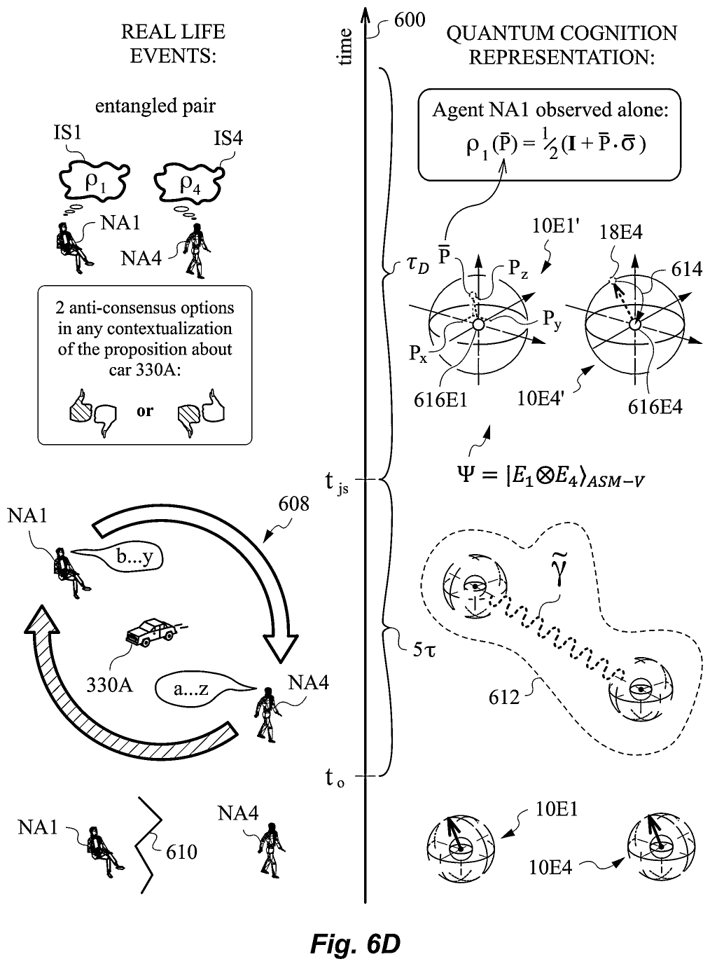

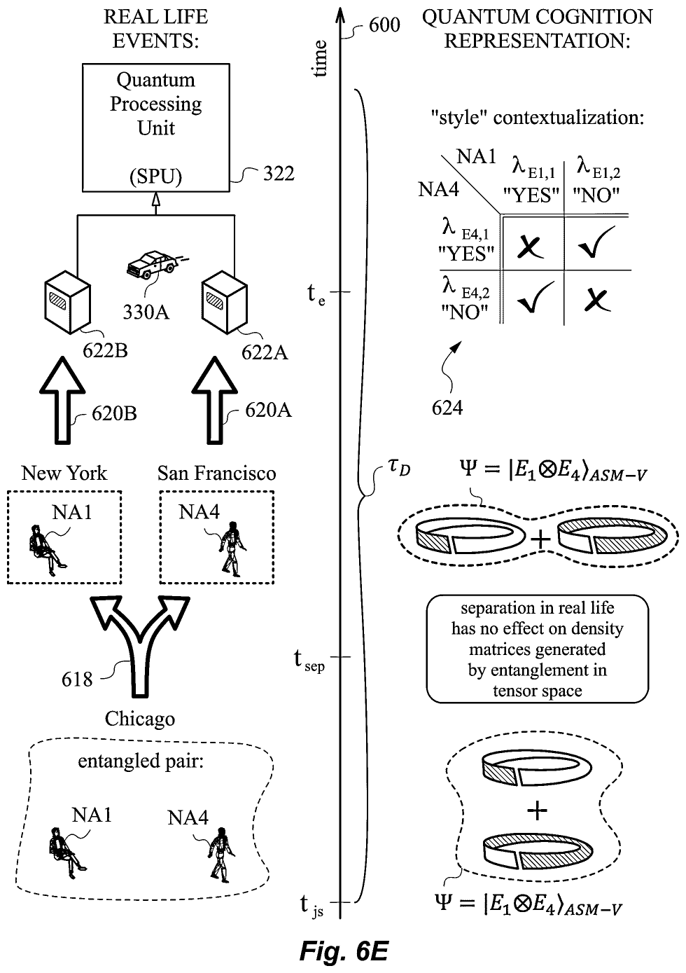

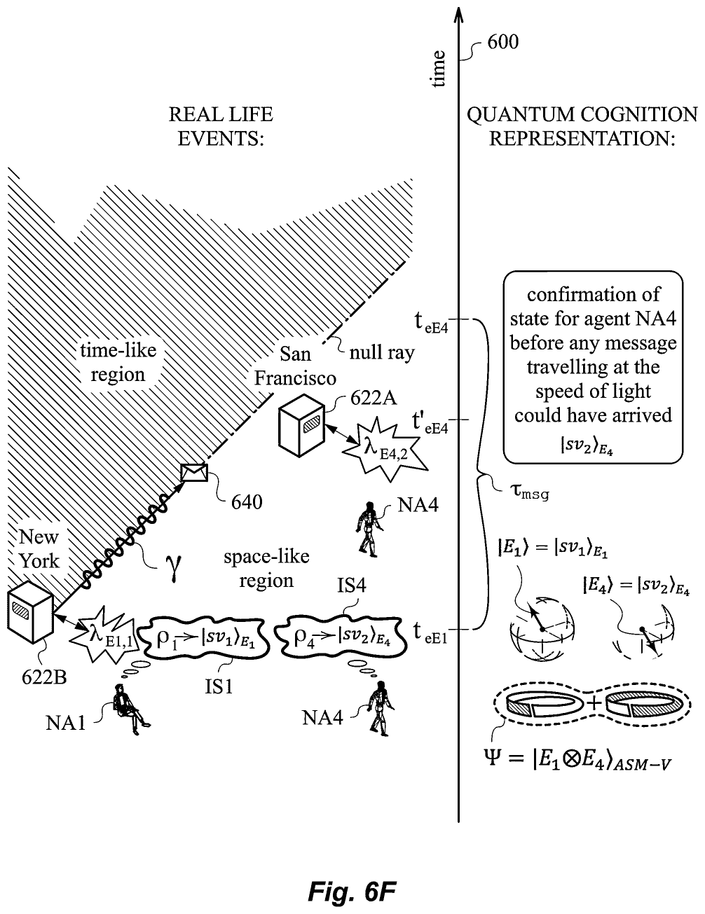

FIG. 6A is a diagram that will be used to explain a simple case of entanglement among just two agents, also known as pairwise entanglement. Pairwise entanglement captures the essence of this quantum phenomenon while remaining mathematically tractable and providing significant insight into more complicated entangled states. Specifically, we examine a mutual interdependence that may exist between agents upon their prior entanglement. The entanglement may have been produced in the past by a joint confrontation with the proposition or by joint confrontation with a different proposition.

The diagram of FIG. 6A focuses on a number of agents to illustrate the fundamental concepts. The pair of agents NA1, NA4 belonging to subgroup or segment 332A already introduced above exhibit F-D anti-consensus statistics. In other words, they obey the Pauli Exclusion Principle. Still differently put, agents NA1, NA4 behave “like electrons” with respect to the proposition about car 330A within overall context 502.

Meanwhile, agents NAj, NAk exhibit B-E consensus statistics. In other words, they agree since they are not subject to the Pauli Exclusion Principle. Differently put, agents NAj, NAk behave “like photons” with respect to the proposition about car 330A within overall context 502.

In contrast to the above agent pairs, agent NAg is not subject to any type of entanglement because it does not interact with any other agents. Differently put, agent NAg acts like a completely independent individual that does not take any others into account in their decision making about car 330A within overall context 502. Note that the basic quantum cognition model from section II is sufficient to describe the non-interacting agent NAg and compute the most likely actions/choices (expectation values) modulo car 330A that agent NAg will exhibit in the quantum cognition model.

We will now discuss the above three cases in considerably more detail. As a precondition, agents NA1, NA4, NAj, NAk and NAg under consideration are embedded in context space 502. As already outlined above, context space 502 is a higher-dimensional space in which internal states IS1, IS4, ISj, ISk and ISg of corresponding agents NA1, NA4, NAj, NAk and NAg are embedded. Context space 502 is a state space [symbol] ^{(E)} that may be a community values space. What is important is that context space 502 support certain inner states to be joined in the form of joint or entangled agent states, while allowing other states to be separate. Differently put, context space 502 has the ability to act as a type of “insulator” between inner states IS that do not enter into joint or entangled agent states while maintaining others as joint or entangled agent states.

In the example of FIG. 6A a first pair of agents, namely agents NAj, NAk are identified as B-E consensus type. Their internal states ISj, ISk are assigned to individual quantum states |Eⱼ [symbol] , |Eₖ [symbol] prior to the formation of their joint or entangled state. More specifically, the pair of agents NAj, NAk have quantum states |Eⱼ [symbol] , |Eₖ [symbol] that are contained in subspace 502A of context space 502.

A second pair of agents NA1, NA4 are both F-D anti-consensus type and their internal states IS1, IS4 are assigned to quantum states |E₁ [symbol] , |E₄ [symbol] prior to the formation of the joint or entangled state. Quantum states |E₁ [symbol] , |E₄ [symbol] inhabit subspace 502B that is insulated from subspace 502A of context space 502.

Market agent NAg does not interact with any other market agent (not with any of agents NA1, NA4, NAj, NAk nor with any other agent found among available agents in group or segment 332A). Hence, quantum state |E_{g} [symbol] is shown fully insulated from the others within his or her own subspace 502C of context space 502. Since quantum state |E_{g} [symbol] remains insulated in its subspace 502C it can be treated individually or separately. More strictly speaking, quantum state |E_{g} [symbol] is separable from others. Such state does not require us to account for its consensus statistic and may be described in simple terms as already presented above in section II.

The advanced quantum cognition model in this section is no longer concerned with single and insulated quantum states that can be considered independently of each other. Such states, also commonly referred to as separable states, do not enter into any joint states and hence do not entangle. Of course, it is crucial to remember that in the case of agent NAg this applies in contextualization of the proposition about car 330A within context space 502. Agent NAg may be subject to entanglement with other agents modulo entirely different propositions (potentially with respect to propositions about certain other items).

We now turn our attention back to pairs of agents NAj, NAk and NA1, NA4. These pairs exhibit different consensus statistics and they can entangle. In other words, they can form joint quantum states that are not separable. Their quantum cognition representation is kept simple because both pairs of agents NAj, NAk and NA1, NA4 when under measurement precipitate as discrete, two-level states modulo the proposition about car 330A.

We first turn to the B-E consensus type pair of agents NAj, NAk. A Riemann surface RS serves as a visualization aid to illustrate the importance of the B-E consensus statistic on the example of agent pair NAj, NAk. Specifically, the way in which agents NAj, NAk apprehend the proposition in their internal spaces ISj, ISk is encoded per our quantum cognition representation in quantum states |Eⱼ [symbol] , |Eₖ [symbol] as assigned by Quantum Processing Unit 322 along with their consensus types used during formal quantum state creation. In contrast to cases considered in section II, agents NAj, NAk are now aware of each other confronting the proposition and thus their consensus type becomes crucial if they indeed entangle. Because of their B-E consensus statistics their joint quantum state in the event of entanglement will be symmetric.

Formation of entangled or mutually interdependent state between agents is not certain. That is because it cannot be foreseen for sure that any particular agents will indeed interact. However, interaction can be promoted by suitable choice of item that the proposition is about. If agents care about the chosen item then the probability of interaction is increased due to their common interest. As noted above, the item at the core of the proposition is usually selected from among goods, services and experiences, as well as any combination of one or more of these. Again, a range of exemplary items about which propositions can be formed are contained in inventory of items 330 (see, e.g., FIG. 5A). To further promote the probability of formation of entangled or joint states Quantum Processing Unit 322 can select items that may be scarce, limited, unique, constrained, desirable or that have features and/or attributes or qualities that make them appear as being in short supply or otherwise limited to the agents.

Formation of interdependency modulo the proposition about specific car 330A is made more probable by the very nature of the proposition. Namely, only one specific car 330A at the core of the proposition is for sale and thus only one agent can buy it. In other words, this is a situation where the resource constraint of the proposition imposed by the availability to agents NAj, NAk of just a single car 330A may increase the probability of developing interdependency. Preferably, the human curator is involved in ascertaining that agents of pair NAj, NAk are truly interested in the proposition to buy car 330A. In other words, car 330A registers as a desirable resource in internal spaces ISj, ISk of agents NAj, NAk and both are seriously interested in buying it.

Of course, it is possible that agents NAj, NAk are already entangled before being confronted with the proposition about car 330A. The entanglement could have been produced during a prior interaction between agents NAj, NAk modulo some other proposition (this is analogous to a past symmetry preserving interaction between quantum entities).

In order for the advanced quantum cognition model to run reliably it is important that entanglement between agents NAj, NAk be ascertained with a high degree of confidence. Thus, Quantum Processing Unit 322 should have data corroborating both the B-E consensus statistic modulo the proposition and existence of entanglement. Such data can be obtained for any two agents, e.g., agents NAj, NAk form data files documenting any prior communications between the agents and any corroboration from human curator.

Exemplary corroborative data can indicate that agents NAj, NAk exhibit conscious agreement or consensus when considering specific car 330A in the same contextualization while aware of each other.

For example, they both judge specific car 330A in the contextualization of “utility”. Moreover, each one of them judges car 330A to be a “YES” or a “NO” in that known contextualization (the a being the “YES” measurable indication and the b being the “NO” measurable indication). This consensus correlation suggests that entanglement is likely to exist. Furthermore, because of B-E consensus there is a lack of strife with respect to each other over car 330A. In other words, B-E consensus type agents do not adopt adversarial positions.

In practice, it may be difficult to discern that agents NAj, NAk are inclined to produce such cooperative or symmetric state modulo the proposition about the exact same car 330A from data files and communications found in data traffic and within social networks in which agents NAj, NAk are active. This is why Quantum Processing Unit 322 has to review data files as well as communications of agents NAj, NAk containing indications exhibited in situations where both were present and modulo propositions as close as possible to the proposition about specific car 330A. The prevalence of “big data” as well as “thick data” that agents produce in self-reports is very useful in this task. Furthermore, the human curator that understands the lives of both agents NAj, NAk should review and approve the proposed B-E consensus statistic for each agent modulo the proposition about car 330A.

The involvement of the curator is especially important when dealing with general “big data” (i.e., typical associative data put together by crawlers operating without any general instructions). Repositories of such general “big data” have become a virtual garbage dump. The relationships between such data and agents are either tenuous or even non-existent. For example, the reader is reminded here of a typical set of images for a person found on a large search engine. The hundreds of images displayed in association with that person frequently do not even include the image of the person in question. However, they may include images that likely have little or nothing to do with that person and even less with clues about contextualizations of propositions either alone or jointly with others. Swaths of such low-quality “big data” are potentially meaningless, useless or worse without the oversight of the human curator.

A person skilled in the art will note that any proposition that generates constraints such as limited availability, perceived status, perceived desirability, exclusivity, necessity for survival, necessity for fulfillment and/or any other mechanisms is likely to require joint agent states. More specifically, when limited resource or other limiting constraints generate conditions under which bidding, competition, strife and/or other similar group dynamics among agents can manifest they produce a situation in which the quantum representation of agents is likely to require a joint state. The joint state of B-E consensus type agents will reflect their ability to share the limited resource here being the item embodied by specific car 330A at the core of the proposition. In other words, joint states among B-E consensus agents admit of joint state solutions in which the pair of agents NAj, NAk finds a way to share the scarce resource at the center of the proposition.

In our exemplary case agents NAj, NAk are genuinely interested in the proposition to buy specific car 330A. Moreover, they are confirmed to exhibit the B-E consensus dynamic modulo the proposition about buying specific car 330A. Again, the B-E consensus statistic is explicitly indicated for agents NAj, NAk along with their quantum states |Eⱼ [symbol] , |Eₖ [symbol] in FIG. 6A.

To consider quantum states |Eⱼ [symbol] , |Eₖ [symbol] jointly we need to introduce a tensor space [symbol] ^{(Ej,Ek)}= [symbol] _{Ej}⊗ [symbol] _{Ek} that can hold any joint state that this pair of consensus type agents NAj, NAk may yield. In other words, any tensor state |Eⱼ [symbol] ⊗|Eₖ [symbol] that is among agents NAj, NAk modulo the proposition has to be in tensor space [symbol] ^{(Ej,Ek)}.

Knowledge of consensus statistics B-E among pair of agents NAj, NAk modulo the proposition tells us something upfront. Namely, whatever joint state obtains it must be symmetric according to the physical principles behind the quantum cognition representation adopted herein. Thus, components of any legitimate joint state Φ=|Eⱼ [symbol] ⊗|Eₖ [symbol] for B-E consensus market agent pair NAj, NAk will interchange with a “+” sign. Differently put, the symmetric joint state we are looking for has to be in the symmetric subspace of [symbol] ^{(Ej,Ek)}. That is because permissible joint states given B-E consensus statistics can also be thought of as confined to unitary evolution on Riemann surface RS. Surface RS is “flat” meaning that it has no twists or obstructions that would produce a flip or sign change in a state confined to unitary evolution along surface RS. All quantum states evolving along RS will do so without flipping. For better visualization, the lack of impediment in evolution along this orbit due to the absence of flipping is indicated by arrow TE in FIG. 6A. Do note, however, that the illustrations of Riemann Surface RS and quantum states in FIG. 6A are to be treated as pedagogical visual aids to understanding rather than actual depiction of Hilbert Space and quantum states.

For still better visualization, the lack of any flip is indicated by the black and white dots that “travel” with the quantum mechanical state representations visualized by “balls” as they evolve in a unitary manner along Riemann surface RS. There is clearly no impediment to the co-existence of quantum states |Eⱼ [symbol] , |Eₖ [symbol] in the symmetric subspace [symbol] ^{(Ej,Ek)} of Hilbert space if they were to “roll over each other” and occupy the same quantum state somewhere along surface RS vis-à-vis the proposition about specific car 330A. Notably, in such symmetric joint state two agents NAj, NAk in the pair could even attempt to agree on using the same car 330A.

The general expression for a symmetric joint state is denoted by Φ for agents NAj, NAk. The states or vector components associating to these individual agents NAj, NAk are tracked by corresponding subscripts. As already hinted at above, a person skilled in the art will be aware that we are treating agents as “indistinguishable” particles at this point in our quantum cognition representation. The tensor space is based on the W-basis decomposition for each agent per “utility” contextualization. Just to repeat, this is because of the known use of agent value matrix PR_{W} by both agents NAj, NAk in contextualizing the proposition about specific car 330A in terms of “utility”. The known contextualization in the case of each one of agents NAj, NAk has two eigenvalues corresponding to measurable indications “YES” and “NO”.

The joint state inhabits tensor space [symbol] ^{(Ej,Ek)} or rather its symmetric subspace, as indicated in FIG. 6A. We use subscript SYM-W to remind ourselves of the fact that the space is a symmetric tensor space. In other words, the symmetric joint state between agents NAj, NAk takes on the general form expressed by Φ=|Eⱼ [symbol] ⊗|Eₖ [symbol] =|Eⱼ⊗Eₖ [symbol] _{SYM-W}. The SYM-W subscript can also be used on the complex coefficients alpha and beta to remind us that they are used in this decomposition of a symmetric joint quantum state.

The measurable indications collected in collapsing or measuring the symmetric joint state will come in pairs. All possibilities will be covered with measurable indication pairs including: “YES”, “YES”; “YES”, “NO”; “NO”, “YES” and “NO”, “NO” for agents NAj, NAk, respectively. Recall, however, that due to the indistinguishable nature of quantum states in the quantum cognition representation adopted herein, it is not possible to label which state corresponds to which agent prior to measurement. Also, prior to entering the joint state the individual measurable indications for each agent are known. In other words, we know or can at the very least estimate from history and/or any other available data as discussed above, the measurable indications of agents NAj, NAk while still individuated. Since data modulo specific car 330A is likely unavailable (unless both agents NAj, NAk, while not yet knowing that they are both potential buyers of specific car 330A expressed their measurable indications online or in real life and Quantum Processing Unit 322 managed to collect these indications). In most cases data including opinions and even, if available, measured indications generated by agents NAj, NAk about comparable cars can be used.

We now review the quantum representation of a specific symmetric joint state |Eⱼ⊗Eₖ [symbol] _{SYM-W} that pair of agents NAj, NAk contextualizing in terms of “utility” can assume. This symmetric joint state is spectrally decomposed in eigenvectors |sv₁ [symbol] and |sv₂ [symbol] of agent value matrix PR_{W} for each agent. The superposition is expressed as:

$$Φ = \vert {E}_{j} ⊗ {E}_{k} {SYM - W}_{} = 1 / \sqrt{2} ( \vert {sw}_{1} {{E}_{j}}_{} ⊗ \vert s {w}_{2} {{E}_{k}}_{} + \vert s {w}_{2} {{E}_{j}}_{} ⊗ \vert {sw}_{1} {{E}_{k}}_{} ) . \qquad Eq . 26$$

Note that the symmetric joint state could also be the one with the minus sign (see |ϕ^{±} [symbol] in Eq. 20a). For reasons of simplicity and clarity of explanation this expression presumes that agents NAj, NAk are confronted jointly by the proposition about buying specific car 330A. It further presumes that agents NAj, NAk are not affected in their joint state by anything other than each other and the proposition. In practical situations such entanglement may not be complete and other environmental effects leading to decoherence may need to be taken into account. However, in the present example it is presumed that pair of agents NAj, NAk are well-confined within subspace 502A and thus are not agent to interactions with any other agents regarding the proposition about specific car 330A.

Although we could now proceed to the next step on our journey to understanding entanglement with B-E consensus agents NAj, NAk in subspace 502A, we will continue dealing with them later. For now, we will focus our attention on the case of F-D anti-consensus agents NA1, NA4 in subspace 502B.

The anti-consensus agents NA1, NA4 are also jointly exposed to the proposition but the proposition is about a different specific car 330A. This condition ensures that the agent pairs are in fact insulated from each other. The reason for continuing the explanation based on F-D anti-consensus agents NA1, NA4 is due to the more complicated nature of their joint quantum state. Specifically, the joint quantum state of F-D anti-consensus agents NA1, NA4 will exhibit the Pauli Exclusion Principle. This principle does not apply to B-E consensus agents NAj, NAk.

Second pair of agents NA1, NA4 in subspace 502B are covered by context 502 generated by the proposition about car 330A. Their quantum state representation according to the present quantum cognition model is discrete and two-level modulo the proposition about car 330A. In deploying Riemann surface RS′ as a visualization aid we see the importance of the F-D anti-consensus statistic on the example of agents NA1, NA4 making up the second pair. Specifically, the way in which agents NA1, NA4 apprehend the proposition in their internal spaces IS1, IS4 is encoded per our quantum cognition representation in quantum states |E₁ [symbol] , |E₄ [symbol] as assigned by Quantum Processing Unit 322 along with their consensus types used during formal quantum state creation.

In terms of the quantum cognition representation quantum states |E₁ [symbol] , |E₄ [symbol] inhabit tensor space [symbol] ^{(E1,E4)}= [symbol] _{E1}⊗ [symbol] _{E4} that cannot support a joint state in which both are evolving without impediment on the same Riemann surface RS′. That is because a quantum state cannot exhibit unitary evolution on Riemann surface RS′ that evolves without producing a disruption due to the flip or sign change necessitated by the half-integral twist. This impediment is indicated by arrow TE′. The fact that there is an obstacle is also visually indicated by discontinuity DD in Riemann surface RS′ for states |E₁ [symbol] , |E₄ [symbol] .

The strictly pedagogical visualization of FIG. 6A is reinforced by the black and white dots that “travel” with the quantum mechanical state representations visualized by the “balls”. The dots indicate that the half-integral twist in Riemann surface RS′ prevents the two states from being identical after completing one cycle or loop in travelling along RS′. States |E₁ [symbol] , |E₄ [symbol] cannot “roll over each other” when confined to travel along surface RS′ after just a single cycle. They thus cannot occupy the same quantum state somewhere along surface RS′ vis-à-vis the proposition about car 330A without impediment. In fact, they turn into their opposites after one cycle! (In physics this corresponds to the property of spinors.) This is a fundamental structural impediment to the co-existence of agent quantum states |E₁ [symbol] , |E₄ [symbol] in tensor space [symbol] ^{(E1,E4)} while occupying the same quantum state vis-A-vis the proposition about car 330A. Their joint state cannot be symmetric under this condition. The consequence, also called the Pauli Exclusion Principle, is that agents NA1, NA4 exhibiting F-D anti-consensus statistic must occupy different states. A joint state composed of such F-D anti-consensus agents has to be anti-symmetric. This is in analogy in the present quantum cognition representation to fermions whose joint states are anti-symmetric.

We continue with our exemplary case where agents NA1, NA4 are genuinely interested in the proposition about car 330A. Their known contextualization of the proposition about car 330A concerns “style”. Moreover, they are confirmed to exhibit the F-D anti-consensus dynamic modulo the proposition about buying car 330A. The F-D anti-consensus statistic is explicitly indicated for these agents along with their quantum states |E₁ [symbol] , |E₄ [symbol] in their corresponding inner spaces IS1, IS4. To consider quantum states |E₁ [symbol] , |E₄ [symbol] jointly we introduced tensor space [symbol] ^{(E1,E4)}= [symbol] _{E1}⊗ [symbol] _{E4}. This space can hold any joint state that these two exemplary quantum states may yield. In other words, any tensor state |E₁ [symbol] ⊗|E₄ [symbol] that is among agents NA1, NA4 modulo the proposition has to be in tensor space [symbol] ^{(E1,E4)}.

Knowledge of anti-consensus statistics F-D among agents NA1, NA4 modulo the proposition tells us that whatever joint state obtains it must be anti-symmetric. Components of any legitimate joint state Ψ=|E₁ [symbol] ⊗|E₄ [symbol] for F-D anti-consensus agents NA1, NA4 will interchange with a “−” sign. An anti-symmetric joint quantum state resides in the anti-symmetric subspace of [symbol] ^{(E1,E4)}.

Again, it may be difficult to discern such competitive dynamic among agents NA1, NA4 modulo underlying proposition about car 330A or the need for an anti-symmetric joint state from data files and communications found in traffic propagating via any network or within a social network. Therefore, Quantum Processing Unit 322 has to review data files as well as any communications originated by and/or passed between agents NA1, NA4 and containing indications exhibited in situations where both were present and were confronted by propositions as close as possible to the proposition about car 330A. The prevalence of “big data” as well as “thick data” that agents produce in self-reports is again very helpful. Still, the human curator who understands the lives of both agents NA1, NA4 should preferably exercise their intuition in reviewing and approving the proposed F-D anti-consensus statistic for each agent modulo the proposition about car 330A in view of some limitations developing in “big data”, as mentioned above.

The joint state available to F-D anti-consensus agents NA1, NA4 inhabits anti-symmetric subspace of tensor space [symbol] ^{(E1,E4)} and we will use subscript ASM-V to remind ourselves of this fact. In other words, the anti-symmetric joint quantum state between agents NA1, NA4 takes on the general form expressed by Ψ=|E₁ [symbol] ⊗|E₄ [symbol] =|E₁⊗E₄ [symbol] _{ASM-V}. The ASM-V subscript is also used on the complex coefficients alpha and beta to remind us that they are used in this decomposition of the anti-symmetric joint quantum state. The tensor space is based on the V-basis decomposition for each agent per “style” contextualization. This is because of the known use of agent value matrix PR_{V} by both agents NA1, NA4 in contextualizing the proposition about car 330A in terms of “style”. The known contextualization in the case of each one of agents NA1, NA4 has two possible eigenvalues λ₁, λ₂ corresponding to measurable indications “YES” and “NO”.

Given this, the full anti-symmetric joint state |E₁⊗E₄ [symbol] _{ASM-V} of agents NA1, NA4 contextualizing the proposition in terms of “style” of car 330A can be decomposed in eigenvectors |sv₁ [symbol] and |sv₂ [symbol] . These are the eigenvectors of agent value matrix PR_{V} for each agent. The superposition is expressed as:

$$Ψ = \vert {E}_{1} ⊗ {E}_{4} {A S M - V}_{} = 1 / \sqrt{2} ( \vert s {v}_{1} {{E}_{1}}_{} ⊗ \vert s {v}_{2} {{E}_{4}}_{} - \vert s {v}_{2} {{E}_{1}}_{} ⊗ \vert {sv}_{1} {{E}_{4}}_{} ) . \qquad Eq . 27$$

Again, note that the anti-symmetric joint state could also be the one with the plus sign (see |ψ^{±} [symbol] in Eq. 20b). Of course, this expression presumes that agents NA1, NA4 are the only two that are confronted jointly by the proposition about buying car 330A and agents NA1, NA4 are not affected in their joint state by anything other than each other and the proposition. As in the case of B-E consensus agents discussed previously, such entanglement may not be complete and other environmental effects (decoherence) may need to be taken into account. In the present example, agents NA1, NA4 are taken to entangle with negligible environmental influences.

We now turn to FIG. 6B to examine the process of entanglement that leads to the anti-symmetric joint quantum state expressed in Eq. 27. This drawing figure illustrates the inside of subspace 502B only. We again remind ourselves of context 502 covering agents NA1, NA4 in subspace 502B being due to the proposition about car 330A in particular.

FIG. 6B introduces a signaling channel 502FD whose aspect admitting of illustration corresponds to Riemann surface RS′. Signaling channel 502FD spans subspace 502B that is more rigorously defined by the anti-symmetric portion of tensor space [symbol] ^{(E1,E4)}. A small portion 504B of channel 502FD is shown in an exploded form to afford a closer examination. Channel 502FD may be considered as the communication link. In embodiments where agents are placed on vertices of a graph, e.g., graph 332 (e.g., see FIG. 3A) channel 502FD stands for the link or edge that connects the vertices or nodes to which agents NA1, NA4 are assigned.

For purposes of present explanation, channel portion 504B is expanded into three dimensions (3-dimensional space or [symbol] ³). These stand for those previously introduced for Bloch Sphere 10 in FIG. 4A. We thus have the X, Y, Z axes. Of these the X and Z axes correspond to real axes and are thus additionally labeled Re. Meanwhile, the Y axis corresponds to the imaginary axis and is additionally labeled by Im. The reader is cautioned that the standard SU(2) representation of spinors on which our explanation is based double-covers the Bloch Sphere shown in [symbol] ³. Thus, the illustration should be considered for visualization and pedagogical aid purposes only. Those skilled in the art will recall that the imaginary axis, here the Y axis extending along channel portion 504B, may be thought of as the time axis (see also Wick rotation where time is allowed to extend along the imaginary axis).

Signaling channel 502FD defines a space traversed by signals or messages that allow agents NA1, NA4 to interact. It is important to realize that any medium that carries information between agents NA1, NA4 can support signaling channel 502FD. In preferred embodiments of the present invention signaling channel 502FD is a corresponding portion of any communication network that supports signaling between agents NA1, NA4. Still differently put, channel 502FD is traversed by messages that are passed between agents NA1, NA4. Indeed, the signaling can also happen directly (live agent-to-agent communication) without any digital intermediation at all.

There is an analogy between messages or signals exchanged by agents NA1, NA4 and the gauge boson that mediates the field between field quanta. In the cases discussed so far the QFT (Quantum Field Theory) of choice for explanatory purposes has been QED (Quantum Electrodynamics). In this field theory the gauge is mediated by the photon γ. The photon γ in its role as gauge boson is described by the Abelian U(1) symmetry at every point along its space-time trajectory (see also null ray). U(1) symmetry permits the photon γ to assume standard observed polarizations. The two basis states of the photon γ are conveniently set to right-handed and left-handed polarizations. Other observed polarizations, such as the often-discussed linear polarization, are built up of combinations of these two basis states. The diligent reader is referred to standard texts on Quantum Field Theory mentioned in the Background Section for a more thorough treatment of the photon including its deeper significance as mediator of the gauge field under the QED Lagrangian as well as the non-physical states assumed by virtual photons. Also, the reader is reminded that the drawing is merely an explanation aid and not to be taken to actually represent a photon.

From the physics inspiration to our quantum cognition representation we draw an analogy between the photon γ as mediator between field quanta, to the signal in signaling channel 502FD as mediator between agents NA1, NA4. In particular, we see in the exploded portion 504B of channel 502FD a message or signal designated by the reference \tilde{γ}. This choice of reference is clearly inspired by the analogy to the photon γ. Message or signal \tilde{γ}, which in accordance to the gauge freedom can mediate any allowable state is shown to propagate along imaginary axis Y of FIG. 6B. In fact, in this figure signal \tilde{γ} is reminiscent of a right-handed photon. Again, the reader is reminded that the drawing is merely an explanation aid and not to be taken to actually represent a photon.

Of course, as remarked, this analogy to the physics model is used to interpret signaling, rather than to set forth a formal characterization thereof (e.g., formal determination of the permissible gauge freedom and dimensionality associated with mediation between agents NA1, NA4). What is important, however, is that signal \tilde{γ} traces components corresponding to the V-basis laid down by agent value matrix PR_{V} expressing the “style” contextualization. In other words, signal \tilde{γ} can mediate between agents NA1, NA4 whose internal states IS1, IS4 are assigned quantum states |E₁ [symbol] , |E₄ [symbol] that are eigenvectors |sv₁ [symbol] , |sv₂ [symbol] of agent value matrix PR_{V}.

In FIG. 6B the capacity of mediation between agents NA1, NA4 that contextualize in the V-basis via signal \tilde{γ} is indicated by its “alignment” with ray V. The reader is reminded here that the eigenvectors in the Bloch representation extend along ray V in opposite directions. Ray V is found embedded in signal \tilde{γ} in the exploded portion of signaling channel 502FD. In accordance with the physics inspired quantum cognition representation adopted herein, signal \tilde{γ} can mediate between agents choosing any value basis that is within subspace 502B. This last statement is tantamount to saying that the gauge boson that is embodied by signal \tilde{γ} can mediate all states that are permissible. A person skilled in the art will realize that this is a re-statement of the fact that the gauge freedom of a QFT is properly mediated by its gauge boson.

We now turn to FIG. 6C to review the formation of entanglement between agents NA1, NA4 that leads to the fully anti-symmetric joint state expressed with Eq. 27. Bloch spheres 10E1, 10E4 are used here in the quantum representation to stand for agent quantum states. However, they do not indicate individual quantum states |E₁ [symbol] , |E₄ [symbol] of agents NA1, NA4 as in previous basic quantum cognition model from the teachings of section II. Using pure states is no longer appropriate when describing entangled states; density matrix representation is required. Thus, Bloch spheres 10E1, 10E4 just show eigenvectors |sv₁ [symbol] , |sv₂ [symbol] _{E}_{₁} for agents NA1 and eigenvectors |sv₁ [symbol] _{E}_{₄}, |sv₂ [symbol] _{E}_{₄} for agent N4. These, of course, are the eigenvectors of the V-basis set forth by agent value matrix PR_{V} that stands for contextualization according to “style”.

Note that these same four eigenvectors |sv₁ [symbol] _{E}_{₁}, |sv₂ [symbol] _{E}_{₁}, |sv₁ [symbol] _{E}_{₄}, |sv₂ [symbol] _{E}_{₄} will be useful in forming an appropriate basis for the anti-symmetric portion of tensor space [symbol] ^{(E1,E4)} that contains any admissible joint agent state involving agents NA1, NA4. Therefore, the density matrix representation of the entangled state is arrived at by starting with these eigenvectors.

The top portion of FIG. 6C illustrates a representative sample of possible real-life interactions and more generally signals between agents NA1, NA4 over the proposition about car 330A. These messages or signals are contained in the real-life events portion of FIG. 6C within the dashed outline 506. The messages, signals and interactions may include in person as well as online events. In general, they can include exchanges of signals or messages in spoken, written and/or any other communicable form(s) (e.g., by proxies of understanding and/or signs) between agents NA1, NA4. Overall, the exchange may include conversation(s), monologue(s), unidirectional and/or bidirectional signaling that is direct and indirect in nature. For example, a threat issued or relayed via a third agent is considered communication that is indirect in nature. The reference 508 generally indicates any permissible collection of messages or signals up to and including conversation(s) and richer exchanges between agents NA1, NA4.

The quantum representation of real-life events within outline 506 are indicated in the lower portion of FIG. 6C. Here we see interaction 508 being translated into an exchange of messages or signals \tilde{γ} already introduced above. In physics proper, photon exchange corresponds to the interaction mechanism between the field quanta in QED, e.g., electrons. This exchange can lead to the formation of a joint state. Interaction via the gauge field also requires a certain fundamentally indeterminate amount of time to occur with some given probability. This indeterminate time, just as many other quantities in quantum mechanics, is not a classically computable quantity.

An effective way to treat time is as a parameter that relates to a transition probability. The transition we are interested in is from separable quantum states |E₁ [symbol] , |E₄ [symbol] expressing known contextualizations and measurable indications when agents NA1, NA4 were on their own and not influencing each other, to the joint agent state Ψ=|E₁⊗E₄ [symbol] _{ASM-V} as expressed by Eq. 27. The concept we will use herein is that of a half-life τ. With the transpiration of each half-life τ that agents are jointly exposed to the proposition about car 330A the probability of formation of the joint agent state we are interested in increases. Equivalently, the likelihood of no exchange of message or signal \tilde{γ} decreases by 1/e (where e is Euler's number that is irrational and approximately equal to 2.71828) after each half-life τ. Although no time is indicated in the quantum cognition representation of FIG. 6C, the practitioner is advised to ensure that at least a few half-lives τ be allowed to transpire in order to form the desired joint agent state between agents NA1, NA4.

We now consult the diagram of FIG. 6D to track the formation of an entangled state between agents NA1, NA4 in more detail. In the present example the entangled state is embodied by joint agent state Ψ of Eq. 27. This figure illustrates real life events involving agents NA1, NA4 and salient aspects of their quantum cognition representation. The quantum cognition representation is shown on the right of a time line 600. Real life events involving agents NA1, NA4 are shown on the left of time line 600. By laying out the diagram in this manner, real life events and the quantum cognition representation are thus temporally synchronized and provide a more coherent and pedagogical visualization tool. Time increases in the up direction.

Recall that prior to entering or forming the joint agent state Ψ the contextualization and the individual measurable indications for each agent NA1, NA4 are known. More precisely, Quantum Processing Unit 322 can at the very least estimate from history and/or any other available data as discussed above, the measurable indications of agents NA1, NA4 while still individuated. The time when agents NA1, NA4 are individuated and not yet jointly confronted by the proposition is prior to an initial time tₒ as shown at the bottom of time line 600. A separator 610 is used on the real-life side of time line 600 to visually remind us of the independent nature of agents NA1, NA4 before time tₒ. Meanwhile, on the quantum cognition representation side right of time line 600 the known and separable quantum states |E₁ [symbol] , |E₄ [symbol] are designated with the aid of corresponding Bloch spheres 10E1, 10E4.

We note that before initial time tₒ both separable quantum states |E₁ [symbol] , |E₄ [symbol] are reasonably pure and correspond to eigenvector |sv₁ [symbol] of the V-basis laid down by value matrix PR_{V} denoting contextualization by “style”. In other words, both agents NA1, NA4 are in an inner state that can be represented by eigenvector |sv₁ [symbol] according to which the agent considers car 330A to be stylish (a measurement would yield the corresponding eigenvalue “YES” for “style”). In other words, we have |E₁ [symbol] _{V}=|sv₁ [symbol] _{E}_{₁} and |E₄ [symbol] _{V}=|sv₁ [symbol] _{E}_{₄}. Thus far, this is the basic quantum cognition representation from section II.

Joint exposure to the proposition commences at initial time tₒ. At this initial time tₒ agents NA1, NA4 are placed under conditions in which they realize that they are both confronting the underlying proposition about car 330A. At this point in time, both agents NA1, NA4 are still most likely using their known contextualization of “style”.

Their discovery of the fact that they are jointly confronting the proposition may take place in real life or online within a network or even within a social network. The fact that both agents NA1, NA4 are F-D anti-consensus type modulo the proposition about buying car 330A is indicated in FIG. 6D by a specific visual designation of interaction 608. Namely, the arrows indicating interaction 608 are blank and shaded, respectively. This represents a type of exchange or conversation that cannot lead to consensus or agreement on the same state for both agents NA1, NA4 even in principle. Instead, agents NA1, NA4 are locked in a win/lose or competitive mentality. They will not be able to devise a way to share car 330A by any strategy. One can consider agents NA1, NA4 to be in some sense “repulsive” with respect to each other modulo the proposition. The physical outcome of such situations ends in one agent outbidding the other.

Joint exposure commencing at initial time tₒ finds its quantum cognition representation on the right side of time line 600. Starting at time tₒ the two previously known quantum states of agents NA1, NA4 can no longer be labeled. In fact, they cannot be presumed to be separable. Now they are engaged in the possible formation of joint agent state Ψ. This process is indicated within the corresponding dashed outline 612 in the quantum cognition representation.

Time line 600 indicates that a time equal to five half-lives (5τ) is allowed to elapse during which agents NA1, NA4 are jointly exposed to the proposition about buying car 330A. Because of indistinguishability dictated by our quantum cognition representation we can't at this stage say who is who. Thus, the Bloch spheres are not expressly labeled. However, at some time a message or signal \tilde{γ} is exchanged and leads to the formation of joint agent state Ψ that is entangled. More than one signal \tilde{γ} can be exchanged up to an inclusive an entire conversation. Furthermore, since the quantum cognition representation cannot yield but statistical information about when the exchange happens, we have indicated it in a dashed line in FIG. 6D.

For the purposes of the present example, it is presumed that joint agent state Ψ is achieved by time tⱼₛ, or after five half-lives. This is a fairly safe assumption, as the careful reader will note that the probability of not having formed joint agent state Ψ after that much time is less than 1%.

The joint confrontation or exposure of agents NA1, NA4 to car 330A where the underlying proposition concerns purchase to thus induce the formation of joint agent state Ψ is not open-ended. Generation of joint agent state Ψ and its persistence is bounded in time. Once achieved with more than 99% likelihood by time tⱼₛ joint agent state Ψ will have a tendency to decohere or dissociate with the passage of time (e.g., due to interactions with the social environment). Based on physical rules on which the present quantum cognition representation is based, the persistence of the joint state is associated with a decoherence time τ_{D} for agents NA1, NA4. Preferably, this time is estimated by Quantum Processing Unit 322 and further corroborated by the human curator.

In vernacular terms, decoherence time τ_{D} is directly related to how long, once in joint agent state Ψ, agents NA1, NA4 will tend remain in it. Decoherence of quantum states is due to interaction with the environment. In the quantum cognition representation adopted herein the most likely source of environmental decoherence effects are taken to be due to interactions with still other agents (not shown). Thus, ideally much less time than one decoherence time τ_{D} should elapse between obtaining the joint state at time tⱼₛ and measuring it (by measuring either or both of agents NA1, NA4) to obtain any eigenvalue(s) or subsequent measurable indication(s). As more and more decoherence times τ_{D} expire, the probability of agents NA1, NA4 persisting in joint agent state Ψ will typically be found to decay exponentially. We can thus only speak of entanglement with a high expectation that it is still there prior to the expiration of one decoherence time τ_{D} and preferably just a fraction thereof. In the following discussion it will be assumed that our chosen pair of agents NA1, NA4, are being considered within a time period much shorter than one decoherence time τ_{D} after time tⱼₛ.

It is important to realize that entanglement itself produces a correlation between agents NA1, NA4 that transcends their individuality. This is fully captured by joint state Ψ of Eq. 27. Even more, this correlation transcends any particular choice of contextualization by either agent in the pair. In other words, as long as entanglement in the pair of agents NA1, NA4 persists, it will manifest modulo the proposition about car 330A even when car 330A is not considered in the “style” contextualization (basis established by value matrix PR_{V}). This rather surprising type of correlation existing prior to the choice of basis (or, equivalently, prior to the choice of contextualization) is not found in classical representations. It is a unique feature of the quantum representation adopted herein and it does warrant further explanation.

Correlation due to entanglement produces a kind of bond or anti-bond, depending on type of joint agent state (which is partly dictated by the consensus or anti-consensus statistics). F-D anti-consensus agents NA1, NA4 establishing entanglement under joint agent state Ψ of Eq. 27 generate an anti-bond. This anti-bond transcends physicality. In some embodiments of the invention it can be assigned its own proxy that has explanatory power among agents NA1, NA4 and for any user of Quantum Processing Unite 322, e.g., a market analyst.

Convenient proxies for talking about such physicality transcendent concepts include concepts of feelings such as trust, distrust, amity, enmity, belonging, loneliness (apartness) and/or other feelings that agents NA1, NA4 may recognize. Of course, these proxies may only be posited in internal spaces IS1, IS4 of agents NA1, NA4. Their use for explanatory purposes should not be unduly extended.

In the present case, agents NA1, NA4 established an anti-bond in their strife over purchase of car 330A while jointly exposed to the proposition. Given that both agents NA1, NA4 are F-D anti-consensus, a likely feeling that may encapsulate their anti-correlation formed through entanglement is enmity or strife. Had agents NA1, NA4 been B-E consensus type and established correlation in a different entangled state, then even if one had “won” and the other “lost” the bidding over car 330A a likely feeling representing the bond (rather than anti-bond found among F-D anti-consensus types) would be mutual respect.

The key feature of correlations (i.e., correlations and anti-correlations) that can thus be captured by the proxy of a feeling is that it forms and persists in Hilbert space. In other words, in the case of agents NA1, NA4 their anti-correlation captured by joint agent state Ψ does not have any objective existence in real life. No equivalent of this anti-correlation, just as in the case of feelings, can be represented in precipitated reality conditions illustrated on the left side of time line 600. The only way to find evidence of the existence of the entangled state when operating within the domain of real-life events is through measurement. Of course, measurement necessitates a basis choice, or equivalently a choice of contextualization. Thus, only a “projection” of the entanglement created between agents NA1, NA4 can ever be observed.

FIG. 6D illustrates the anti-bond established in the entangled pair of agents NA1, NA4 by showing that they will anti-correlate under any given proposition involving car 330A (as long as they are both measured in the same contextualization). In other words, irrespective of choice of basis (contextualization) modulo the proposition, when measured in that same basis their measurable indications will anti-correlate. The drawing figure uses the rather universal thumbs-up and thumbs-down signs to illustrate the anti-correlation of subsequent measurable indications that entangled agents NA1, NA4 are expected to manifest in real-life. In preferred embodiments of the invention Quantum Processing Unit 322 is in charge of collecting subsequent measurable indications from agents NA1, NA4.

On the quantum representation side of time line 600 we show the entangled state Ψ with the aid of new Bloch spheres 10E1′ and 10E4′. Explanation of entangled state Ψ requires the density matrix formalism. For reasons of simplicity and clarity, the present example presumes that agents NA1, NA4 entangled with negligible environmental influences and are thus truly represented by joint state Ψ as expressed in Eq. 27. A person skilled in the art will recognize that effects beyond entanglement can be included in the density matrix expression of an agent's internal state in accordance with the quantum representation taught herein (e.g., an agent's individualistic state as explained in section II).

Bloch spheres 10E1′, 10E4′ no longer illustrate individual quantum states with eigenvectors since the joint state is completely interdependent across the agents (due to entanglement). Rather, as shown on the example of agent NA4 assigned to Bloch sphere 10E4′, entanglement caused its original (when acting individually) reasonably pure eigenstate |sv [symbol] _{E}_{₄} of value matrix PR_{V} to “jump” to a point 616E4 at the center of Bloch sphere 10E4′ as indicated by arrow 614. In other words, the quantum representation of internal state IS4 of agent NA4 modulo the proposition about car 330A has ceased to be a reasonably pure state associated to single state vector |sv₁ [symbol] _{E}_{₄} or, equivalently its point 18E4 on the surface of Bloch sphere 10E4′. Internal state IS4 of agent NA4 modulo the proposition is now expressed by density matrix ρ₄.

The same is true for the other agent of the pair, namely for agent NA1 whose experience of entanglement with agent NA4 modulo the proposition sends his quantum cognition representation to a point 616E1 at the center of Bloch sphere 10E1′. Internal state IS1 of agent NA1 modulo the proposition is now expressed by density matrix ρ₁. The reader is reminded here that once the quantum cognition description of the agent's state ceases to be confined to the surface of the Bloch sphere (i.e., it ceases to be a pure state and becomes progressively more mixed the closer the state is to the center of the Bloch sphere) it also stops being unique. In other words, there are many ways to describe the same point within the Bloch sphere. Still differently put, many types of entanglement can lead to the agent's state to be expressed by the same point within the Bloch sphere.

FIG. 6D also provides an idea of environmental effects that may interfere with the achievement of perfect entanglement between agents NA1, NA4. To keep matters simple, environmental influences (decoherence effects) are shown on the example of agent NA1 only. As already noted previously, these could be due to additional effects under coupling with aspects of the social environment that may include other agents, objects/items and/or experiences including the agent's own internal experiences. Because of such additional interactions the quantum cognition representation of inner state IS1 of agent NA1 changes. This is depicted in Bloch sphere 10E1′ where point 616E1 at the center is dislodged to point P̅ with the passage of time as shown in the dashed lines.

The amount by which point P̅ moves away from center point 616E1 is conveniently described by projections Pₓ, P_{y}, P_{z}. Put together, these parameterize point P̅ in vector form that can be used to describe the deviation of agent NA1 from perfect entanglement under Eq. 27 with agent NA4. The perturbed density matrix ρ₁ that describes internal state IS1 of agent NA1 is explicitly written out in terms of point P̅, the identity matrix I and the “vector” of Pauli matrices 6.

In the following we presume persistence of perfect entanglement in accordance with Eq. 27 (no decoherence). In view of the previous example of perturbation, we immediately see that for states corresponding to points 616E1, 616E4 at the centers of their Bloch spheres 10E1′, 10E4′ (or alternatively where point P̅={0,0,0}) density matrices ρ₁, ρ₄ become just one half the identity matrix I. This is the simple case we have been introduced to in section I (Background).

A crucial realization is that entanglement between agents NA1, NA4 leading to density matrices ρ₁, ρ₄ could have been achieved in any other basis or contextualization of the proposition. Say agents NA1, NA4 had been jointly exposed to the proposition while previously espousing a known alternative contextualization expressed by an alternative value matrix PR_{AV}. For example, alternative value matrix PR_{AV} sets forth the alternative contextualization by “practicality”. Its eigenbasis contains two orthogonal eigenvectors. This first eigenvector |sav₁ [symbol] stands for finding car 330A practical. The second eigenvector |sav₂ [symbol] stands for not finding car 330A practical. The eigenvalues that go with these eigenvectors are mutually exclusive measurable indications of “YES” and “NO”.

Clearly, entanglement between agents NA1, NA4 could now lead to Eq. 27 but using the basis vectors |sav₁ [symbol] , |sav₂ [symbol] of alternative agent value matrix PR_{AV}. In other words, we now obtain the same expression with the new basis vectors:

$$Ψ = 1 / \sqrt{2} ( \vert s a {v}_{1} {{E}_{1}}_{} ⊗ \vert s a {v}_{2} {{E}_{4}}_{} - \vert s a {v}_{2} {{E}_{1}}_{} ⊗ \vert s a {v}_{1} {{E}_{4}}_{} ) .$$

But this will again lead to the same density matrices ρ₁, ρ₄! Therefore, irrespective of how entanglement was achieved, density matrices ρ₁, ρₙ₄ continue to describe the individual states of agents NA1, NA4 modulo the proposition. This holds for purposes of collection of subsequent measurements from each one of agents NA1, NA4 on its own. Of course, we again presumed no environmental effects in this case. It should further be noted that in some cases agents NA1, NA4 could already be entangled prior to confronting them with the proposition. This is an important point, since in practical situations when considering agents such as market agents in a known marketplace many of them would likely have histories of forming (and not forming) various types of relationships with each other.

The gist of entanglement is thus seen to transcend correlations and anti-correlations modulo propositions about items manifesting in physical reality or in the realm or real-life events shown on the left side of time line 600. Entanglement is an expression of an overall approach to a proposition in any basis when agents NA1, NA4 are cognizant of each other. Indeed, in some instances even the exchange of the item about which proposition is formed may not affect the entangled state. Differently put, if agents entangle according to F-D statics about car 330A they may do the same with respect to other items. Entanglement between agents can thus sustain or persist over different propositions altogether. In the vernacular, it is as if agents NA1, NA4 developed an anti-correlation in measurable indications irrespective of what proposition it is they are confronting. Of course, for agents that exhibit the B-E consensus statistic entangled states that point to the development of agreement with each other irrespective of the proposition and/or the item it is about is possible too.

In the quantum cognition representation entanglement is taken to persists even when agents NA1, NA4 are no longer together. The inspiration for this aspect of the quantum cognition representation is once again derived from physics proper, where entanglement has been confirmed to sustain for non-local states. Experiments that empirically corroborate this are commonly done with Bell states separated by large distances (see also EPR states). Eigenvalues obtained in measuring one of the pair of particles or photons in some basis are seen to obey the correlation established in Hilbert space when the other particle or photon of the pair is measured in the same basis. The reader is encouraged to explore the many experimental verifications of Bell's inequality. For other types of tests of entanglement and “no-go” theorems for classical explanations of entanglement (typically using hidden variables) the reader is referred to the Kochen-Specker (KS) theorem along with its early version presented by von Neumann and also to Gleason's theorem in quantum logic.

The establishment of entanglement in physics is due to an underlying symmetry or conservation law that governs the interaction (for a more extensive review see Noether's theorem and the Ward-Takahashi identity). Underlying symmetries transcend specific instances. In the case of the two spinors we have been using in our example, it is typically the conservation of angular momentum that is used to illustrate this point. We start with an entangled state in which the pair of spins add to yield a net angular momentum of zero. The careful reader will recognize that this is the state encapsulated by Eq. 27. When the two spins separate and the joint state has not yet decohered, conservation of angular momentum dictates that the spins anti-correlate when measured in the same basis. It is irrelevant how far apart the spins are from the point of view of conservation of angular momentum that is imposed on the state in Hilbert space. No communication between the spins is required to communicate this underlying symmetry (conservation of angular momentum).

By extending entanglement to pairs of agents we are importing these foundational insights about physical nature to inform our quantum cognition representation. We thus posit that once formed, entanglement continues to affect agents NA1, NA4 even when they are no longer together. In other words, their entanglement continues until it is destroyed by decoherence.

FIG. 6E first shows agents NA1, NA4 together after being entangled at time tⱼₛ when their joint agent state Ψ is created (with 99% probability, as noted above). On the quantum cognition representation side of time line 600 we show their joint agent state Ψ pictorially for reasons of simplicity. Note that the plus sign in this picture merely indicates that the state is joint (the formal joint agent state has a minus sign and is described by Eq. 27). The fact that agents NA1, NA4 are entangled to anti-correlate on subsequent measurable indications when collected in the same basis (or, equivalently, in the same contextualization) is indicated by opposite shadings of the Riemann surfaces.

Before the passage of one decoherence time τ_{D} after entanglement time tⱼₛ agents NA1, NA4 are physically separated. The separation occurs in real life at a separation time tₛₑₚ. It is designated by arrow 618 shown on the left side of time line 600 in the real-life events realm. Agents NA1, NA4 are no longer together after time tₛₑₚ and thus cannot be jointly exposed to the proposition any more.

Nevertheless, according to our quantum cognition representation agents NA1, NA4 are still entangled after separation time tₛₑₚ with a very high probability (until they decohere). As a reminder of this important aspect, we note on the quantum cognition representation side of time line 600 that physical separation 618 has no effect on entangled state as described by joint agent state Ψ. The reader should note that once some sufficient physical separation between agents is achieved in real life, complete online separation, i.e., in any network or social network that they belong to can be used to achieve and keep the final physical separation.

In the present example a large physical separation 618 is used for pedagogical reasons. In particular, agent NA4 moves to San Francisco while agent NA1 moves to New York city. This is visually indicated on the real-life events side of time line 600. At the same time, nothing changes in the description of joint agent state Ψ on the quantum cognition representation side. Just to indicate that agents are physically separated their Riemann surfaces are rearranged but they stay within the same tensor space.

At a measurement time tₑ agents NA1, NA4 are re-confronted by the proposition about buying car 330A. The re-confrontation or exposure is not joint, since agents NA1, NA4 are evidently separated and not in communication with each other. Moreover, the re-confrontation may not occur at exactly the same time for each of agents NA1, NA4. In some cases, only one agent may be measured and the other not. For reasons of explanation of the effects of entanglement, however, we will continue with a case in which both agents NA1, NA4 are measured and yield measurable indications.

In a preferred embodiment re-confrontation with the proposition is orchestrated by using any of the affordances of any network and/or social network available to Quantum Processing Unit 322. Alternatively, re-confrontation may happen in real life. It may even occur spontaneously when, for example, both agents NA1, NA4 read their respective newspapers with advertisements for car 330A at their original location prior to separation. Just for the purpose of the present example, we will take this place to be Chicago, as also indicated in FIG. 6E.

For the purposes of the present example neither agent in the entangled pair had ultimately won the bidding over car 330A. Some unknown third agent had purchased car 330A. This unknown agent is selling car 330A shortly after having bought it, so it is available once more. Agents NA1, NA4 living their now separate lives, as indicated by arrows 620A and 620B, learn about this fact separately. Again, by separate lives 620A, 620B we mean that agents NA1, NA4 are no longer in any communications with each other and are thus not exchanging any signals or messages about any propositions and especially not about the proposition of renewed purchase opportunity of car 330A. This lack of contact is true in real life and online.

Local network monitoring units 622A, 622B are provided in San Francisco and New York city for collecting subsequent measurable indications from agents NA1, NA4 modulo the proposition. Preferably, units 622A, 622B belong to an overall network monitoring unit or are otherwise integrated and/or interfaced therewith in any permissible manner and provide their measurable indications to Quantum Processing Unit 322. Units 622A, 622B have access to information generated by the agents. For example, units 622A, 622B belong to a system that monitors transactions such as sales of cars evidently including car 330A. Examples of such systems are well known in the art of car brokerages and listing services.

At event time tₑ, which is slightly different for each agent (e.g., from a few hours to a few days apart), units 622A, 622B collect subsequent measurable indications from agents NA1, NA4. Of course, both are collected within a single decoherence time τ_{D} after entanglement time tₛ. In accordance with the quantum cognition representation, it is therefore very likely that both agents NA1, NA4 still deploy the contextualization of the proposition in terms of “style” of car 330A when re-confronting the proposition.

It is important to recall, that if joint state Ψ between agents NA1, NA4 has already decohered by event time tₑ then no entanglement effects will be observed. Once decohered agents NA1, NA4 can be treated separately as previously taught for individual or independent states (separable states; see section II). Preferably, the new and independent states should be estimated first before attempting any tracking, simulation or prediction.

For the present purposes, we will proceed under the assumption that the measurement or “collapse” of the wave function does indeed happen from the non-decohered joint state Ψ. The joint state thus continues to manifests the anti-correlated measurable indications. This is shown on the quantum cognition representation side of time line 600 by table 624 of possible subsequent measurable indications when both agents NA1, NA4 again choose the “style” contextualization of the proposition. Specifically, the measurable indications are here properly associated to their correspondent eigenvalues.

It is duly noted, that although both agents NA1, NA4 can still be contextualizing the proposition about buying car 330A the same way at event time tₑ, namely “style”, their context choice at that time can also be different. This different context choice does not negate or undo the effects of entanglement, as we will see further below.

Table 624 shows the measurable indications that can be collected from collapsing anti-symmetric joint state Ψ in the same contextualization. As noted above, both agents use the same value matrix PR_{V}, which corresponds to contextualization by “style”. The eigenvalues come in pairs since we measure both agents. They go with the eigenvectors in the tensor space [symbol] ^{(E1,E4)}. To keep better track, we take eigenvalues λ_{E1,1}, λ_{E1,2} as those for agent NA1 (“YES”, “NO” from agent NA1) and λ_{E4,1}, λ_{E4,2} as those for agent NA4 (“YES”, “NO” from agent NA4). In the same contextualization of “style” the pairs will include: “YES”, “NO” and “NO”, “YES” for agents NA1, NA4, respectively. In table 624 the entries corresponding to these indications are shown with a check sign. The “YES”, “YES” and “NO”, “NO” options available when the entangled agents are B-E consensus type are not available to the F-D anti-consensus type agents NA1, NA4. The corresponding entries in table 624 are therefore crossed out. Also recall that the indistinguishable nature of agent states in this quantum cognition representation precludes labeling of agents prior to measurement. Only after the measurement is performed at a later time will we know how agents NA1, NA4 chose their “YES” and “NO” eigenvalues.

Entanglement ensures that agents NA1, NA4 will yet again exhibit strife typical of two competing F-D anti-consensus agents. In the vernacular, the two agents NA1, NA4 will effectively replay their original competitive dynamic. In the chosen contextualization of “style”, the strife can manifest in a “bidding war” or similar situation. We recall that the eigenvalues λ_{E1,1}, λ_{E1,2} and λ_{E4,1}, λ_{E4,2} can manifest not only in terms of the mutually exclusive responses of “YES” and “NO”. They may take on the form of a real-valued parameter W that denominates a socially accepted quantity. For example, in real life the renewed competition between agents NA1, NA4 over car 330A can find expression in measurable indications being differing amounts of money offered to buy car 330A. In this case, money would be the embodiment of the real-valued parameter W.

Surprisingly, the competitive dynamic will play out even if agents NA1, NA4 choose a different contextualization when re-confronted by the proposition. For example, let us consider the case where both agents NA1, NA4 decide at event time tₑ to contextualize the proposition they are re-confronted with in terms of “utility”. In this contextualization the agents do not consider car 330A for its stylishness, but whether it has utility. The purpose of car 330A is evidently different in contextualization by “utility”. Therefore, the judgment of car 330A in this contextualization will be different. We presume here that both agents NA1, NA4 are interested in car 330A in this secondary contextualization by “utility” for whatever reasons (e.g., for personal reasons).

Contextualization of the proposition about car 330A by “utility” practiced by agents NA1, NA4 in this alternative is not compatible in the Heisenberg sense with the “style” contextualization expressed with value matrix PR_{V}. The “utility” contextualization is expressed with a secondary value matrix PR_{SV} (which happens to be value matrix PR_{w}) whose eigenvectors are not aligned and may even be orthogonal to those of value matrix PR_{V}. Although it is clear that contextualizing by “utility” and by “style” typically cannot be applied simultaneously in agreement with the Heisenberg sense of non-commutability, the relationship should nevertheless be confirmed. In other words, commutator algebra should be used to obtain the best possible estimate of the relationship between value matrix PR_{V} and secondary value matrix PR_{SV}.

In practice, each agent is free to choose their own contextualization when re-confronted by the proposition. To see what happens when the basis is changed it will be necessary to sway agents NA1, NA4 to both adopt the “utility” contextualization. This is best done by using the resources of the system including any networked devices, networks and/or social network available to Quantum Processing Unit 322. For example, a new advertisement for car 330A is pushed to agents NA1, NA4 touting its utilitarian attributes (e.g., as having qualities of a good gas mileage and low maintenance cost). The purpose is to shift the choice of contextualization by agents NA1, NA4 (change of basis) but not to disrupt entanglement. Note that if unsuccessful and agents adopt incompatible contextualizations then the entanglement effect in the quantum cognition representation will be lost (same as in physics proper).

We proceed under the assumption that the strategy for shifting the basis was effective. In other words, agents NA1, NA4 switched from contextualizing the proposition by “style” to contextualizing it by “utility”. This means that the states of agents NA1, NA4 should now be spectrally decomposed in eigenvectors of secondary value matrix PR_{SV}. These eigenvectors are not the same as those of value matrix PR_{V}. In fact, they are possibly even completely orthogonal (ensure confirmation by commutator algebra) to those of agent value matrix PR_{V}.

Given the rules of quantum entanglement now expect something unusual to manifest. We have already discovered that the formation of entangled agent state Ψ modulo the proposition about car 330A originally achieved in the “style” contextualization expressed with value matrix PR_{V} led to density matrices ρ₁, ρ₄ that were not unique representations of agent inner states. In other words, entanglement in any other basis or contextualization would have yielded the same density matrices ρ₁, ρ₄ (consult FIG. 6D). To repeat, entanglement between agents NA1, NA4 leading to density matrices ρ₁, ρ₄ could have been achieved in the contextualization of proposition by “beauty” expressed by alternative value matrix PR_{AV}, by “utility” expressed by secondary value matrix PR_{SV}, or indeed any other admissible contextualization under which agents NA1, NA4 can entangle!

This means that when agents NA1, NA4 remain entangled but decide to deploy the same contextualization in evaluating the proposition (they both apply the same value matrix) at event time tₑ, network monitoring units 622A, 622B will record measurable indications that anti-correlate according to the F-D statistic (see table 624 in FIG. 6E). This is true irrespective of the commutation relation between value matrices encoding the different contextualizations as long as both choose the same contextualization. Meanwhile, value matrices PR_{V}, PR_{AV}, PR_{SV} could be maximally non-commuting (yielding the largest commutator value possible) thus standing for contextualization that are not compatible (cannot be acted on simultaneously). Alternatively, they could commute and stand for contextualizations that can be adopted simultaneously in judging the proposition. Most likely, they would represent contextualizations that partially commute and are somewhere in-between compatibility and incompatibility. In any event, however, as long as agents NA1, NA4 are still entangled and adopt the same contextualization, their measurable indications will anti-correlate.

Of course, in most common situations it will not be possible to sway both agents NA1, NA4 to choose the same contextualization. Attempting to do so may even break the joint agent state Ψ and consequently destroy entanglement. The human curator should be consulted when attempting to sway agents NA1, NA4 to estimate the likelihood of loss of entanglement when forcing a contextualization upon either one or both of them.

In the general case, agents NA1, NA4 will be allowed or even expected to freely choose different contextualizations upon being re-confronted by the proposition. Despite this freedom, the effects of entanglement will become apparent in subsequent measurements.

Specifically, the statistics of subsequent measurable indications collected by units 622A, 622B from agents NA1, NA4 will violate Bell's inequality. In the vernacular, entanglement will cause the internal states of agents NA1, NA4 to “feel” each other's choices irrespective of contextualization. Of course, this “feeling” will decrease as the value matrices of chosen by the agents become more and more incompatible and disappear completely once the value matrices are orthogonal and their commutator reaches maximum value. It is this absolutely astounding correlation between the inner states experienced by agents NA1, NA4 despite being separated that leads to statistics that violate Bell's inequality.

Of course, it is possible that only one of agents NA1, NA4 will manifest their measurable indication. The other agent may drop out of the competition without yielding their measurable indication. Nonetheless, as long as entanglement is still present there will be an effect. Specifically, at the time that the measurable indication of the first agent is collected the second agent concurrently assumes a certain internal state. This internal state will be the one that the quantum cognition representation assigns based on the symmetry under which entanglement was formed. For our F-D anti-consensus type agents NA1, NA4 the second agent, if forced to yield their measurable indication would exhibit anti-correlation in the same contextualization. For B-E consensus type agents, of course, measurable indications correlate rather than anti-correlate under entanglement.

FIG. 6F is a diagram that takes a closer look at a situation in which agent NA1 yields their measurable indication λ_{E1} at their event time t_{eE1}. The actual value of measurable indication λ_{E1} is either λ_{E1,1} or λ_{E1,2}. It corresponds in our example to one of the two mutually exclusive responses “YES” or “NO”. In reliance on the fact that entanglement transcends contextualizations the contextualization in which agent NA1 yields their measurable indication λ_{E1} is not imposed.

In other words, agent NA1 is not swayed in their choice of contextualization (choice of value matrix). Instead, unit 622B collects measurable indication λ_{E1} (i.e., λ_{E1,1} or λ_{E1,2}) at event time t_{eE1} and, if available (e.g., by agent self-report or otherwise) simply notes the freely chosen contextualization exhibited by agent NA1 when yielding their measurable indication λ_{E1}. In the present example the measurable indication is λ_{E1,1}.

Agent NA4 does not yield their measurable indication λ_{E4} until their event time t_{eE4}. Again, the actual measurable indication λ_{E4} is either λ_{E4,1} or λ_{E4,2} and stands for one of the two mutually exclusive responses “YES” or “NO”. Agent NA4 is likewise allowed to freely choose their contextualization. Unit 622A collects measurable indication λ_{E4} (i.e., λ_{E4,1} or λ_{E4,2}) at event time t_{eE4} and also notes the freely chosen contextualization (if available) exhibited by agent NA4 when providing their measurable indication λ_{E4}.

Now the reason for letting Quantum Processing Unit 322 choose agents NA1, NA4 that entangle in the same contextualization and are likely to continue to exhibit that contextualization in the future will pay its dividends. Specifically, since agents NA1, NA4 were chosen for exhibiting the known contextualization of “style”, it is likely that they will freely adopt this same contextualization after they have been entangled and are being re-confronted by proposition. Of course, this is just a probable situation and we do not presume that it will happen always or even most of the time. However, in the cases where both agents NA1, NA4 revert to contextualization by “style” the quantum representation tells us that their measurable indications λ_{E1}, λ_{E4}, if both collected at event times t_{eE1}, t_{eE4} that are very close (so as to prevent any appreciable state evolution in the interim between them) will anti-correlate.

It is crucial to note that the quantum representation does not dictate that the anti-correlation should be the same as before. The two agents NA1, NA4 can switch their “YES” and “NO” responses. Such a swap will still satisfy the entanglement condition. In addition, entanglement that assigns their inner states IS1, IS4 to joint agent state Ψ will cause anti-correlated measurable indications λ_{E1}, λ_{E4} irrespective of the separation of agents NA1, NA4 in space-time. No transmission of physical information between agents NA1, NA4 is required for this to take place. In other words, the correlation does not exist on the real-life events side of time line 600. Instead, it is confined to the Hilbert space on the quantum cognition representation side of time line 600.

Einstein had a fundamental objection to this “spooky action at a distance” under which “collapse” or measurement of the state of one agent influenced the state of the other. To better understand the objection we examine our case of agent pair NA1, NA4 in still more detail.

As shown in FIG. 6F, agent NA1 is measured at time t_{eE1} by unit 622B in New York and exhibits eigenvalue λ_{E1}=λ_{E1,1}. Therefore, at measurement or event time t_{eE1} internal space IS1 of agent NA1 must be assigned to quantum state |sv₁ [symbol] _{E}_{₁}. This means that the density matrix ρ₁ representation of their inner state IS1 modulo the proposition is reduced to just state |sv₁ [symbol] _{E}_{₁}. Were it not so, then agent NA1 would not have generated measurable indication λ_{E1,1}, which is after all the physical manifestation of state |sv₁ [symbol] _{E}_{₁} per our quantum cognition representation.

At this juncture, Einstein would maintain that nothing has yet happened to agent NA4, who is far away in San Francisco. However, inner state IS4 of agent NA4 is entangled with inner state IS1 of agent NA1. Thus, as agent NA1 is measured and collapses to state |sv₁ [symbol] _{E}_{₁} it is inextricably entangled with inner state IS4 of agent NA4 and thus has to “collapse” that state too (there is really only one state, due to entanglement). That is the quantum meaning of the joint agent state. It is impossible to interact with one of the entangled agents in the pair without affecting the other irrespective of physical separation.

The measurement of agent NA1 must therefore reduce the density matrix ρ₄ representing inner state IS4 of agent NA4 modulo the proposition to pure state |sv₂ [symbol] _{E}_{₄}! The symmetry (anti-symmetric joint agent state) under which entanglement occurred in our quantum cognition representation requires anti-correlation of inner states IS1, IS4. Notice that we did not need to measure the correspondent eigenvalue λ_{E4}=λ_{E4,2} from agent NA4 at time t_{eE1} to establish the existence of state |sv₂ [symbol] _{E}_{₄}. Were it to be measured, it would have yielded eigenvalue λ_{E4,2} given agent NA4 is in state |sv₂ [symbol] _{E}_{₄}.

In labeling the states in the drawing figure we could have added back the subscript V to indicate the V-basis decomposition in the “style” contextualization per value matrix PR_{V} for pedagogical reasons. The fact that measurement of agent NA1 under re-confrontation with proposition has thus collapsed the full joint wave function W described by Eq. 27 is indicated on the quantum cognition representation side in FIG. 6F.

Einstein's objection is that internal state of agent NA4, who is all the way in San Francisco cannot be changed by measurement of agent NA1 in New York without some interaction mechanism in real life. This objection indicates a skepticism that symmetry laws that hold in Hilbert space and do not require mediation through the fully emerged context or via the space-time fabric on the left side of time line 600 are sufficient for mediating the quantum correlations established in entanglement. In order to overcome the objection from the point of view of our present quantum cognition representation, it would have to be shown agent NA4 “feels” a change in their inner state IS4 at measurement time t_{eE1} of entangled partner NA1 in the context of the proposition. Note that this change is initially confined to inner spaces and does not need to produce any measurable indication.

For the purposes of the present invention and the quantum cognition representation adopted herein, we assume that agent NA4 indeed “feels” the change in their inner state IS4 modulo the proposition as captured by the change in their quantum representation when their partner NA1 is measured. Further, for the purposes of the invention, it is assumed that any pair of agents can represent such “feelings” by a proxy that has explanatory power for them. Even further, tokenization of proxies in physical entities, which may include items is also permissible.

For example, a “feeling of rivalry” may be a proxy that entangled agents experiencing this proxy wish to capture or embody in the physical realm. The token may be an item that relates to the proposition the “feelings of rivalry” were about. In the event of car 330A, the token may simply be a picture of car 330A. Tokens that embody proxies such as friendship, trust, amity etc. can also be instantiated. In most cases, proxies can be represented by items that include agents, objects and experiences. In the case of proxies for the feeling of “trust” very specific items can be designated. Indeed, these items may even represent the real-valued parameter W we have previously discussed. A very convenient social choice for tokenization of parameter W standing for social trust is money.

In general, tokenization of proxies in accordance with the invention allows us to measure entanglement (or at least the level of entanglement experienced by the agent pairs). We can, of course, deploy for this purpose the many tools we have previously discussed for studying the level of entanglement in physics proper. Advantageously, however, unfettered deployment of tokens by agents that are entangled to capture their specific type of joint agent states should be encouraged. These tokens can be used as a validation of entanglement measures obtained using the tools from physics proper.

Tokens can also be used to discover hidden entanglements between agents. For example, the discovery of a token embodied by an item such as a friendship bracelet between apparent strangers indicates that these agents are likely entangled in accordance to one of the four possible joint states for pairs. These also correspond to the four canonical entangled states for two qubits, when the invention is practiced using qubits.

We now consider the conclusion to the situation shown in FIG. 6F as if it were necessary to communicate in the emerged realm on the left side of time line 600 to sync up agents NA1, NA4 in their measurable indications to reflect the anti-correlation captured by their anti-symmetric joint agent state Ψ. It so happens that agent NA4 is measured within a very short time after agent NA1 is measured. The measurement of agent NA4 is performed at time t′_{eE4} by unit 622A in San Francisco.

The period between times t_{eE1} and t′_{eE4} is extremely short. It is shorter than a signaling or messaging time τ_{msg} during with a message 640 communicating the choice of eigenvalue λ_{E1,1} in contextualization of “utility” made by agent NA4 to agent NA1 can be physically sent between New York and San Francisco. Message 640 could, at the very earliest, arrive at a time t_{eE4} which is equal to messaging time τ_{msg} after agent NA1 has already exhibited their measurable indication λ_{E1}. In other words, agent NA4 would have already had to have exhibited their measurable indication correctly, i.e., exhibited the proper anti-correlation on measurable indications forcing λ_{E4}=λ_{E4,2} by time t_{eE4}.

Message 640 communicating the choice of eigenvalue λ_{E1,1} by agent NA1 to agent NA4 cannot travel any faster. That is because message 640 uses the fastest possible message transfer channel available in fully emerged reality, namely the electro-magnetic field or photons γ. Photons γ cannot travel faster than the speed of light c and thus are confined to propagate on the null ray. As indicated in the diagram, this makes it impossible to transmit message 640 in fully emerged reality or on the real-life events side of time line 600 it a time less than τ_{msg}. The separation between agents NA1, NA4 is space-like. Therefore, there is no mechanism permitted within our current understanding of relativity that can be responsible for alerting agent NA4 to the choice of contextualization and measurable indication already made by agent NA1 if the time between t_{eE1} and t′_{eE4} is less than τ_{msg}. The earliest time by which message 640 can arrive in principle is t_{eE4}.

Barring any evolution of the internal state IS4 (captured by the quantum state) of agent NA4 between its collapse at time t_{eE4} and time t′_{eE4} we see from the perspective of quantum representation that measurement of agent NA4 is merely confirmatory of what we already know. Namely, agent NA4 will be found in state |sv₂ [symbol] _{E}_{₄} and will yield as subsequent measurable indication λ_{E4}=λ_{E4,2}. This has to happen in order to preserve the anti-correlation between the measurable indications. In physics proper, this type of situation has been studied in Bell-type experiments. The hotly debated non-local anti-correlation is a confirmed fact. In our representation, we take this to mean that message 640 is not required to sync up agents NA1, NA4 to obtain the anti-correlation.

Returning to FIG. 6E, we see that in the preferred embodiment Quantum Processing Unit 322 is connected to units 622A, 622B. Quantum Processing Unit 322 reviews known and subsequent measurable indications from agents NA1, NA4 to estimate a measure of entanglement such as, for example, entanglement entropy. At this point it should be remembered that there are four possible pairwise entangled states. The first two express entanglement between F-D anti-consensus agent pairs like agents NA1, NA4 (notice that Eq. 27 is just Eq. 28 with the minus sign choice):

$$Ψ = 1 / \sqrt{2} ( \vert s {v}_{1} {{E}_{1}}_{} ⊗ \vert s {v}_{2} {{E}_{4}}_{} \pm \vert s {v}_{2} {{E}_{1}}_{} ⊗ \vert s {v}_{1} {{E}_{4}}_{} ) \qquad Eqs . 28$$

The other two are for B-E consensus agent pairs like agents Sⱼ, Sₖ experiencing entanglement:

$$Φ = 1 / \sqrt{2} ( \vert s {v}_{1} {{E}_{j}}_{} ⊗ \vert s {v}_{1} {{E}_{k}}_{} \pm \vert s {v}_{2} {{E}_{j}}_{} ⊗ \vert s {v}_{2} {{E}_{k}}_{} ) \qquad Eqs . 29$$

Clearly, for the perfectly anti-correlated joint agent state Ψ expressed by Eq. 27 the entanglement measure will indicate complete entanglement. The same will be true for the remaining three joint agent states of Eqs. 28 & 29.

As will be appreciated by those skilled in the art, tests of entangled states can be performed in many ways. These may even include situations in which the original measurable indications are unknown, but entanglement is nonetheless established. Therefore, Quantum Processing Unit 322 can be used for estimating the measure of entanglement by comparing just the subsequent measurable indications without having at its disposal any known measurable indications. In cases where the original measurable indications are known, of course, comparison of known measurable indications with subsequent measurable indications will permit Quantum Processing Unit 322 to obtain better estimates. In cases where a sufficiently reliable measure of entanglement can be obtained, the statistics module may proceed to further estimate a change in the quantum representation of the pair of agents due to entanglement. In other words, when confronted with imperfect entanglement (see FIG. 6D and corresponding description of density matrix ρ), Quantum Processing Unit 322 can estimate point P̅.

In estimating entanglement it is particularly advantageous to select an additional proposition that is incompatible with the underlying proposition in the quantum sense. Preferably, however, both propositions are about the same item. Agents in the pair should then be confronted with the additional proposition to obtain subsequent measurable indications. Most effective is an additional proposition that induces secondary value matrix PR_{SV} that is incompatible with value matrix PR_{V}. This is true, of course, if secondary value matrix PR_{SV} was indeed confirmed by commutator algebra to be incompatible with value matrix PR_{V}. Otherwise, secondary agent value matrix should be appropriately selected with the aid of commutator algebra. In the above example secondary agent value matrix PR_{SV} stands for contextualization by “utility”.

Clearly, the manner in which additional proposition is presented should induce the incompatible contextualization. It should induce agents to yield their subsequent measurable indications as eigenvalues of secondary agent value matrix PR_{SV}. To ensure that this is true, the eigenvalues should preferably be collected in conjunction with questions asking the agents to articulate their contextualization.

Thus, the advanced quantum cognition model allows Quantum Processing Unit 322 to determine a mutual interdependence or entanglement in pairs of agents that jointly contextualize a proposition. As seen above, the agents can be F-D anti-consensus type of B-E consensus type. Of course, the advanced quantum cognition model extends to tracking or detecting the effects of entanglement that each agent in the entangled pair experiences. They also extend to simulating the effects of entanglement exhibited or experienced by pairs of agents. In particular, Bell type experiments can be performed on agent states in the process of tracking, detecting or simulating the effects of entanglement.

A final output 600 of Quantum Processing Unit 322 thus obtained under the application of the advanced quantum cognition model that accounts for entanglement consists of expected measurable indications based on expected indications collected from entangled partners. Of course, the entanglement can be extended beyond pairwise entanglements to include larger groups of agents. The extension will require considerably larger amount of computation but is otherwise implemented by extending the entanglement effects to many agents. This is of particular benefit for agents that exhibit B-E consensus as they may form larger collections that all present the same measurable indication (in analogy to the Bose-Einstein condensation effect).

IV. Quantum Cognition Model with Graph Applications

In practical applications it is most advantageous to deploy the basic and advanced quantum cognition models together, as appropriate. In other words, non-interacting agents can be treated in isolation, whereas interactions agents must be treated jointly or using joint states (entanglement). The below example extends to an exemplary application that deploys both basic and advanced quantum cognition models.

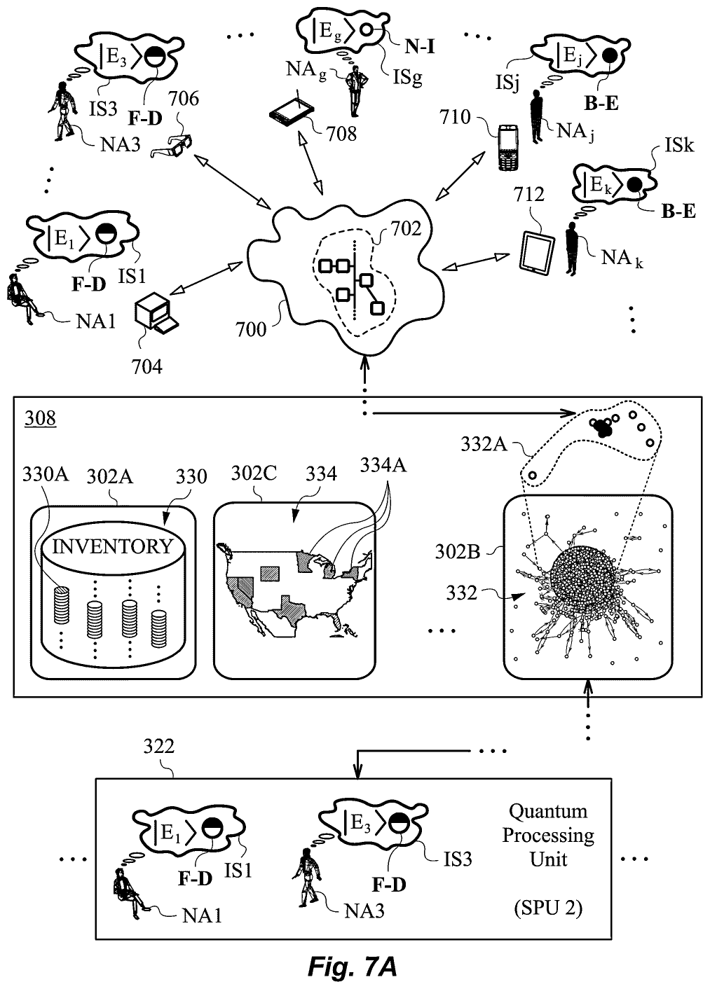

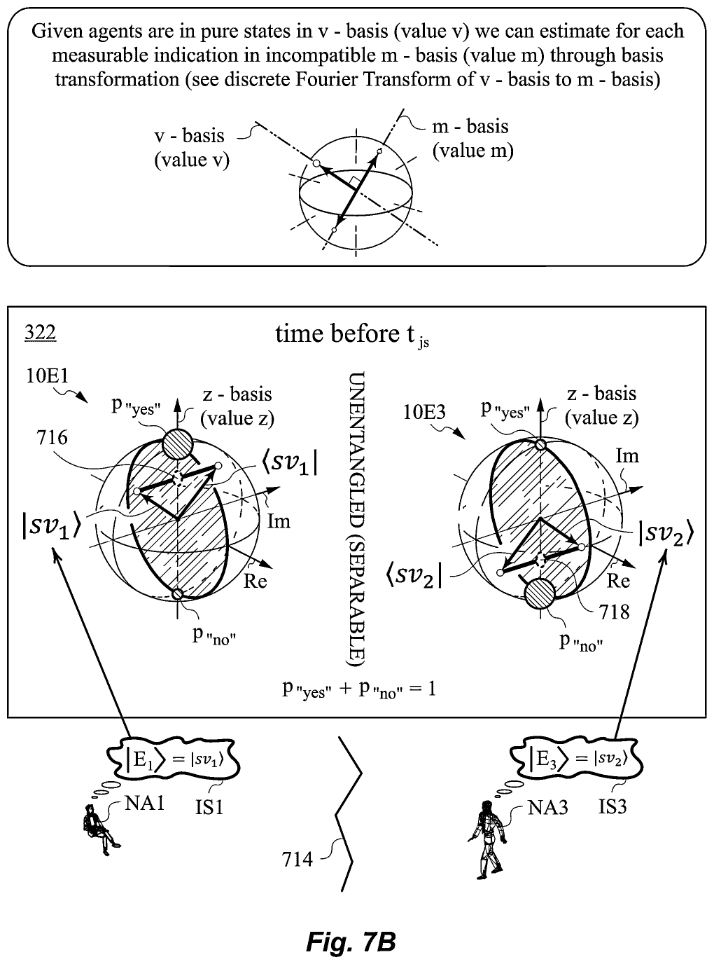

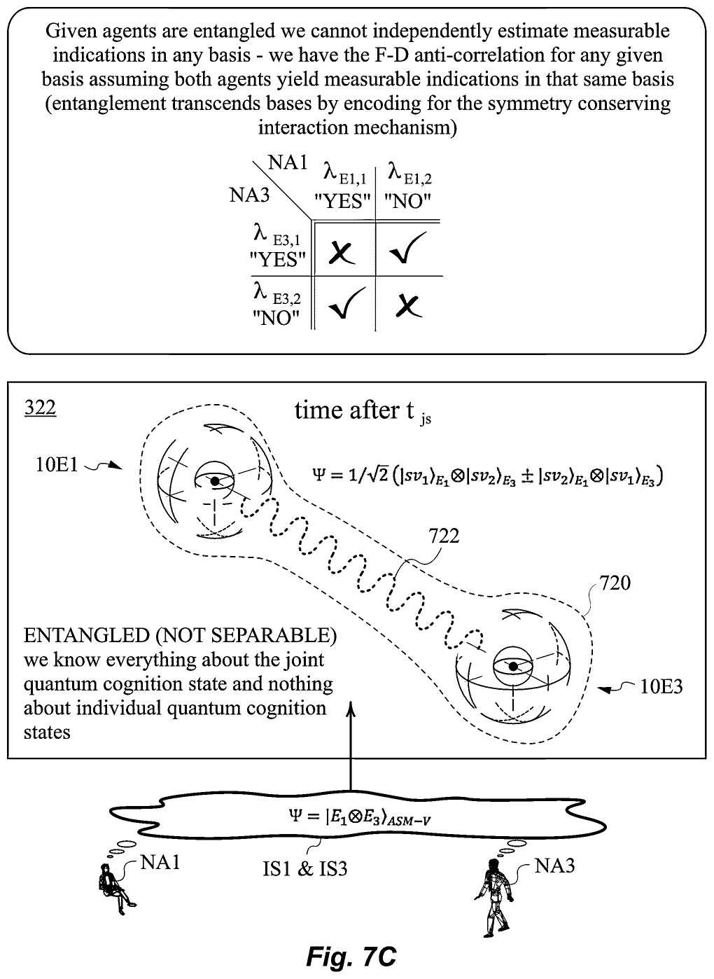

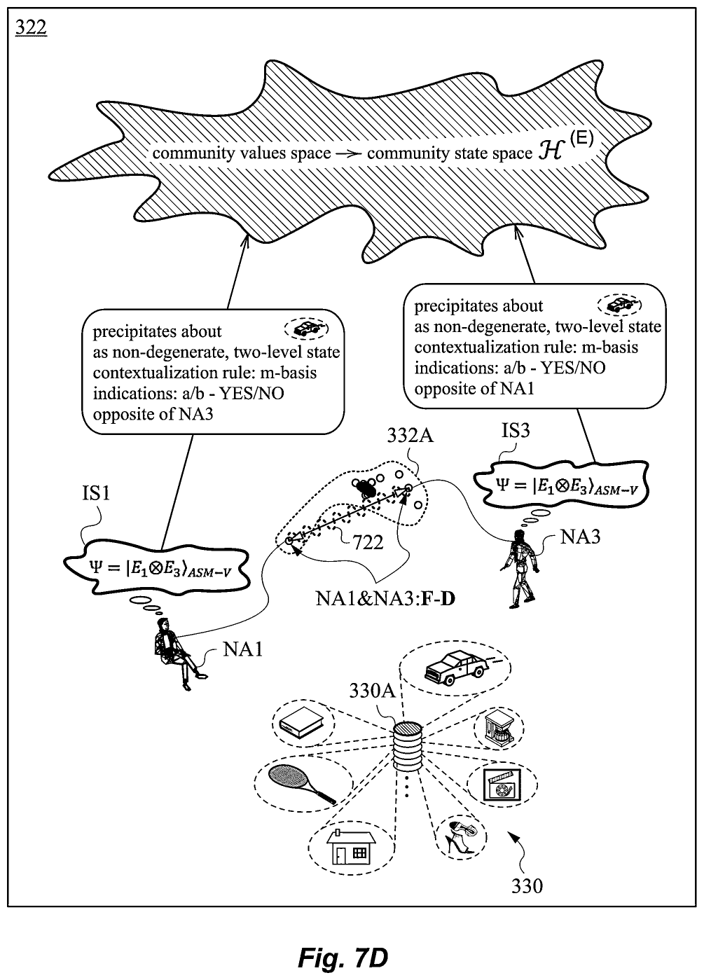

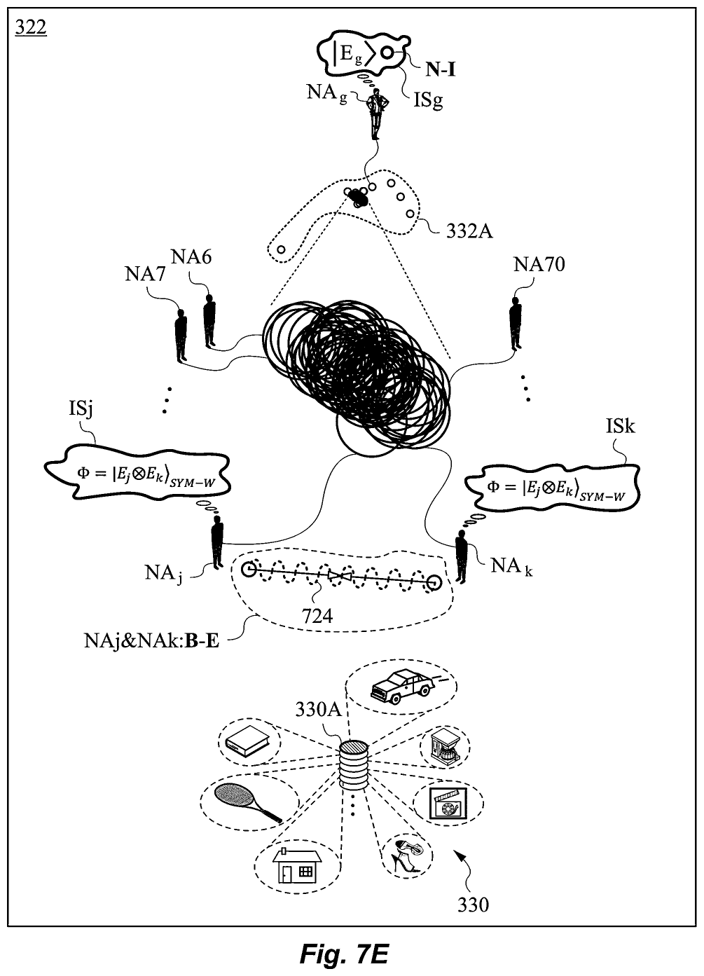

FIG. 7A diagrammatically illustrates an extension of integrated computing architecture 300 from FIG. 3A for working with layered data set 302 in situations where a network 700 spread over network resources 702 connects the agents. The same reference numerals will be used here to refer to elements previously presented in integrated computing architecture 300. Specifically, layered data set 302 has data layers 302A, 302B, 302C that are again shown explicitly already delivered to CPU 308 for clarity. The connection to specialized processing unit (SPU) 322 instantiated by the Quantum Processing Unit is shown without indicating high-speed bus 312 for reasons of clarity.

Data layer 302A contains inventory of items 330 represented symbolically by tokens. Data layer 302B contains graph 332 that expressly shows market participants or market agents represented by vertices or nodes N (see FIG. 3A). The buy and sell relationships between agents N are expressly shown as directed edges or directed connections C (see FIG. 3A). Data layer 302C contains geographical region 334 where agents N are physically located, namely the United States. Thus, layered data set 302 in the present embodiment has data layers 302A, 302B, 302C that jointly focus on agents N that buy and sell or trade items 330 within the United States 334. The operation of integrated computing architecture 300 can deploy the logic flow shown in FIG. 2 or an alternative logic flow that breaks up the steps between resources in a different manner.

Again, specific item 330A instantiated by a car is selected from inventory of items 330 of data layer 302A. The corresponding relevant subset of information is indicated in the other two data layers 302B, 302C. Once again, car 330A is only traded within agent segment 332A from among agents N shown in graph 332 contained in data layer 302B. Furthermore, car 330A is only traded in a certain portion 334A of geographical region 334 namely just the states indicated by hatching (California, Florida, Minnesota, Nevada, New York, Texas, Wisconsin and Wyoming).

A number of agents belonging to segment 332A are shown explicitly in FIG. 7A. In particular, agents NA1, NA3, NAg, NAj and NAk of segment 332A are shown along with their connections into network 700 via network resources 702. Each one of agents NA1, NA3, NAg, NAj, NAk uses a different networked device to interchange data over network 700. Agent NA1 uses a computer 704. Agent NA3 uses a pair of Augmented Reality (AR) or Virtual Reality (VR) goggles 706 (sometimes referred to as head-mounted display HMD). Agent NAg uses a slate or tablet computer 708 with a stylus. Finally, agent NAj uses a smart phone 710 and agent NAk uses a tablet 712 such as an iPad.

As in the previous embodiment, CPU 308 identifies and separates layered data 302 and assigns them to computation tasks accordingly. In the example we focus on just the computation task that involves the quantum cognition models submitted to Quantum Processing Unit 322. In the present embodiment, this involves data layer 302B that contains graph 332 that includes segment 332A with entanglement suspects and is assigned to second computation task and routed accordingly by CPU 308 (see FIG. 3A).

The present embodiment relies on data collected about all agents N of graph 332 and specifically for agents in segment 332A via their networked devices. In particular, for agents NA1, NA3, NAg, NAj, NAk data about their behavior patterns and measurable indications is collected through devices 704, 706, 708, 710, 712. Thus, resources 702 of network 700 permit graph 332 and segment 332A that is the focus of the present example to have useful additional information (see previous sections for “big data” and other sources of historical information about agents and other files about them, including any information provided by a human curator). The additional information can be used by Quantum Processing Unit 322 in deploying the quantum cognition model.

In the present example, historical data is used with network 700 to assign expected field behavior or consensus type to agents NA1, NA3, NAg, NAj, NAk. Agents NA1, NA3 are F-D anti-consensus type, agent NAg is not subject to interaction N-I (rugged individual), and agents NAj, NAk are B-E consensus type (subject to Bose-Einstein condensation). These field behaviors are indicated in corresponding inner spaces IS1, IS2, ISg, ISj, ISk of agents NA1, NA3, NAg, NAj, NAk as treated by the quantum cognition model in the context of propositions that involve transactions about car 330A. FIG. 7A illustrates Quantum Processing Unit 322 specifically treating F-D anti-consensus agents NA1, NA3 by applying the quantum cognition model and using data supplied through network 700.

FIG. 7B illustrates how Quantum Processing Unit 322 treats agents NA1, NA3 at a time before entanglement (at times before formation of joint state tⱼₛ; see FIG. 3D). Before entanglement, as indicated by separator 714, based on data gleaned from network 700 agents NA1, NA3 are unentangled and can be considered to have separate quantum states |E₁ [symbol] , |E₃ [symbol] modulo any proposition about car 330A. According to the basic quantum cognition model these states can be represented with the aid of corresponding Bloch spheres 10E1, 10E3.

Data from network 700 indicates that separable quantum states |E₁ [symbol] , |E₃ [symbol] are reasonably pure and correspond to eigenvector |sv₁ [symbol] and |sv₂ [symbol] of the V-basis laid down by value matrix PR_{V} denoting contextualization by “style”, as explained above. In other words, both agents NA1, NA3 are in inner states IS1, IS3 that can be represented by eigenvectors |sv₁ [symbol] and |sv₂ [symbol] , respectively. Accordingly, agent NA1 considers car 330A to be stylish (a measurement would yield the corresponding eigenvalue “YES” for “style”) and agent NA3 considers car 330A not stylish (a measurement would yield the corresponding eigenvalue “NO” for “style”).

The v-basis representation of quantum states |E₁ [symbol] , |E₃ [symbol] is advantageous, but the reader is reminded that they can be represented in any other basis. For example, FIG. 7B shows that a discrete Fourier Transform can be used to express quantum states |E₁ [symbol] , |E₃ [symbol] in a completely incompatible m-basis. Also, expectation values 716, 718 in z-basis for quantum states |E₁ [symbol] , |E₃ [symbol] computed with the aid of corresponding bra vectors (involving complex conjugation) are illustrated in FIG. 7B. The probabilities for “YES” and “NO” are also indicated for completeness. These probabilities are the output of Quantum Processing Unit 322 regarding purchase probabilities of car 330A by agents NA1, NA3 prior to entanglement. This output is obtained with the basic quantum cognition representation from section II and the resulting probabilities can be used as long as agents NA1, NA3 are acting as independent market agents. Still differently put, at this point they are not entanglement suspects.

FIG. 7C illustrates how Quantum Processing Unit 322 treats agents NA1, NA3 once they are entangled (at times after formation of joint state tⱼₛ; see FIG. 3D). After entanglement, which can be due to joint exposure to the proposition or other reasons (see section III) and as gleaned from contemporaneous data delivered by network 700, agents NA1, NA3 can no longer be considered separately. In other words, it is not possible to independently estimate their measurable indications (e.g., expectation values) in any basis as we know nothing about their individual quantum states. Still differently put, the inner states IS1 and IS3 cannot be separated in the context of the proposition about car 330A. This “melding” of their inner states is illustrated at the bottom of FIG. 7C.

Yet, from joint agent state Ψ which combines agent states into a single, non-separable description we know everything that can be known about agents NA1, NA3 within the quantum cognition model. (Note that joint F-D anti-consensus agent pair state Ψ in FIG. 7C lists both options (with “+” and with “−” signs) where the option with the “−” sign represents the singlet quantum state.) Specifically, we know how obtaining measurable indications from one of the agents in any chosen basis will affect the quantum state of the other agent of the NA1, NA3 pair; it will be opposite if measured in the same basis. The corresponding table for any given basis is also shown at the top of the drawing figure.

From the point of view of an observer of the entire market in car 330A the anti-consensus F-D agents ss seem to repel each other. It is as if the anti-correlation formed a bond 722 that is repulsive. In other words, whatever agent N1 chooses agent N3 will not choose.

FIG. 7D illustrates repulsive bond 722 between agents NA1, NA3 within segment 332A. The quantum cognition representation in state space, which can also be considered a “sentiment space”, is also indicated. Since agents NA1, NA3 repel due to their F-D anti-consensus joint state it is not surprising that their positions within segment 332A of graph 332 are far apart. In practice, this typically manifests by their choice of different suppliers or dealers of car 330A. Such dealers naturally compete in the marketplace and hence lie far apart in graph 332. This ensures separation of their customers, such as agents NA1, NA3, when presented in graph 332 under the graph embedding rules discussed above.

FIG. 7E illustrates the opposite situation for agents within segment 332A of graph 332 that are B-E consensus type and hence form attractive bonds. There are many such consensus type agents and they pool or clump together in graph 332. In practice, they all choose the same supplier or dealer of car 330A and thus form the tight clump that is enlarged in order to visualize them better.

Agents NAj, NAk are explicitly identified with their symmetric joint state Φ. Note that joint B-E consensus agent pair state Φ in FIG. 7E has two options (either with “+” or with “−” sign; see Eqs. 29). An attractive bond 724 between agents NAj, NAk within segment 332A is shown in the outline labeled with their joint state type: NAj&NAk:B-E. Attractive bond 724 of the quantum cognition representation can also be shown in state space, which can also be considered a “sentiment space”. Since agents NAj, NAk attract due to their B-E consensus joint state it is not surprising that their positions within segment 332A of graph 332 are virtually on top of each other. In practice, this typically manifests by their choice of the same suppliers or dealers of car 330A.

A more rigorous treatment of B-E consensus agents within the quantum cognition model extends the entanglement beyond pairwise to treat larger groups. This is analogous to the treatment of larger states in physics proper. Furthermore, large consensus states manifest in the emergence of condensation effects (e.g., Bose-Einstein condensate formation).

Finally, FIG. 7E also illustrates agent NAg that does not interact and is thus marked N-I (Non-Interacting). Agent NAg does not enter joint states with other agents and thus does not require complicated state representations. Consequently, predictions about the actions of agent NAg can be derived by reverting to the basic quantum cognition model presented in section II.

### V. Quantum Models and Real World Applications

A person skilled in the art will be familiar with using quantum models for treating various entities with quantum tools. Thus, the integrated computing architecture of the present invention can be applied to other quantum models beyond quantum cognition. These can be standard quantum models used with entities that are complex or other generally accepted quantum models, such as quantum chemistry. The basics of those models are understood by those skilled in the art and can also be gleaned from following the quantum cognition explanations above, as those track to those taught in physics proper.

The various quantum models that can be deployed can also be based on entities that are represented by nodes in a graph. Such entities can include organisms and biological entities, chemical entities, atomic entities and the like.

An important class of agents that can be represented with the quantum cognition model taught above are synthetic agents. Such synthetic agents can be Artificial-Intelligence Agents (AI Agents). The application of the quantum cognition model to AI agents would enable simulations that agree with more fundamental natural principles that have been learned from quantum mechanics.

### 1. Real-World Applications of the Quantum Cognition Model: Advertising and Consumer Response: The Quantum Advantage

The quantum cognition model, as elaborated in this patent application, offers a transformative lens for understanding and optimizing advertising strategies. By representing consumer perceptions and preferences as quantum states, the model captures the inherent uncertainty and fluidity of human decision-making, providing a significant advantage over classical models that often struggle to account for the complexities of consumer behavior. The following sections delve deeper into the application of the quantum cognition model to advertising, highlighting its ability to address key challenges and unlock new possibilities for effective consumer engagement.

A. Advertising without Entanglement: The Indeterminate Consumer

In the initial stages of an advertising campaign, the consumer's perception of the advertised product or service can be likened to the indeterminate state of a quantum system before measurement. The consumer's internal state, as represented by their quantum state in the model, exists in a superposition of various possible states, reflecting their uncertainty and lack of a definitive opinion. The quantum cognition model, by representing the consumer's internal state as a superposition of basis states corresponding to different value judgments modulo the product or service using different contextualizations, including incompatible ones (e.g., “like” or “dislike,” “useful” or “not useful”), captures this inherent indeterminacy with unparalleled accuracy.

The act of viewing the advertisement can be interpreted as a measurement that collapses this superposition into a definite state, revealing the consumer's response or measurable indication. The probability of collapsing into a particular state is governed by the coefficients of the superposition, which can be estimated based on the consumer's prior experiences, preferences, and the context in which the advertisement is presented. The quantum cognition model's ability to quantify these probabilities empowers advertisers to confidently predict and strategically optimize the effectiveness of their campaigns, enabling them to tailor their messaging and targeting strategies to not just maximize consumer engagement and conversion rates, but to strategically influence them.

Furthermore, the quantum cognition model provides a powerful framework for understanding the influence of order effects in advertising. The sequence in which advertisements are presented can significantly impact the consumer's contextualization of the propositions, leading to different measurement outcomes and responses. This phenomenon, well-documented in marketing research, is elegantly captured by the quantum cognition model's ability to represent the evolution of quantum states under the influence of external stimuli. By strategically sequencing advertisements, marketers can leverage order effects to enhance the overall impact of their campaigns, ensuring that their message resonates with consumers in the most effective and persuasive manner.

### B. The Power of the ‘Ask’: Collapsing the Superposition

A key insight from the quantum cognition model is the profound impact of the ‘ask’ in advertising. By explicitly prompting the consumer for their opinion or response to the proposition, advertisers can actively induce the collapse of the superposition representing the consumer's internal state. This can be achieved through various calls to action, interactive elements, or surveys that require the consumer to make a choice or express a preference.

The act of asking serves a dual purpose. First, it reveals the consumer's current state, providing valuable feedback on the effectiveness of the advertisement and enabling real-time adjustments to the campaign. Second, and perhaps more importantly, it can influence the consumer's future behavior. By forcing a measurement and obtaining a definite outcome, the ‘ask’ can reinforce a particular contextualization or value judgment, potentially shaping the consumer's subsequent interactions with the brand or product. This active engagement with the consumer, facilitated by the quantum cognition model, empowers advertisers to not only understand but also actively shape and guide consumer behavior, leading to more effective and impactful campaigns.

### C. Beyond Individual Responses: Predicting Market Trends and Unveiling Hidden Preferences

The quantum cognition model's potential in advertising transcends the understanding of individual consumer responses. By aggregating the quantum states of a large number of consumers, the model can provide unprecedented insights into the overall market sentiment and predict potential trends. This can be particularly valuable for new product launches or campaigns targeting a specific demographic, allowing advertisers to gauge the likely reception of their message and make informed decisions about their marketing strategies.

Moreover, the model's ability to represent the superposition of consumer preferences can help unveil hidden or latent desires that may not be readily apparent through traditional market research methods. By probing consumer perceptions in multiple contextualizations, the model can uncover underlying motivations and preferences that can be leveraged to create more compelling and resonant advertising campaigns.

### D. The Quantum Advantage: A New Era of Advertising

The quantum cognition model represents a paradigm shift in advertising, offering a more nuanced, dynamic, and predictive understanding of consumer behavior. By embracing the principles of quantum mechanics, advertisers can move beyond the limitations of classical models and unlock new possibilities for effective consumer engagement. The quantum cognition model is not merely a theoretical construct but a practical tool that can revolutionize the way we understand and interact with consumers, leading to more targeted, personalized, and impactful advertising campaigns. It empowers advertisers to navigate the complexities of human decision-making, anticipate market trends, and shape consumer behavior in a way that is both ethical and effective. The quantum cognition model is not just the future of advertising; it is the key to unlocking its full potential.

2. Real-World Applications with Entanglement: Influencer Marketing and Social Influence: The Quantum Leap

The advanced quantum cognition model, enriched with the concept of entanglement, heralds a paradigm shift in understanding the intricate dynamics of influencer marketing and social influence. Entanglement, a cornerstone of quantum mechanics, captures the profound interconnectedness between quantum systems, where the state of one system is intrinsically linked to the state of another, regardless of spatial separation. In the realm of social networks, entanglement manifests as the mutual influence and interdependence between individuals, where the opinions, preferences, and actions of one person can reverberate through the network, shaping the internal states and behaviors of others. The quantum cognition model, by incorporating entanglement, provides a powerful framework for deciphering the complex interplay of individual and collective states within these networks, enabling a deeper understanding of the mechanisms through which influencers shape opinions and drive trends.

### A. Influencers as Entangled Agents: The Power of Connection

In the world of influencer marketing, the relationship between influencers and their followers can be elegantly modeled as an entangled state within the quantum cognition framework. The influencer, through their content, endorsements, and interactions, acts as a powerful source of propositions that resonate with their followers, influencing their internal states and shaping their perceptions of products, services, or even broader societal issues.

The quantum cognition model allows us to represent these interactions as measurements that collapse the superposition of followers' internal states, leading to correlated outcomes and behaviors. The strength of this influence is directly proportional to the degree of entanglement between the influencer and their followers. This entanglement, forged through consistent engagement, shared values, and perceived authenticity, creates a powerful conduit for the transmission of information and influence.

The influencer's endorsement of a product or service can be seen as a measurement that collapses the superposition of their followers' internal states, leading to correlated outcomes and behaviors, such as increased purchase intent, brand loyalty, or even shifts in social attitudes. The quantum cognition model's ability to quantify this entanglement allows for a more precise understanding of the influencer's impact and enables marketers to identify and collaborate with the most influential individuals in their target market.

### B. The Ripple Effect: Entanglement and the Propagation of Influence

The impact of entanglement extends far beyond the direct influencer-follower relationship. The quantum cognition model reveals how entangled states between individuals can facilitate the rapid and pervasive dissemination of information and opinions throughout a social network, creating a ripple effect where the actions and choices of one person can cascade through the network, influencing the behavior of countless others. This phenomenon lies at the heart of viral marketing campaigns and the formation of social trends. By identifying key influencers and understanding the entanglement patterns within a network, marketers can strategically leverage social influence to amplify their message and achieve unprecedented reach and impact. The quantum cognition model provides the tools to map these entanglement patterns, enabling marketers to visualize the flow of influence and identify potential brand advocates who can organically spread their message within their social circles.

### C. Beyond Pairwise Entanglement: The Collective Consciousness

The quantum cognition model's potential extends beyond pairwise entanglement to encompass the complex interplay of multiple entangled agents within a network. This allows for the exploration of emergent phenomena arising from the collective consciousness of a group, such as the formation of shared beliefs, the emergence of social norms, and the dynamics of group decision-making. By analyzing the entanglement patterns and the flow of information within a network, the model can shed light on the mechanisms through which collective opinions and behaviors emerge and evolve. This understanding can be leveraged to design more effective communication strategies, foster social cohesion, and promote positive change. In the context of influencer marketing, this means understanding how the collective consciousness of a community can be shaped and influenced by key individuals, and how this can be leveraged to create a groundswell of support for a brand or product.

### D. The Future of Influencer Marketing and Social Influence: A Quantum Leap

The quantum cognition model, with its incorporation of entanglement, offers a transformative perspective on influencer marketing and social influence. It provides a powerful framework for understanding the complex dynamics of social networks, predicting the impact of influencers, and designing strategies that harness the power of social connection. By embracing the principles of quantum cognition, marketers and communicators can unlock new levels of insight and effectiveness, navigating the intricate landscape of social influence with unprecedented precision and impact. The quantum cognition model is not merely a theoretical construct but a practical tool that can revolutionize the way we understand and engage with the interconnected world of human interaction. It empowers marketers to go beyond traditional metrics and tap into the underlying quantum dynamics of social networks, enabling them to create truly influential and impactful campaigns that resonate with consumers on a deeper level.

### 3. Phase Changes and Collective Phenomena in Quantum Cognition: The Quantum Leap in Predictive Power

The quantum cognition model, particularly when augmented with the concept of entanglement, offers a transformative perspective on understanding and predicting collective phenomena in social systems. This section delves into the model's unique capability to elucidate the dynamics of rapid shifts in public opinion, the formation and bursting of bubbles, and the emergence and decline of fads—phenomena that have long defied traditional models due to their inherent complexity and seemingly unpredictable nature. The quantum cognition model, with its ability to represent the complex interplay of individual and collective states, provides a promising framework for analyzing and potentially predicting such emergent behaviors.

### A. Bose-Einstein Condensation and Phase Transitions

At the heart of this understanding lies the concept of Bose-Einstein condensation (BEC), a state of matter in which a large number of bosons occupy the lowest quantum state, resulting in macroscopic quantum phenomena. In the realm of quantum cognition, BEC can be interpreted as the convergence of a significant portion of agents within a social network towards a shared contextualization, exhibiting highly correlated behaviors and beliefs. This collective alignment manifests as a sudden and dramatic shift in the overall state of the system, akin to a phase transition in the physical world.

The transition to a BEC-like state in a social system, as captured by the quantum cognition model, is marked by a sharp increase in the coherence and correlation of individual quantum states. This coherence, stemming from the entanglement between agents, allows for the rapid transmission and amplification of information and influence, leading to the emergence of macroscopic quantum phenomena at the collective level. The ability to represent and analyze such phase transitions sets the quantum cognition model apart, offering a powerful tool to dissect the dynamics of collective behavior.

### B. Triggers and Critical Points: The Seeds of Change

The onset of a phase transition in a social system can be triggered by various factors, both internal and external to the network. The quantum cognition model provides a framework for identifying and analyzing these triggers:
External Events: Major events, such as economic crises, political upheavals, or natural disasters, can act as powerful catalysts for phase transitions. These events can be modeled as external perturbations that induce shifts in the contextualization and measurement outcomes of individual agents, potentially leading to a cascade of correlated changes across the network. The quantum cognition model's ability to incorporate external influences into its framework allows for a more comprehensive understanding of how such events can trigger and shape collective phenomena.
Influential Individuals: Key individuals or influencers within a social network, by virtue of their high degree of entanglement with others, can exert a disproportionate influence on the collective state. Their opinions and actions can act as nucleation points for the formation of BEC-like states, triggering rapid shifts in public opinion or the emergence of new trends. The quantum cognition model's representation of entanglement allows for the identification and analysis of these influential individuals and their impact on the network.
Accumulation of Small Changes: Even in the absence of major events or influential individuals, gradual shifts in individual opinions and preferences can accumulate over time, eventually reaching a critical point that triggers a phase transition. The quantum cognition model's ability to track the evolution of individual quantum states enables the detection of subtle patterns and correlations that may foreshadow an impending collective shift. This capability to identify early warning signs of change is crucial for understanding and potentially mitigating the risks associated with bubbles or rapid shifts in public sentiment.

### C. Predictive Power: Unveiling the Future of Collective Behavior

The quantum cognition model, with its ability to represent the complex interplay of individual and collective states, offers a powerful tool for predicting the likelihood and timing of phase transitions in social systems. By analyzing the distribution of quantum states, the degree of entanglement within a network, and the influence of external factors, the model can identify early warning signs of an impending shift in collective opinion or the emergence of a new trend. This predictive capability has far-reaching implications across various domains. In marketing, it can enable businesses to anticipate changes in consumer preferences and tailor their strategies accordingly. In sociology, it can shed light on the dynamics of social movements and the factors that contribute to their success or failure. In economics, it can help forecast market trends and identify potential bubbles before they burst. The quantum cognition model's potential for prediction goes beyond traditional models, offering a new level of insight into the dynamics of collective behavior.

### D. Extending the Frontiers: Beyond Phase Transitions

The quantum cognition model's potential extends beyond the analysis of phase transitions. By incorporating additional layers of complexity and sophistication, the model can be further developed to explore a wider range of collective phenomena, such as:
The Spread of Information and Misinformation: Understanding how information, both accurate and false, propagates through social networks and influences collective beliefs is crucial in today's information-saturated world. The quantum cognition model can provide a framework for analyzing the dynamics of information dissemination, identifying key nodes and pathways, and assessing the impact of different communication strategies.
The Formation of Social Norms and Values: Analyzing the emergence and evolution of shared norms and values within a community is essential for understanding social cohesion and cooperation. The quantum cognition model can shed light on the mechanisms through which these norms and values are established and maintained, and how they can be influenced or changed.
The Dynamics of Group Decision-Making: Examining how groups reach consensus or become polarized on contentious issues is crucial for understanding political and social dynamics. The quantum cognition model can provide insights into the factors that influence group decision-making, such as the role of individual preferences, social influence, and the flow of information within the group.
The Emergence of Collective Intelligence: Exploring how the interactions between individuals within a network can lead to the emergence of collective intelligence that surpasses the capabilities of any single individual is a fascinating area of research. The quantum cognition model, with its ability to represent entanglement and collective states, can provide a framework for understanding the mechanisms underlying collective intelligence and its potential applications in various fields.

By pushing the boundaries of the quantum cognition model, we can gain deeper insights into the complex and often unpredictable dynamics of social systems, paving the way for more effective interventions and informed decision-making in a wide range of fields. The quantum cognition model is not merely a theoretical construct but a powerful tool for understanding and shaping the future of collective human behavior.

4. Real-World Applications with Entanglement:

### Financial Markets and Herd Behavior-Unveiling Quantum Dynamics

The quantum cognition model, with its integration of entanglement, offers a revolutionary approach to understanding and navigating the complex dynamics of financial markets. This section explores how the model's unique capabilities can provide a deeper insight into market behavior, particularly in analyzing herd mentality, predicting market trends, and crafting more resilient risk management and investment strategies.

### A. The Quantum Nature of Financial Markets: Transcending Classical Models

Financial markets are notoriously unpredictable, marked by interconnectedness, volatility, and sudden shifts that challenge traditional economic models rooted in classical notions of rationality and independence. The quantum cognition model introduces a paradigm shift by incorporating quantum mechanics principles, acknowledging that investor behavior is often influenced by a complex interplay of factors beyond mere rationality. Emotions, biases, social influence, and information cascades are all represented as quantum states, with entanglement providing a more nuanced and realistic depiction of market dynamics. This model transcends classical assumptions, offering a richer framework for understanding how markets truly operate.

### B. Herd Behavior and Market Bubbles: The Power of Entanglement

Herd behavior is one of the most pronounced phenomena in financial markets, where investors, influenced by the actions of others, collectively drive asset prices to unsustainable levels, leading to bubbles and eventual crashes. The quantum cognition model explains this behavior through the concept of entanglement. Investors are interconnected through various communication channels such as social media and news outlets, creating entangled states where the decisions of one investor can ripple through the market, influencing the actions of others. This interconnectedness fosters a self-reinforcing cycle of buying or selling, pushing prices far beyond their intrinsic values and setting the stage for a bubble that is prone to abrupt collapse.

The model's ability to quantify entanglement within investor networks offers a powerful tool for predicting the formation and bursting of market bubbles. By monitoring the evolution of these entangled relationships and identifying key influencers or “super-spreaders” of information, the quantum cognition model can provide early warning signals of market instability, allowing for more proactive measures to mitigate potential crises.

### C. Predictive Power: Navigating the Quantum Financial Landscape

The predictive capabilities of the quantum cognition model extend well beyond bubble detection. By analyzing the distribution of quantum states and the degree of entanglement across investor networks, the model can forecast market trends and pinpoint emerging opportunities or risks. This enhanced predictive power enables investors to make more informed decisions, optimize their portfolios, and confidently navigate the complex, often volatile financial markets.

### D. Risk Management and Investment Strategies: The Quantum Advantage

The Insights derived from the quantum cognition model can be instrumental in crafting more effective risk management strategies and investment approaches. Recognizing the inherent uncertainty and interconnectedness among market participants, the model helps identify potential vulnerabilities within a portfolio or market sector. Moreover, its predictive prowess in identifying market trends and emerging opportunities can be leveraged to design investment strategies that are more robust and adaptable to changing market conditions.

### E. The Quantum Revolution in Finance: Pioneering a New Era of Understanding

Applying the quantum cognition model to financial markets signals a profound transformation in our understanding of market behavior. By embracing quantum mechanics, we move beyond the constraints of classical models and gain a deeper appreciation of the complex, often counterintuitive dynamics that govern financial systems. This quantum revolution in finance promises to reshape how we approach investing, risk management, and the ever-evolving landscape of global markets, heralding a new era of financial strategy and understanding.

### 1. The Quantum Cognition Model and Large Language Models: A New Frontier in AI

The quantum cognition model represents a transformative leap in the development of Large Language Models (LLMs) by encapsulating the complex and context-sensitive nature of human thought. This paradigm shift offers a promising solution to the inherent limitations of current LLMs, which heavily rely on vast datasets and computationally intensive training processes. By integrating key principles of quantum mechanics-such as superposition, entanglement, and contextualization-into the architecture of LLMs, we can create models that not only achieve greater accuracy and contextual awareness but also operate with increased efficiency.

### A. Rethinking Attention:

### A Quantum Paradigm for Contextualizing Language

Despite significant advancements, current LLMs often struggle to capture the subtle nuances and intricate contextual dependencies that characterize human language. These models can produce grammatically correct text, but they frequently fall short in maintaining semantic coherence or reflecting the richness of the broader conversational context. This limitation arises from their reliance on linear, deterministic processing mechanisms, which can oversimplify the multifaceted and often ambiguous nature of language.

The quantum cognition model offers a groundbreaking approach to overcoming these challenges by reimagining attention as a dynamic, quantum-inspired process. In this model, language is not confined to a single, fixed meaning. Instead, words, phrases, and concepts exist in a state of superposition-simultaneously representing multiple potential meanings, each influenced by the surrounding context. This approach allows LLMs to evaluate various interpretations of input, assess their probabilities based on contextual cues, and generate responses that are not only grammatically sound but also semantically coherent and deeply context-aware.

This quantum-inspired view of attention represents a new paradigm for contextualizing language. Traditional attention mechanisms in LLMs focus on identifying and prioritizing the most relevant parts of an input sequence, often through weighted sums. However, this approach may falter when dealing with complex language structures where meaning is layered across multiple contexts and where the significance of specific elements can shift with subtle nuances.

In contrast, the quantum cognition model treats attention as an entangled process, where the significance of each word or phrase is considered within a broader web of interconnected meanings. This entanglement allows LLMs to better capture the intricate relationships between words and their surrounding context. For example, the meaning of a phrase can be influenced by its entangled relationship with other phrases or concepts, leading to a more nuanced and accurate understanding of the text as a whole.

By adopting this quantum-inspired approach, LLMs can achieve a deeper level of semantic processing, where attention is not just about focusing on individual elements but understanding the holistic interplay of meanings. This enables LLMs to produce text that aligns more closely with the complexities of human language, resulting in outputs that are contextually rich, semantically coherent, and better suited to real-world communication.

Furthermore, this new paradigm holds the potential to revolutionize various natural language processing tasks. In machine translation, for instance, the ability to maintain multiple potential meanings in superposition could lead to more accurate translations that account for cultural and contextual differences. In text summarization, the entangled attention mechanism could help distill the most relevant information while preserving the nuanced meaning of the original text. And in conversational AI, this approach could enable systems to engage in more natural and meaningful interactions, with responses finely tuned to the specific context and intent of the user.

### B. Quantum-Inspired LLM Training: Efficiency and Adaptability

The quantum cognition model offers a transformative approach to optimizing the training and fine-tuning of LLMs, paving the way for unprecedented efficiency and adaptability. Traditional LLM training processes, while powerful, are often characterized by immense computational demands, requiring extensive resources to process vast datasets. These models rely on classical optimization algorithms that, although effective, can be slow and resource-intensive when navigating large solution spaces.

In contrast, the quantum cognition model leverages quantum-inspired optimization techniques, which draw on the principles of quantum mechanics—such as superposition and entanglement—to explore complex solution spaces more efficiently. By applying these principles, quantum-inspired algorithms can simultaneously evaluate multiple potential solutions, effectively reducing the time and computational power required to train large-scale LLMs. This streamlined training process allows models to converge on optimal solutions faster and with fewer resources, making the development of advanced LLMs more accessible and sustainable.

Beyond efficiency, the quantum cognition model inherently supports the creation of more adaptable and resilient LLMs. Central to this adaptability is the model's focus on contextualization and entanglement, which enables LLMs to better understand and respond to the nuanced complexities of human language. During training, the model doesn't merely learn static representations of language patterns; instead, it dynamically adjusts to the contextual interrelationships between words, phrases, and concepts, fostering a deeper and more flexible understanding of language.

This adaptability is crucial for developing LLMs that can handle a wide range of tasks and scenarios with greater precision. For instance, in conversational AI, where context and user intent can shift rapidly, a quantum cognition-based LLM can quickly adapt to these changes, generating responses that are more relevant and contextually appropriate. The model's ability to incorporate subtle shifts in meaning and intent ensures that it remains robust even in complex or ambiguous situations, leading to more natural and engaging interactions with users.

Moreover, this enhanced adaptability extends to the fine-tuning process. As LLMs are refined for specific applications or domains, the quantum cognition model allows for more targeted adjustments, ensuring that the model remains finely tuned to the particular nuances of the language and context it encounters. This means that LLMs can be more easily customized for specialized tasks-whether adapting to the technical jargon of a specific industry or the cultural subtleties of a particular region-without requiring exhaustive retraining.

### C. The Future of LLMs: Quantum Cognition as the Next Frontier

The quantum cognition model signals the beginning of a new era in the evolution of LLMs, where these models can interpret and generate language with a sophistication and nuance that closely mirrors human communication. By embedding quantum cognition principles into the core of LLMs, we can transcend the limitations of current architectures, unlocking capabilities that were once thought to be beyond the reach of artificial intelligence.

This is not just a theoretical leap; the quantum cognition model holds the potential to revolutionize the field of natural language processing. From creating more intuitive and responsive chatbots and virtual assistants to enhancing the precision of language translation and content generation, the integration of quantum cognition principles is poised to redefine what LLMs can achieve. As we step into this new frontier, the quantum cognition model stands at the cutting edge, leading the charge toward a future where LLMs can truly understand and communicate with human-like depth and complexity. The future of LLMs is indeed quantum, and this model is paving the way for revolutionary advancements.

It will be evident to a person skilled in the art that the present invention admits of various other embodiments. Therefore, its scope should be judged by the claims and their legal equivalents.

1. An integrated computing architecture for distributing a layered data set comprising data layers tagged with layer type descriptors to processing units according to a first computation task and a second computation task, said integrated computing architecture comprising:
a) a Central Processing Unit for:
1) receiving said layered data set tagged with said layer type descriptors;
2) identifying and separating said layered data set based on said layer type descriptors into a first type data subset and a second type data subset; and
3) assigning said first type data subset to said first computation task and said second type data subset to said second computation task;
b) a high-speed bus connected to said Central Processing Unit for routing said first type data subset and said second type data subset;
c) at least one Graphics Processing Unit connected to said high-speed bus for performing said first computation task on said first type data subset;
d) at least one specialized processing unit connected to said high-speed bus for performing said second computation task on at least one segment of said second type data subset;
wherein said first computation task comprises matrix operations and said second computation task comprises application of a specialized computation model.

2. The integrated computing architecture of claim 1, wherein said layer type descriptors comprise metadata including at least one parameter selected from among dimensions, activation functions, attention mechanisms, hyperparameters, positional encodings, feed-forward networks, non-classical data indicators and entanglement suspects.

3. The integrated computing architecture of claim 1, wherein said layer type descriptors include a specialized metadata indicator for said at least one segment of said second type data subset.

4. The integrated computing architecture of claim 1, wherein said layer type descriptors include at least one suspected non-classical metadata indicator for said at least one segment of said second type data subset.

5. The integrated computing architecture of claim 4, wherein said specialized computation model comprises a quantum cognition model and wherein said at least one segment of said second data type comprises agents assigned to graph nodes and relationships between said agents assigned to graph edges.

6. The integrated computing architecture of claim 5, wherein said relationships between said agents include entanglement between a pair of agents whose contextualization of a proposition is tracked in a quantum representation.

7. The integrated computing architecture of claim 4, wherein said Central Processing Unit performs a non-classicality test on said at least one segment, said non-classicality test comprising a factorizability test.

8. The integrated computing architecture of claim 4, wherein said at least one segment comprises a quantum data segment and said at least one specialized processing unit comprises at least one unit selected from the group consisting of Quantum Coprocessors, Quantum Computers and Quantum Simulators for application of said specialized computation model.

9. The integrated computing architecture of claim 8, wherein said specialized computation model comprises a model selected from among a quantum annealing model, a sequence of quantum gates, a generator of entangled qubits for quantum key distribution, a noise-mitigation algorithm for minimizing quantum errors, a hybrid quantum-classical optimization loop, a sequence of quantum operations followed by classical operations, a quantum Fourier transform, a generator of entangled states with a controlled-NOT gate, a quantum error correction code, a quantum state preparation and measurement sequence, a quantum walk algorithm, a quantum search algorithm.

10. The integrated computing architecture of claim 1, wherein said at least one specialized processing unit comprises at least one unit selected from among Liquid Neural Network Processing Units and Neural Ordinary Differential Equations Processing Units.

11. The integrated computing architecture of claim 10, wherein said specialized computation model comprises a model selected from among an initial value solver for Neural Ordinary Differential Equations by adaptive Runge-Kutta methods, a fast Jacobian Matrix evaluation for implicit Ordinary Differential Equation solution, a real-time simulation of Liquid Neural Networks with a sparse connectivity matrix, a hardware-accelerated bifurcation analysis to identify parameter regimes where the dynamics of Neural Ordinary Differential Equations change qualitatively, a backpropagation through time for Liquid Neural Networks by storing and replaying neural states, a time-stepping algorithm for solving partial differential equations related to Neural Ordinary Differential Equations, a gradient descent algorithm, a reservoir computing task with projection of high-dimensional inputs onto lower-dimensional liquid states, an evaluation of stability of fixed points and limit cycles in Neural Ordinary Differential Equation systems, a sensitivity analysis for quantifying impact of parameter variations on Neural Ordinary Differential Equation solutions, a simulation of spiking neural networks with integrate-and-fire models or Hodgkin-Huxley models, a hardware-accelerated Fast Fourier Transform for frequency domain analysis of Liquid Neural Networks.

12. The integrated computing architecture of claim 1, wherein said at least one Graphics Processing Unit and said at least one specialized processing unit operate asynchronously.

13. The integrated computing architecture of claim 1, wherein said at least Graphics Processing Unit and said specialized processing unit operate synchronously.
